(19) United States
(12) Patent Application Publication
(10) Pub. No.: US 2018/0314109 A1
(43) Pub. Date: Nov. 1, 2018

(54) LIQUID CRYSTAL DISPLAY PANEL

(71) Applicant: SHARP KABUSHIKI KAISHA, Sakai City, Osaka (JP)

(72) Inventors: Akira SAKAI, Sakai City (JP); Kohzoh NAKAMURA, Sakai City (JP); Masahiro HASEGAWA, Sakai City (JP); Takako KOIDE, Sakai City (JP); Kiyoshi MINOURA, Sakai City (JP)

(21) Appl. No.: 15/739,698

(22) PCT Filed: Jun. 17, 2016
(86) PCT No.: PCT/JP2016/068165

§ 371 Date: Dec. 22, 2017

(30) Foreign Application Priority Data
Jun. 23, 2015 (JP) 2015-125666

(51) Int. Cl. G02F 1/1335; G02F 1/13363; G02F 1/1368; G02F 1/137; G02F 1/1337; G02B 5/30

(52) U.S. Cl. CPC G02F 1/133528; G02F 1/133636; G02F 1/1368; G02F 1/137; G02F 1/1337; G02F 2001/133738; G02F 2001/133541; G02F 2201/121; G02F 2201/123; G02F 2001/13706; G02F 2001/13712; G02B 5/3083

(57) ABSTRACT

Provided is a liquid crystal display panel (100C) including a transverse electric field mode liquid crystal cell (10), a first polarizing plate (22C) disposed on a back surface side of the liquid crystal cell (10), and a second polarizing plate (24C) disposed on an observer side of the liquid crystal cell (10), wherein: letting Δn be birefringence of nematic liquid crystals and d be a thickness of the liquid crystal layer for a liquid crystal layer (18), Δnd is less than 550 nm, the liquid crystal layer is in a twisted alignment state when no voltage is applied, and when polarized light for which the absolute value |S3| of the Stokes parameter S3 is 1.00 is incident, the |S3| of the polarized light transmitted through the liquid crystal layer (18) is greater than or equal to 0.85; and the first polarizing plate (22C) and the second polarizing plate (24C) are circular polarizing plates or elliptical polarizing plates having an ellipticity of 0.422 or greater, and each of the first polarizing plate (22C) and the second polarizing plate (24C) is substantially constituted only of a linear polarizing layer and a phase difference layer.

### TECHNICAL FIELD

The present invention relates to a liquid crystal display panel, and particularly relates to a liquid crystal display panel having a transverse electric field mode.

### BACKGROUND ART

Liquid crystal display panels having a transverse electric field mode, such as an In-Plane Switching (IPS) mode or a Fringe Field Switching (FFS) mode, have an advantage over vertical electric field mode (VA mode, for example) liquid crystal display panels in the related art in that the viewing angle dependence of γ properties is low. As such, the use of such panels as small- and medium-sized liquid crystal display panels, in particular, is increasing.

However, as the resolutions of liquid crystal display panels increase, the pixel aperture ratios (a ratio of the total surface area of the pixels occupying the display region) decrease, and it is becoming difficult to achieve a satisfactory display luminance. Particularly, in small- and medium-sized liquid crystal display panel for mobile applications, a drop in the contrast ratio when viewing in bright environments such as outdoors is a problem.

Thus far, in response to this problem, the contrast ratio has been increased by increasing the brightness of a backlight in order to increase the display luminance. However, increasing the brightness of the backlight has a drawback in that doing so consumes more energy, and responding by increasing the brightness of the backlight is nearing its limit.

Reflection by the liquid crystal display panel is one reason why the contrast ratio of the liquid crystal display panel drops in bright environments. Thus, attempts are made to improve contrast ratios by suppressing reflection by liquid crystal display panels.

For example, Patent Document 1 discloses an in-plane switching mode liquid crystal display panel that suppresses a situation in which light reflected by a liquid crystal cell escapes to an observer side by providing a phase difference plate (also called a “front-side phase difference plate”) between a linear polarizing plate (also called a “front-side linear polarizing plate”) disposed on the observer side (also called a “front side”) and the liquid crystal cell. The front-side phase difference plate is provided so that linear polarized light transmitted through the front-side linear polarizing plate rotates in a first direction to become circular polarized light. In other words, the front-side linear polarizing plate and the front-side phase difference plate function as a circular polarizing plate. When circular polarized light is reflected (at an interface where the refractive index changes from low to high), the phases of both P waves and S waves are shifted by π radian, and the rotation direction reverses as a result. Thus, light reflected in the liquid crystal cell (transparent substrate) becomes circular polarized light having a second direction, which is the reverse of the first direction, as the rotation direction, and linear polarized light obtained from the circular polarized light passing through the front-side phase difference plate is absorbed by the front-side linear polarizing plate.

The liquid crystal display panel of Patent Document 1 further includes a phase difference plate (also called a “rear-side phase difference plate”) disposed between a linear polarizing plate (also called a “rear-side linear polarizing plate”) disposed on a backlight side (also called a “rear side”) and the liquid crystal cell, and the rear-side phase difference plate is configured so that linear polarized light transmitted through the rear-side linear polarizing plate becomes circular polarized light having a rotation direction that is the second direction, which is the reverse of the first direction, upon passing through the rear-side phase difference plate and a liquid crystal layer in a black display state. By passing through the front-side phase difference plate, the circular polarized light having the second direction as the rotation direction is transformed into linear polarized light that is absorbed by the front side polarizing plate.

According to Patent Document 1, an in-plane switching mode liquid crystal display panel capable of achieving good image quality even when used outdoors can be obtained.

Transflective liquid crystal display panels are known as liquid crystal display panels suited to display when outdoors. A transflective liquid crystal display panel has a region in which pixels display in a reflective mode (a reflective region) and a region in which pixels display in a transmissive mode (a transmissive region). The reflective region is configured, for example, by using reflective electrodes as the pixel electrodes and setting the thickness of the liquid crystal layer to approximately half the thickness of the liquid crystal layer in the transmissive region. By disposing a circular polarizing plate on the observer side, display can be carried out in the reflective mode with a single polarizing plate.

Patent Document 2 discloses a liquid crystal display panel in which at least a transmissive region is driven in a transverse electric field mode. In the transflective liquid crystal display panel disclosed in Patent Document 2, a front-side circular polarizing plate, a front-side phase difference plate (an observer side compensating plate), a transflective type LCD cell, a rear-side phase difference plate (a back surface-side compensating plate), and a rear-side polarizing plate are disposed in that order. Patent document 2 discloses a liquid crystal display panel having a liquid crystal layer in which the initial alignment is a twisted state (paragraphs [0148] to [0158], for example). By using a liquid crystal layer in which the initial alignment is a twisted state, variations in the refractive index caused by variations in the thickness of the liquid crystal layer can be suppressed better than when using a liquid crystal layer in a parallel alignment state, and thus good compensation can be achieved by the front-side phase difference plate.

### CITATION LIST

### Patent Literature

Patent Document 1: JP 2012-173672 A

Patent Document 2: JP 5278720 B

### SUMMARY OF INVENTION

### Technical Problem

The liquid crystal display panel disclosed in Patent Document 1 is an in-plane switching mode liquid crystal display panel, and considers only a liquid crystal layer in a parallel alignment state. A liquid crystal display panel using a liquid crystal layer in a parallel alignment state has a problem in that the transmittance with respect to incident circular polarized light is low. The drop in transmittance is particularly marked when using nematic liquid crystal with positive dielectric anisotropy, which have a positive anisotropy of dielectric constant. Additionally, an in-plane switching mode liquid crystal display panel using a circular polarizing plate or an elliptical polarizing plate has a problem in that when the thickness of the liquid crystal layer varies due to variations during production or the like, the quality of black displays drops. Patent Document 2 discloses using a liquid crystal layer in a twisted alignment state, which makes it possible to suppress a drop in black display quality caused by variations in the thickness of the liquid crystal layer. No mention is made, however, of the specific magnitude of retardation in the liquid crystal layer.

Having been achieved to solve the above-described problems, an object of the present invention is to provide a transverse electric field mode liquid crystal display panel that reduces reflection of outside light more than in the past and/or that improves the contrast ratio of bright parts.

### Solution to Problem

A liquid crystal display panel according to embodiments of the present invention includes: a liquid crystal cell, the liquid crystal cell including a first substrate, a second substrate, and a liquid crystal layer, the liquid crystal layer being provided between the first substrate and the second substrate; a first polarizing plate disposed on a back surface side of the liquid crystal cell; and a second polarizing plate disposed on an observer side of the liquid crystal cell. The first substrate includes an electrode pair, the electrode pair producing a transverse electric field in the liquid crystal layer. The liquid crystal layer contains nematic liquid crystals having negative dielectric anisotropy, and letting Δn be birefringence of the nematic liquid crystals and d be a thickness of the liquid crystal layer, Δnd is less than 550 nm, the liquid crystal layer is in a twisted alignment state when no voltage is applied, and when polarized light for which an absolute value |S3| of a Stokes parameter S3 is 1.00 is incident, the |S3| of polarized light transmitted through the liquid crystal layer is greater than or equal to 0.85. The first polarizing plate and the second polarizing plate are circular polarizing plates or elliptical polarizing plates having an ellipticity of greater than or equal to 0.422.

In some embodiments, Δnd of the liquid crystal layer is greater than or equal to 340 nm.

In some embodiments, Δnd of the liquid crystal layer is greater than or equal to 420 nm.

In some embodiments, the |S3| of polarized light passing through the liquid crystal layer is greater than or equal to 0.95.

In some embodiments, the twist angle of the liquid crystal layer is from 50° to less than 90°. The twist angle is 73°, for example.

In some embodiments, retardations of the first polarizing plate and the second polarizing plate are each independently from 90 nm to less than 138 nm.

In some embodiments, an angle formed by an alignment azimuthal direction of liquid crystal molecules in the liquid crystal layer near the first substrate and an azimuthal direction of a long axis of the elliptical polarized light passing through the first polarizing plate or the second polarizing plate is from 0° to 5° or from 90° to 95°.

In some embodiments, letting the twist angle of the liquid crystal layer having a twisted alignment state be θ, Δnd is generally expressed by −0.0134·θ²+0.414·θ+544.

A liquid crystal display panel according to other embodiments of the present invention includes: a liquid crystal cell, the liquid crystal cell including a first substrate, a second substrate, and a liquid crystal layer, the liquid crystal layer being provided between the first substrate and the second substrate; a first polarizing plate disposed on a back surface side of the liquid crystal cell; and a second polarizing plate disposed on an observer side of the liquid crystal cell. The first substrate includes an electrode pair, the electrode pair producing a transverse electric field in the liquid crystal layer. Letting Δn be birefringence of the nematic liquid crystals and d be a thickness of the liquid crystal layer, And is less than 550 nm, the liquid crystal layer is in a twisted alignment state when no voltage is applied, and when polarized light for which an absolute value |S3| of a Stokes parameter S3 is 1.00 is incident, the |S3| of polarized light transmitted through the liquid crystal layer is greater than or equal to 0.85. The first polarizing plate and the second polarizing plate are circular polarizing plates or elliptical polarizing plates having an ellipticity of greater than or equal to 0.422, the first polarizing plate is substantially constituted only of a first linear polarizing layer and a first phase difference layer, and the second polarizing plate is substantially constituted only of a second linear polarizing layer and a second phase difference layer.

In some embodiments, the ellipticity of the first polarizing plate and the second polarizing plate is greater than or equal to 0.575. The ellipticity of the first polarizing plate and the second polarizing plate is preferably greater than or equal to 0.617, and more preferably greater than or equal to 0.720.

In some embodiments, a retardation of the first phase difference layer and the second phase difference layer is from 105.0 nm to 170.0 nm. Preferably, the retardation of the first phase difference layer and the second phase difference layer is from 138 nm to 170 nm.

In some embodiments, an absorption axis of the first linear polarizing layer and an absorption axis of the second linear polarizing layer are not orthogonal.

In some embodiments, an angle formed by the absorption axis of the first linear polarizing layer and a slow axis of the first phase difference layer, and an angle formed by the absorption axis of the second linear polarizing layer and a slow axis of the second phase difference layer, are both less than 45° or greater than 45°.

In some embodiments, the retardation of at least one of the first phase difference layer and the second phase difference layer has a normal dispersion.

### Advantageous Effects of Invention

According to embodiments of the present invention, a transverse electric field mode liquid crystal display panel that reduces reflection of outside light more than in the past and/or that improves the contrast ratio of bright parts is provided.

### BRIEF DESCRIPTION OF DRAWINGS

FIG. 1 (a) is a schematic exploded cross-sectional view of a liquid crystal display panel 100A according to a first embodiment of the present invention, also illustrating a backlight 50; (b) is a schematic cross-section of a part corresponding to a single pixel in a liquid crystal cell 10 included in the liquid crystal display panel 100A; and (c) is a schematic plan view of a part corresponding to a single pixel in the liquid crystal cell 10.

FIG. 2 is a diagram (called an FOM) illustrating a relationship between a twist angle of a liquid crystal layer and Δnd of the liquid crystal layer, and a Stokes parameter S3 of polarized light transmitted through the liquid crystal layer when polarized light having the Stokes parameter S3 of 1.00 is incident on the liquid crystal layer, where white regions indicate regions where 1.00≥S3≥0.95 (E regions), gray regions indicate regions where 0.95≥S3≥0.85 (G regions), and black regions indicate regions where 0.85>S3 (NG regions).

FIG. 3 is a graph illustrating a relationship between the twist angle of a liquid crystal layer and Δnd of the liquid crystal layer at which the S3 of polarized light transmitted through the liquid crystal layer is 1.00.

FIG. 4A is a diagram illustrating the value of S3 in a range, in the FOM illustrated in FIG. 2, where the twist angle is from 0° to 90° (in 10° intervals), and a range where Δnd is from 310 nm to 600 nm (in 5-nm intervals).

FIG. 4B is a diagram illustrating the value of S3 in a range, in the FOM illustrated in FIG. 2, where the twist angle is from 100° to 180° (in 10° intervals), and a range where Δnd is from 310 nm to 600 nm (in 5-nm intervals).

FIG. 4C is a diagram illustrating the value of S3 in a range, in the FOM illustrated in FIG. 2, where the twist angle is from 0° to 90° (in 10° intervals), and a range where Δnd is from 5 nm to 305 nm (in 5-nm intervals).

FIG. 4D is a diagram illustrating the value of S3 in a range, in the FOM illustrated in FIG. 2, where the twist angle is from 100° to 180° (in 10° intervals), and a range where Δnd is from 5 nm to 305 nm (in 5-nm intervals).

FIG. 5 is a graph illustrating relationships between transmittances of liquid crystal display panels and Δnd of liquid crystal layers according to Examples 1-1 to 1-10.

FIG. 6 is a schematic exploded cross-sectional view of a liquid crystal display panel 100B according to a second embodiment of the present invention, also illustrating the backlight 50.

FIG. 7 is a diagram illustrating relationships between the retardations of elliptical polarizing plates and transmittances for liquid crystal display panels in which Δnd=500 nm and the twist angle is 73° in the liquid crystal layers.

FIG. 8 is a diagram illustrating relationships between screen brightnesses and contrast ratios (CR) for liquid crystal display panels in which Δnd=500 nm and the twist angle is 73° in the liquid crystal layers.

FIG. 9 is a diagram illustrating a relationship between the azimuthal direction of a long axis of elliptical polarized light based on the azimuthal direction of a transverse electric field and a transmittance, for a liquid crystal display panel according to Example 2-3.

FIG. 10 is a diagram illustrating a relationship between the azimuthal direction of a long axis of elliptical polarized light based on the azimuthal direction of a transverse electric field and an alignment azimuthal direction of liquid crystal molecules.

FIG. 11 is a diagram illustrating a relationship between the alignment azimuthal direction of liquid crystal molecules in the center of the thickness direction of a liquid crystal layer based on the azimuthal direction of a transverse electric field, and a transmittance.

FIGS. 12 (a) and (b) are diagrams schematically illustrating changes in the alignment azimuthal direction of a liquid crystal molecule in a transverse electric field, where (a) illustrates a case where a twist direction is counter-clockwise (left rotation) and (b) illustrates a case where the twist direction is clockwise (right rotation).

FIG. 13 is a graph illustrating a distribution of azimuthal directions of liquid crystal molecules with respect to the azimuthal direction of a transverse electric field in a region, of a liquid crystal layer in a voltage applied state, where the strength of the transverse electric field is highest.

FIG. 14 is a graph illustrating a distribution of azimuthal directions of liquid crystal molecules with respect to the azimuthal direction of a transverse electric field in a region, of a liquid crystal layer in a voltage applied state, where the strength of the transverse electric field is lowest.

FIG. 15 (a)˜(d) are schematic diagrams illustrating the configurations of liquid crystal display panels 100Aa, 100Ab, 100Ac, and 100Ad having different combinations of circular polarized light rotation directions and liquid crystal layer twist directions.

FIG. 16 (a) is a schematic exploded cross-sectional view of a liquid crystal display panel 100C according to a third embodiment of the present invention, and (b) is a schematic exploded cross-sectional view of a liquid crystal display panel 100D according to a reference example.

FIGS. 17 (a)˜(c) are diagrams illustrating, on Poincare spheres, the trajectories of transitions in polarization states in a black display state of a liquid crystal display panel according to Comparative Example 3-1; (d) is a diagram illustrating a trajectory in an S1-S2 plane; and (e) to (g) are diagrams schematically illustrating the trajectories of transitions in polarization states resulting from Δnd of liquid crystal layers.

FIG. 18 (a)˜(f) are diagrams illustrating, on Poincare spheres, the trajectories of transitions in polarization states in black display states of liquid crystal display panels according to Comparative Example 3-2 and Comparative Example 3-3.

FIG. 19 (a)˜(c) are diagrams illustrating, on Poincare spheres, the trajectories of transitions in polarization states in a black display state of a liquid crystal display panel according to Comparative Example 3-4; and FIG. 19D is a diagram illustrating a trajectory in an S1-S2 plane.

FIG. 20 (a)˜(f) are diagrams illustrating, on Poincare spheres, the trajectories of transitions in polarization states in black display states of liquid crystal display panels according to Comparative Example 3-5 and Comparative Example 3-6.

FIG. 21 is a diagram illustrating spectra of black display states of liquid crystal display panels according to Comparative Examples 3-1 to 3-6.

FIG. 22 (a)˜(c) are diagrams illustrating, on Poincare spheres, the trajectories of transitions in polarization states in a black display state of a liquid crystal display panel according to Example 4-1; and (d)˜(f) are diagrams schematically illustrating the trajectories of transitions in polarization states resulting from Δnd of liquid crystal layers.

FIG. 23 (a)˜(f) are diagrams illustrating, on Poincare spheres, the trajectories of transitions in polarization states in black display states of liquid crystal display panels according to Example 4-2 and Example 4-3.

FIG. 24 (a)˜(c) are diagrams illustrating, on Poincare spheres, the trajectories of transitions in polarization states in a black display state of a liquid crystal display panel according to Reference Example 3-1; and (d) is a diagram illustrating an optical compensation mechanism using a compensation layer 23Cr.

FIG. 25 (a)˜(f) are diagrams illustrating, on Poincare spheres, the trajectories of transitions in polarization states in black display states of liquid crystal display panels according to Reference Example 3-2 and Reference Example 3-3.

FIG. 26 is a diagram illustrating spectra of black display states of liquid crystal display panels according to Examples 4-1 to 4-3 and Reference Examples 3-1 to 3-3.

FIG. 27 (a)˜(c) are diagrams illustrating, on Poincare spheres, the trajectories of transitions in polarization states in a black display state of a liquid crystal display panel according to Example 4-4; and (d)˜(f) are diagrams schematically illustrating the trajectories of transitions in polarization states resulting from Δnd of liquid crystal layers.

FIG. 28 (a)˜(i) are diagrams illustrating, on Poincare spheres, the trajectories of transitions in polarization states in black display states of liquid crystal display panels according to Examples 4-5 to 4-7.

FIG. 29 is a diagram showing results of calculating a ratio of light, orthogonally incident on an elliptical polarizing plate disposed above a mirror, that is reflected by the mirror and transmitted through and emitted from the elliptical polarizing plate.

FIG. 30 is a diagram illustrating results of calculating a ratio of light, orthogonally incident on an elliptical polarizing plate disposed above a mirror, that is reflected by the mirror and transmitted through and emitted from the elliptical polarizing plate, showing a region of a retardation and Phi at which an internal reflection remainder rate is less than or equal to 0.25 (the region to the right of the bold line).

FIG. 31 is a diagram illustrating values of ellipticity of a polarizing plate instead of the internal reflection remainder rate in FIG. 30.

FIG. 32 is a diagram illustrating a relationship between an internal reflection remainder rate and a bright part contrast ratio (CR) in a 20000 lux environment, found through a simulation.

FIGS. 33 (a)˜(l) are diagrams illustrating, on Poincare spheres, the trajectories of transitions in polarization states in black display states of liquid crystal display panels according to Examples 4-8 to 4-11.

FIG. 34 (a)˜(l) are diagrams illustrating, on Poincare spheres, the trajectories of transitions in polarization states in black display states of liquid crystal display panels according to Examples 4-12 to 4-15.

FIG. 35 is a diagram illustrating, on Poincare spheres, the trajectories of transitions in polarization states in a black display state of a liquid crystal display panel according to Example 4-16.

FIG. 36 is a diagram illustrating spectra of black display states of liquid crystal display panels according to Examples 4-4 to 4-16.

FIG. 37 is a diagram illustrating, on Poincare spheres, the trajectories of transitions in polarization states in black display states of liquid crystal display panels according to Examples 4-17 and 18 and Reference Examples 3-4 and 3-5.

FIG. 38 is a diagram illustrating, on Poincare spheres, the trajectories of transitions in polarization states in a black display state of a liquid crystal display panel according to Example 4-19.

FIG. 39 is a diagram illustrating spectra of black display states of liquid crystal display panels according to Examples 4-17 to 4-19 and Reference Examples 3-4 and 3-5.

FIG. 40 (a)˜(l) are diagrams illustrating, on Poincare spheres, the trajectories of transitions in polarization states in black display states of liquid crystal display panels according to Examples 4-20 and 4-21 and Reference Examples 3-6 and 3-7.

FIG. 41 is a diagram illustrating, on Poincare spheres, the trajectories of transitions in polarization states in a black display state of a liquid crystal display panel according to Example 4-22.

FIG. 42 is a diagram illustrating spectra of black display states of liquid crystal display panels according to Examples 4-20 to 4-22 and Reference Examples 3-6 and 3-7.

FIG. 43 (a)˜(e) are graphs illustrating preferred relationships of various design parameters of a polarizing plate with respect to the twist angle of a liquid crystal layer.

FIG. 44 (a)˜(e) are graphs illustrating preferred relationships of various design parameters with respect to the ellipticity of a polarizing plate.

### DESCRIPTION OF EMBODIMENT

A liquid crystal display panel according to embodiments of the present invention includes: a liquid crystal cell including a first substrate (a back surface-side substrate, such as a TFT substrate, disposed on a backlight-side substrate), a second substrate (an observer side-substrate, such as a color filter substrate), and a liquid crystal layer provided between the first substrate and the second substrate; a first polarizing plate disposed on the back surface side of the liquid crystal cell; and a second polarizing plate disposed on the observer side of the liquid crystal cell.

The first substrate has an electrode pair producing a transverse electric field in the liquid crystal layer, and letting Δn be the birefringence of nematic liquid crystals and d be the thickness of the liquid crystal layer, Δnd is less than 550 nm, the liquid crystal layer is in a twisted alignment state when no voltage is applied, and when polarized light for which the absolute value |S3| of the Stokes parameter S3 is 1.00 for light having a wavelength of 550 nm is incident, the |S3| of the polarized light passing through the liquid crystal layer is greater than or equal to 0.85. Here, |S3| is a value standardized so that S0=1. The first polarizing plate and the second polarizing plate are both circular or elliptical polarizing plates, and the ellipticities (the short axis divided by the long axis of an ellipse) of polarized light after passing therethrough are each independently from 0.422 to 1.000. To distinguish the polarity of the elliptical polarized light (right rotation or left rotation), definitions in which a sign is added to the ellipticity (positive for rightward elliptical polarized light, negative for leftward elliptical polarized light) may be used; however, unless otherwise specified, “ellipticity” refers to the absolute value of the ellipticity in the present specification.

A circular polarizing plate and an elliptical polarizing plate typically have a layered structure with a linear polarizing layer that transmits linear polarized light and a phase difference layer. In the present specification, the retardation of the phase difference layer in the polarizing plate is sometimes called the “retardation of the polarizing plate”. Furthermore, unless specified otherwise, the retardation (or phase difference) is an “in-plane retardation” in the present specification. In-plane retardation (in-plane phase difference) refers to a retardation (phase difference) with respect to two linear polarized lights orthogonal to each other and incident orthogonally on a polarizing plate (phase difference layer). Letting the thickness of the phase difference layer be d, in-plane principle refractive indices be nx and ny, and a principle refractive index in the normal direction be nz, the in-plane retardation is defined as (nx−ny)×d. As such, ((nx+ny)/2−nz)×d is sometimes defined as a thickness direction retardation.

As will be described in first and second embodiments, a polarizing plate having an ellipticity of from 0.422 to 1.000 (a circular polarizing plate or an elliptical polarizing plate) is achieved by, for example, arranging the slow axis of a phase difference layer having a retardation of from 70 nm to 138 nm to form an angle of 45° with respect to the polarization axis (orthogonal to the absorption axis) of a linear polarizing layer. As will be described in a third embodiment, a polarizing plate having an ellipticity of from 0.422 to 1.000 can also be achieved by, for example, arranging the slow axis of a phase difference layer having a retardation greater than 138 nm to form an angle of greater than 45° (less than 90°) with respect to the polarization axis of a linear polarizing layer (i.e., so that the slow axis of the phase difference layer forms an angle of less than 45° (greater than 0°) with respect to the absorption axis of the linear polarizing layer). Aside from the above examples, a polarizing plate having an ellipticity of from 0.422 to 1.000 can also be achieved by, for example, arranging the slow axis of a phase difference layer having a retardation of from 138 nm to 206 nm (=138+(138−70) nm) to form an angle of 45° with respect to the polarization axis (orthogonal to the absorption axis) of a linear polarizing layer. Furthermore, such a polarizing plate can also be achieved by arranging the slow axis of a phase difference layer having a retardation of greater than 138 nm to form an angle of less than 45° (greater than 0°) with respect to the polarization axis of a linear polarizing layer. Such a polarizing plate can also be achieved by arranging the slow axis of a phase difference layer having a retardation of greater than 138 nm to form an angle of greater than 45° (less than 90°) with respect to the polarization axis of a linear polarizing layer.

The liquid crystal display panel according to embodiments of the present invention is a liquid crystal display panel having a transverse electric field mode, such as an in-plane switching mode or a fringe field switching mode. The liquid crystal layer may contain nematic liquid crystals having positive dielectric anisotropy, or nematic liquid crystals having negative dielectric anisotropy. In a transverse electric field mode liquid crystal display panel, when a voltage is applied to the electrode pair that produces the transverse electric field in the liquid crystal layer, vertical electrical field components are produced (e.g., near the edges of the electrode pair) in addition to the transverse electric field (an electrical field in the horizontal direction; an electrical field parallel to the liquid crystal layer surface) in the liquid crystal layer. The liquid crystal molecules of nematic liquid crystals having positive dielectric anisotropy align so that the long axes of the molecules are parallel to the electrical field, and thus the liquid crystal molecules stand up in regions of strong vertical electrical field components. This results in retardation unevenness and insufficient twisting in the liquid crystal layer plane. On the other hand, the liquid crystal molecules of nematic liquid crystals having negative dielectric anisotropy align so that the long axes of the molecules are orthogonal to the electrical field, and thus the liquid crystal molecules stand up little even in regions of strong vertical electric field components, maintaining an alignment parallel to the liquid crystal layer plane. As such, an advantage in that a high display quality can be achieved can be realized by using nematic liquid crystal having negative dielectric anisotropy. This effect is greater in fringe field switching mode liquid crystal display panels, where many vertical electric field components are produced, than in an in-plane switching mode. Thus, a fringe field switching mode liquid crystal display panel is described as an example in the first to third embodiments.

Additionally, Δnd, which is the product of the birefringence Δn of the nematic liquid crystals constituting the liquid crystal layer and the thickness d of the liquid crystal layer, is less than 550 nm, and thus the so-called λ conditions for black display (Δnd=550 nm) are not met while in an untwisted parallel alignment. 550 nm is used as the wavelength λ because 550 nm, which has the highest visibility, is typically used for the wavelength λ for design purposes.

Additionally, the liquid crystal layer is in a twisted alignment state when no voltage is applied, and when polarized light for which the absolute value |S3| of the Stokes parameter S3 is 1.00 is incident, the |S3| of the polarized light passing through the liquid crystal layer is greater than or equal to 0.85. Here, there are four Stokes parameters, namely S0, S1, S2, and S3. When S0, S1, S2, and S3 represent an intensity, a horizontal linear polarized light component, a 45° linear polarized light component, and a rightward circular polarized light component, respectively, and with completely polarized light (linear polarized light, circular polarized light, or elliptical polarized light), a relationship of S1²+S2²+S3²=S0² is established. S3=1 when S0=1 indicates rightward circular polarized light, whereas S3=−1 when S0=1 indicates leftward circular polarized light. In other words, the absolute value |S3| of the Stokes parameter S3 being 1.00 means rightward circular polarized light where S3=1.00 or leftward circular polarized light where S3=−1.00. A case where polarized light having an |S3| of 1.00 is incident and the |S3| of the polarized light passing through the liquid crystal layer is greater than or equal to 0.85 is specifically a case where polarized light having an S3 of 1.00 is incident and the S3 of the polarized light passing through the liquid crystal layer is greater than or equal to 0.85, and a case where polarized light having an S3 of −1.00 is incident and the S3 of the polarized light passing through the liquid crystal layer is less than or equal to −0.85.

Liquid crystal display panels according to embodiments of the present invention will be described hereinafter using an example in which incident polarized light (referring to “polarized light emitted from a backlight and transmitted through a first polarizing plate”) is rightward circular polarized light (S=1.00). However, the present invention can be applied in the case where the incident polarized light is leftward circular polarized light (S=−1.00) in the same manner. Note that in the case where the first polarizing plate transmits rightward circular polarized light, the second polarizing plate is configured to transmit leftward circular polarized light, and conversely, in the case where the first polarizing plate transmits leftward circular polarized light, the second polarizing plate is configured to transmit rightward circular polarized light.

The twist direction of the liquid crystal layer refers to the twist direction, when viewed from the observer side, of the long axes of the liquid crystal molecules from the back surface-side substrate (called a “bottom substrate” hereinafter) toward the observer side-substrate (called a “top substrate” hereinafter). Although the following will describe a case where the twist direction of the liquid crystal layer is leftward (i.e., counter-clockwise) (see FIG. 12A), the present invention can be applied in the case where the twist direction of the liquid crystal layer is rightward (i.e., clockwise) (see FIG. 12 (b)) in the same manner. A combination of the rotation direction of circular polarized light and the twist direction of the liquid crystal layer will be described later.

The λ conditions of the liquid crystal display panel are typically discussed for cases where a natural mode of polarized light propagating in the liquid crystal layer is linear polarized light. In this case, Δnd=550 nm corresponds to the λ conditions for a liquid crystal layer in a parallel alignment state. Rightward circular polarized light incident on a liquid crystal layer satisfying the λ conditions is also rightward circular polarized light upon passing through the liquid crystal layer. However, a liquid crystal layer in which Δnd is less than 550 nm does no satisfy the λ conditions, and thus rightward circular polarized light incident on a liquid crystal layer in which Δnd is less than 550 nm is no longer rightward circular polarized light upon passing through the liquid crystal layer. On the other hand, the natural model of polarized light propagating in a liquid crystal layer in a twisted alignment state is elliptical polarized light, and thus the λ conditions are typically discussed only in terms of the value of Δnd. The inventors of the present invention surprisingly found that with a liquid crystal layer in a twisted alignment state, there is a twist angle at which rightward circular polarized light incident on the liquid crystal layer is also rightward circular polarized light upon passing through the rightward circular polarized light, even when Δnd is less than 550 nm. In the present specification, the conditions at which rightward circular polarized light incident on the liquid crystal layer is also rightward circular polarized light upon exiting the liquid crystal layer for a liquid crystal layer in a twisted alignment state are called “semi-λ conditions” to distinguish these conditions from the aforementioned typical “λ conditions”.

The first polarizing plate and the second polarizing plate in the liquid crystal display panel according to embodiments of the present invention (including all of the first to third embodiments) are circular polarizing plates or elliptical polarizing plates having an ellipticity of greater than or equal to 0.422. The polarizing plate in the liquid crystal display panel according to the first and second embodiments can be achieved by, for example, arranging the slow axis of a phase difference layer having a retardation of from 70 nm to 138 nm to form an angle of 45° with respect to the polarization axis of a linear polarizing layer. Here, the polarizing plate retardations of the first polarizing plate and the second polarizing plate may be any retardations of from 70 nm to 138 nm independently. Letting λ be 550 nm, the quarter wave (λ/4) is 137.5 nm, resulting in a value of 138 nm when rounding off one decimal place. In other words, the retardation of a polarizing plate being 138 nm means that that polarizing plate is a circular polarizing plate. A circular polarizing plate is typically configured by layering a linear polarizing layer and a quarter wave (λ/4) layer. An angle formed by the polarization axis (transmission axis) of the linear polarizing layer and the slow axis of the λ/4 layer is 45°. Rightward circular polarized light is circular polarized light in which the rotation direction of an electric field vector is rightward (i.e., clockwise) when viewed in the travel direction of the polarized light. Rightward circular polarized light can be obtained by arranging the slow axis of the λ/4 layer at a position rotated rightward from the polarization axis of the linear polarizing layer by 45° when viewed in the travel direction of the polarized light.

The first polarizing plate and the second polarizing plate in the liquid crystal display panel according to embodiments of the present invention may be circular polarizing plates (with a retardation of 138 nm) independently, as in the liquid crystal display panel according to the first polarizing plate, or may be elliptical polarizing plates (with a retardation of greater than or equal to 70 nm and less than 138 nm), as in the liquid crystal display panel according to the second embodiment. The retardation is a value required in the case where the slow axis of the phase difference layer is arranged in a position 45° with respect to the polarization axis of the linear polarizing layer; the slow axis of the phase difference layer may be arranged at an angle aside from 45°, and the ellipticity may be any ellipticity greater than or equal to 0.422. In other words, the retardation of the phase difference layer may be greater than or equal to 138 nm in the case where the slow axis of the phase difference layer is arranged at an angle aside from 45° with respect to the polarization axis (or absorption axis) of the linear polarizing layer.

An effect of suppressing the reflection of outside light incident on the liquid crystal display panel from the observer side in a state where no voltage is applied (a black display state) is high when a circular polarizing plate is used for at least the second polarizing plate. The reflection of outside light at the liquid crystal display panel is higher at the top substrate (before passing through the liquid crystal layer) than at the bottom substrate (after passing through the liquid crystal layer). Specifically, a black matrix (BM) layer formed on the top substrate of the liquid crystal cell, a color filter (CF) layer, or a transparent conductive layer (e.g., an ITO layer provided to prevent electrostatic charge in a fringe field switching mode liquid crystal display panel) have high reflection. Additionally, in a liquid crystal display panel that includes a touch panel (on-cell or in-cell), a top-side substrate includes a transparent conductive layer and/or metal wires, and the reflection from these is high as well. Using a circular polarizing plate as the second polarizing plate is preferable in order to most effectively suppress reflection from the aforementioned constituent elements formed on the top substrate of a liquid crystal cell (the liquid crystal layer side or the observer side of the top substrate) in this manner. The liquid crystal display panel according to embodiments of the present invention may have a touch panel function layer between the first polarizing plate and the second polarizing plate. A liquid crystal display panel including a touch panel according to embodiments may be an in-cell type, in which the touch panel function layer is provided within the liquid crystal cell, or an on-cell type, in which the touch panel function layer is layered on the outside of the liquid crystal cell. Note that outside light incident on the liquid crystal display panel from the observer side is also reflected by pixel electrodes, a common electrode, and various wires formed in the bottom substrate after passing through the liquid crystal layer.

On the other hand, in the case where elliptical polarizing plates are used as the first polarizing plate and the second polarizing plate, the amount of light emitted from the backlight and transmitted through the liquid crystal layer can be increased (the brightness can be increased) in a voltage applied state (a white display state) more than in the case where circular polarizing plates are used for both the first polarizing plate and the second polarizing plate. This is because some of the light emitted from the backlight and reflected by pixel electrodes, a common electrode, and various wires formed in the bottom substrate can be reused. However, in a case where the retardation becomes less than 70 nm (an ellipticity of less than 0.422), the effect of suppressing reflection of light incident from the observer side will drop too much, resulting in a drop in the contrast ratio.

Furthermore, by adjusting the configurations of the phase difference layers of the first polarizing plate and the second polarizing plate and the liquid crystal layer (a third embodiment), a good black display with little light leakage can be achieved without providing an optical compensation layer (called simply a “compensation layer” hereinafter) that compensates for optical anisotropy of a liquid crystal layer in a twisted alignment state. It is difficult and expensive to manufacture a compensation layer for compensating for optical anisotropy of a liquid crystal layer in a twisted alignment state, and thus being able to omit such a layer is highly advantageous. The liquid crystal display panel according to the third embodiment achieves a good black display with a simple configuration while reducing reflection more than in the past and/or improving the contrast ratio of bright parts.

The inventors of the present invention found that setting a liquid crystal layer in a twisted alignment state to satisfy the semi-λ conditions makes it possible to carry out displays using a circular polarizing plate or an elliptical polarizing plate even in a display mode using a transverse electric field, and makes it possible to effectively suppress reflection in the liquid crystal display panel. The inventors also found that using an elliptical polarizing plate improves the display luminance. The inventors further discovered a simple configuration that efficiently compensates for optical anisotropy of a liquid crystal layer in a twisted alignment state.

The structure of a liquid crystal display panel according to embodiments of the present invention will be described below with reference to the drawings. In the descriptions of the drawings below, constituent elements having substantially identical functions will be given identical reference signs, and descriptions thereof will be omitted.

The first embodiment is a liquid crystal display panel in which circular polarizing plates (with a phase difference layer retardation of 138 nm) are used as the first polarizing plate and the second polarizing plate. The second embodiment is a liquid crystal display panel in which elliptical polarizing plates (with a phase difference layer retardation of less than 138 nm) are used as the first polarizing plate and the second polarizing plate, and a compensation layer that compensates for optical anisotropy of the liquid crystal layer in a twisted alignment state is included. The third embodiment is a liquid crystal display panel that does not include a compensation layer that compensates for optical anisotropy of the liquid crystal layer in a twisted alignment state. The first polarizing plate and the second polarizing plate included in the liquid crystal display panel of the third embodiment may be circular polarizing plates or elliptical polarizing plates.

To facilitate understanding, the embodiments will be described next in order from the first embodiment.

### First Embodiment

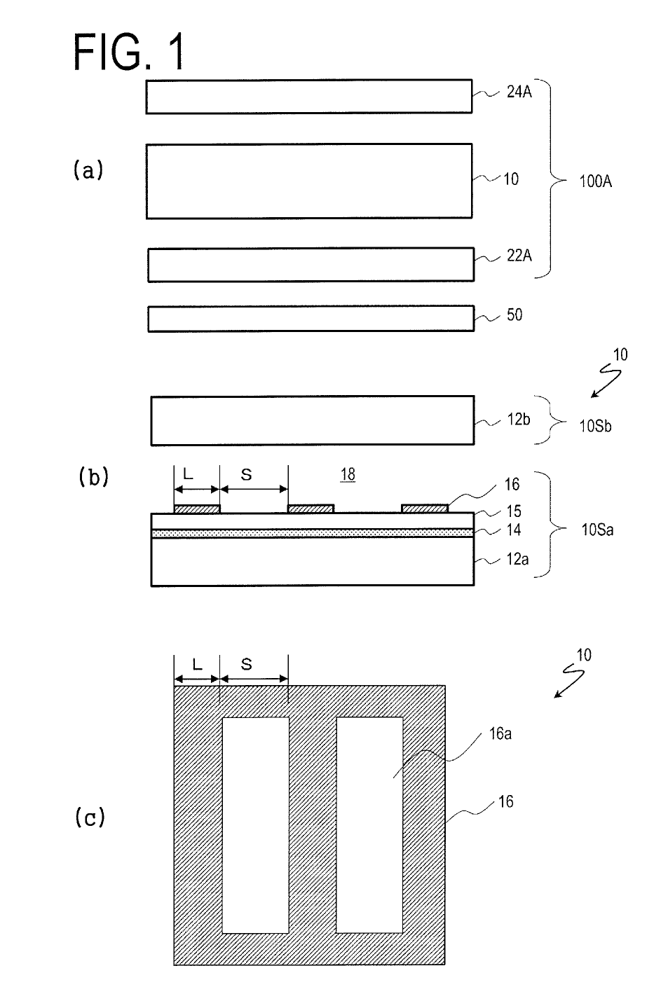

The structure of a liquid crystal display panel 100A according to the first embodiment of the present invention will be described with reference to FIG. 1. The first embodiment describes a case where circular polarizing plates (with a retardation of 137.5 nm) are used as the first and second polarizing plates.

FIG. 1 (a) is a schematic exploded cross-sectional view of the liquid crystal display panel 100A according to the first embodiment of the present invention, also illustrating a backlight 50. A liquid crystal display device according to the first embodiment of the present invention is a transmissive mode liquid crystal display device including the liquid crystal display panel 100A and the backlight 50. FIG. 1 (b) is a schematic cross-section of a part corresponding to a single pixel in a liquid crystal cell 10 included in the liquid crystal display panel 100A, and FIG. 1 (c) is a schematic plan view of a part corresponding to a single pixel in the liquid crystal cell 10.

The liquid crystal display panel 100A includes the liquid crystal cell 10, a first polarizing plate 22A, and a second polarizing plate 24A. The first polarizing plate 22A and the second polarizing plate 24A are both circular polarizing plates, and have a retardation of 137.5 nm.

As illustrated in FIG. 1 (b), the liquid crystal cell 10 includes a first substrate 10Sa, a second substrate 10Sb, and a liquid crystal layer 18 provided between the first substrate 10Sa and the second substrate 10Sb. The first substrate 10Sa includes a transparent substrate 12a, a common electrode 14 formed on the transparent substrate 12a, a dielectric layer 15 formed on the common electrode 14, and pixel electrodes 16 formed on the dielectric layer 15. A protection film, an alignment film, or the like is formed on the liquid crystal layer 18 side of the pixel electrodes 16 as necessary. The first substrate 10Sa may also include thin film transistors (called “TFTs” hereinafter) for supplying display signal voltages to the pixel electrodes 16, as well as gate bus lines and source bus lines for supplying signal voltages to the TFTs (none of which are illustrated). The first substrate 10Sa includes electrode pairs that produce transverse electric fields in the liquid crystal layer 18, and here, the common electrode 14 and the pixel electrodes 16 form the electrode pairs. As illustrated in FIG. 1 (c), the pixel electrodes 16 have a plurality of rectangular openings 16a extending parallel to each other. The liquid crystal cell 10 is a fringe field switching mode liquid crystal cell. The second substrate 10Sb includes a transparent substrate 12b. For example, a color filter layer or an alignment film (neither of which are illustrated) can be formed on the liquid crystal layer 18 side of the transparent substrate 12b. The fringe field switching mode liquid crystal display panel according to this embodiment of the present invention is not limited to the example described here, and can be broadly applied in known fringe field switching mode liquid crystal display panels. For example, the arrangement relationship of the common electrode 14 and the pixel electrodes 16 may be reversed.

The liquid crystal display panel 100A does not have a phase difference plate between the liquid crystal cell 10 and the first polarizing plate 22A and second polarizing plate 24A; however, a phase difference plate for compensating for wavelength dispersion of the refractive index of the liquid crystal layer 18 and/or differences in retardation depending on the wavelength, for example, may be provided between the liquid crystal cell 10 and the first polarizing plate 22A on the backlight 50 side of the liquid crystal cell 10, and/or between the liquid crystal cell 10 and the second polarizing plate 24A on the observer side of the liquid crystal cell 10. In the liquid crystal display panel 100A according to this embodiment of the present invention, the second polarizing plate 24A on the observer side is a circular polarizing plate, and thus the second polarizing plate 24A functions to suppress a situation in which outside light incident from the observer side is reflected by the liquid crystal display panel 100A and emitted toward an observer. Thus, in the case where a phase difference plate is provided between the liquid crystal cell 10 and the second polarizing plate 24A, it is preferable that the phase difference plate not alter the state of circular polarized light passing through the second polarizing plate 24A.

A relationship between the aforementioned semi-λ conditions and twist angle, and the reflection suppression effect and transmittance, was examined through a simulation. The configuration of the liquid crystal cell 10 used in the simulation is as follows.

A width S of the openings 16a was set to 5 μm, while a distance L between the openings 16a and a distance L from the openings 16a to the edges of the pixel electrodes 16 was set to 3 μm. In other words, a slitted structure in which L/S is 3 μm/5 μm was used. A birefringence Δn of a nematic liquid crystal material having negative dielectric anisotropy, constituting the liquid crystal layer 18, was set to 0.12, and a dielectric constant Δε was set to −7. And of the liquid crystal layer 18 was adjusted by changing the thickness of the liquid crystal layer 18 (also called the “cell thickness”). The thickness of the dielectric layer 15 was set to 100 nm, and the relative dielectric constant was set to 6. An LCDMaster 2-D (Shintech, Inc.) was used in the simulation.

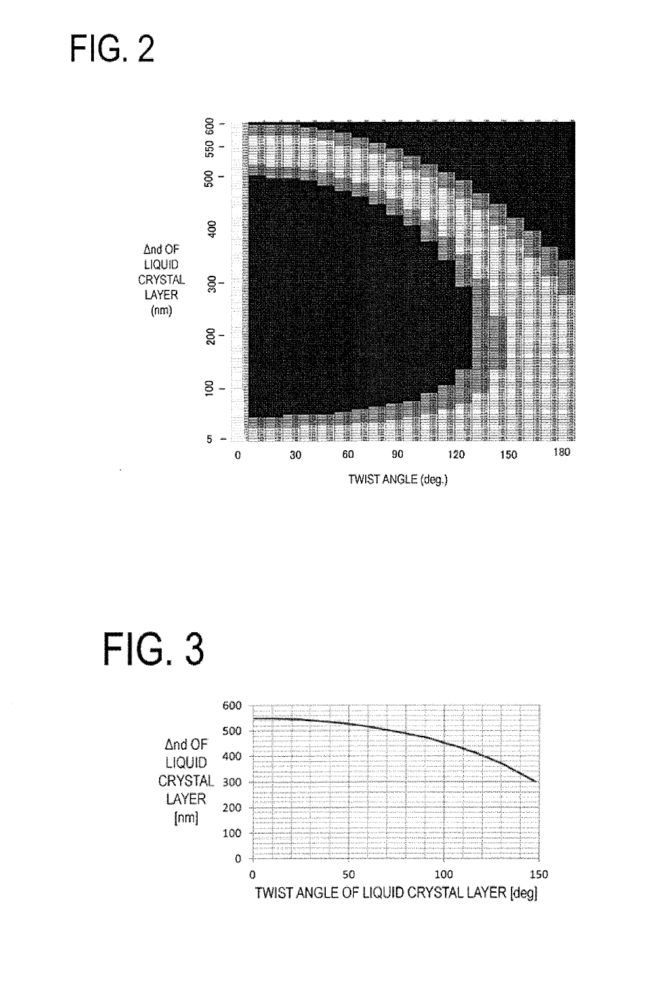

FIG. 2 illustrates results of the simulation. FIG. 2 is a diagram illustrating a relationship between the twist angle of the liquid crystal layer and And of the liquid crystal layer, and the Stokes parameter S3 of polarized light passing through the liquid crystal layer when polarized light having a Stokes parameter S3 of 1.00 is incident on the liquid crystal layer. This diagram will be called a “Figure of merit (FOM)”. In the FOM, white regions indicate regions where the S3 of the polarized light passing through the liquid crystal layer satisfies 1.00≥S3≥0.95 (E regions), gray regions indicate regions satisfying 0.95>S3≥0.85 (G regions), and black regions indicate regions where 0.85>S3 (NG regions). A region where the twist angle is greater than 0° (i.e., where the liquid crystal layer is in a twisted alignment state), and where Δnd≠550 nm and S=1.00, is a region where the semi-λ conditions are satisfied, but the E regions (white regions) and G regions (gray regions) also substantially satisfy the semi-λ conditions. Note that a twist angle of 0° and Δnd of 550 nm correspond to the λ conditions.

Ideal semi-λ conditions at which the S3 of the polarized light passing through the liquid crystal layer becomes 1.00 in the FOM are illustrated in FIG. 3. The ideal semi-λ conditions illustrated in FIG. 3 are expressed by Δnd≈−0.0134·θ²+0.414·θ+544.

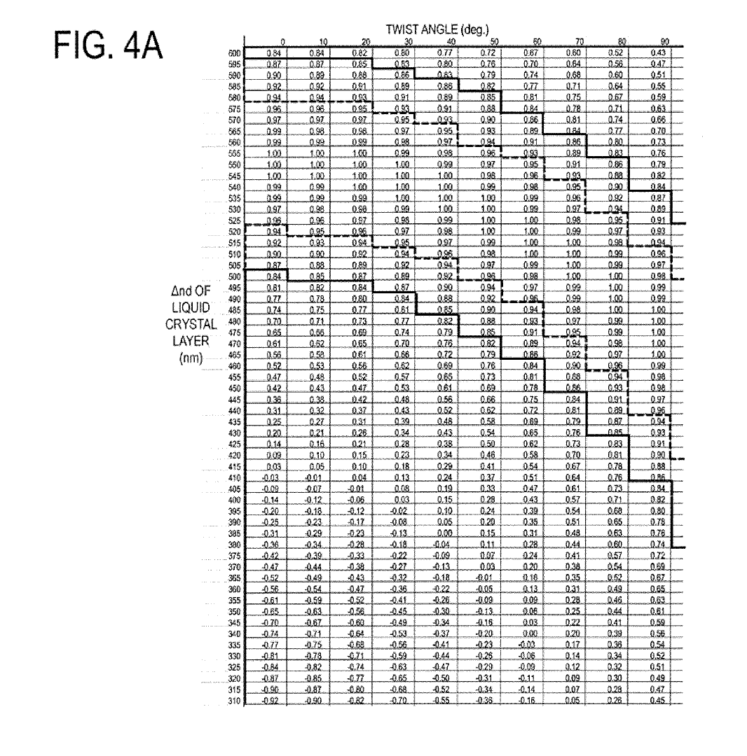

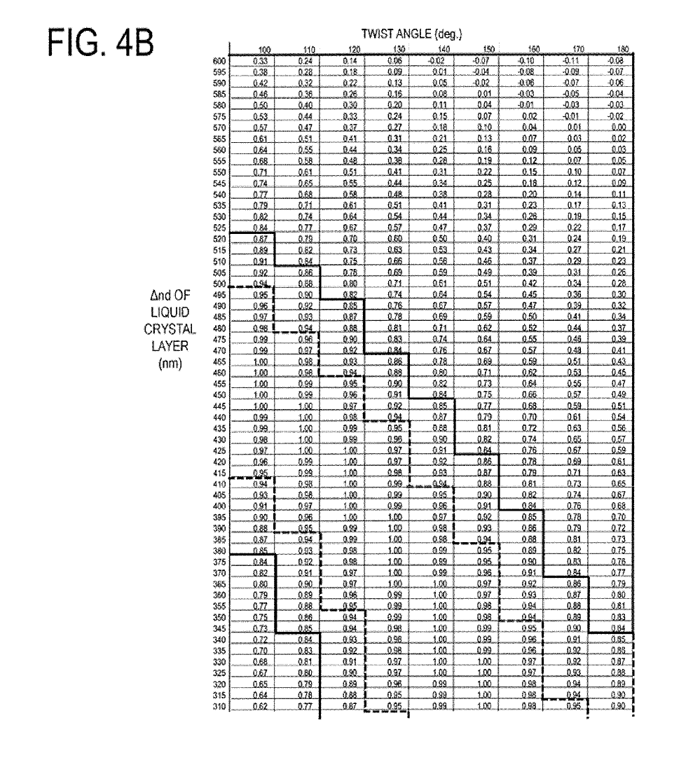

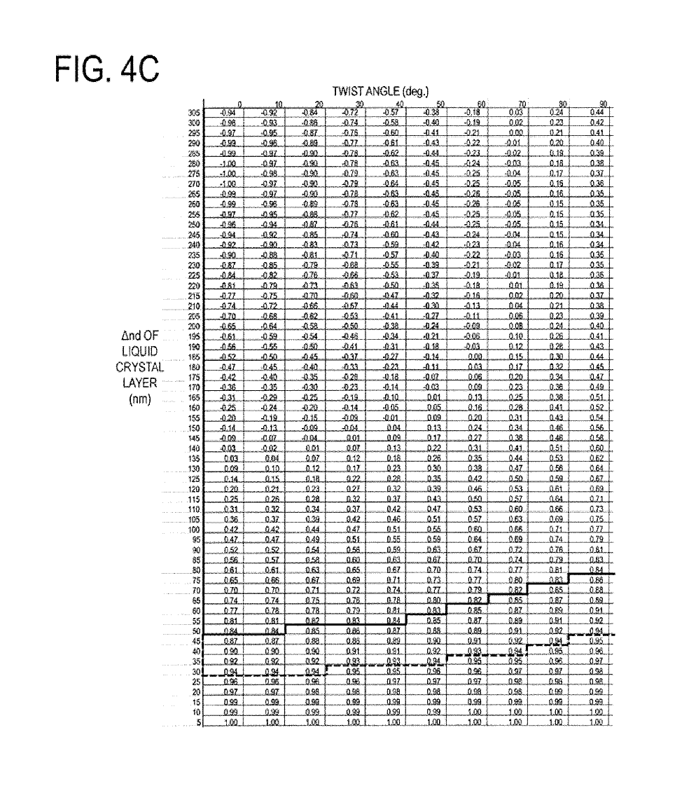

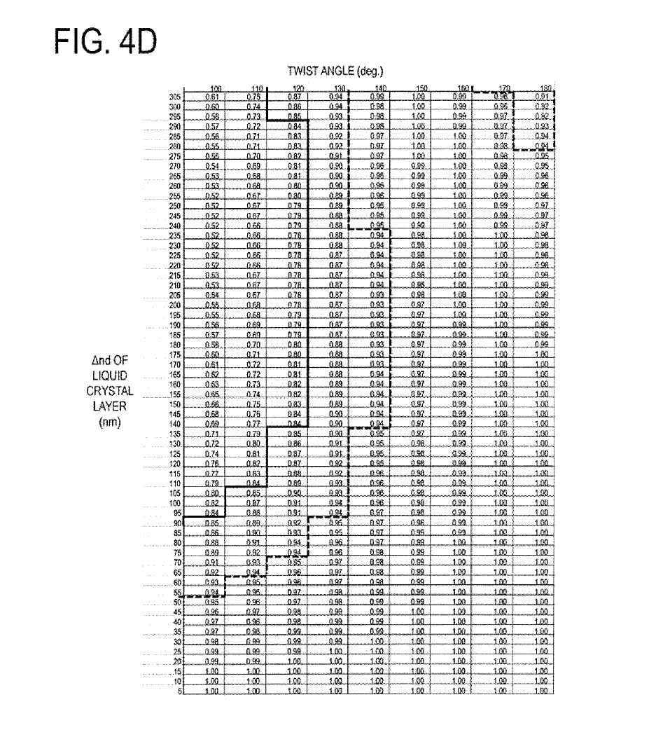

Furthermore, numerical values of the S3 of the polarized light passing though the liquid crystal layer are illustrated in FIGS. 4A to 4D, which are enlargements of the FOM illustrated in FIG. 2. FIG. 4A is a diagram illustrating the value of S3 in a range where the twist angle is from 0° to 90° (in 10° intervals), and a range where Δnd is from 310 nm to 600 nm (in 5-nm intervals); FIG. 4B is a diagram illustrating the value of S3 in a range where the twist angle is from 100° to 180° (in 10° intervals), and a range where Δnd is from 310 nm to 600 nm (in 5-nm intervals); FIG. 4C is a diagram illustrating the value of S3 in a range where the twist angle is from 0° to 90° (in 10° intervals), and a range where Δnd is from 5 nm to 305 nm (in 5-nm intervals); and FIG. 4D is a diagram illustrating the value of S3 in a range where the twist angle is from 100° to 180° (in 10° intervals), and a range where Δnd is from 5 nm to 305 nm (in 5-nm intervals).

First, as can be seen from FIG. 2, the region satisfying the semi-λ conditions is, though limited, unexpectedly broad. Additionally, the greater the twist angle is, the lower the value of Δnd satisfying the semi-λ conditions, and the broader the range of Δnd. And depends on the thickness of the liquid crystal layer and is thus susceptible to the effects of variations during production. Thus, considering production margins, it is preferable that the twist angle be greater.

The closer the numerical value of the S3 of the polarized light passing through the liquid crystal layer, illustrated in FIGS. 2 and 4A to 4D, is to 1.00, the closer the polarized light emitted from the backlight and passing through the liquid crystal layer is to circular polarized light transmitted through the first polarizing plate, and thus setting the second polarizing plate to transmit circular polarized light in the reverse direction as that of the first polarizing plate makes it possible to carry out a black display. Accordingly, to increase the quality of black display, it is preferable to select a region in which the numerical value of the S3 of the polarized light passing through the liquid crystal layer is close to 1.00.

Additionally, the closer the numerical value of the S3 of the polarized light passing through the liquid crystal layer is to 1.00, the greater the effect of suppressing reflected light (where the rotation direction of the circular polarized light is reversed) at the first substrate 10Sa will be. In other words, after circular polarized light incident from the observer side and transmitted through the second polarizing plate passes through the liquid crystal layer, is reflected by the electrodes, wires, and the like on the first substrate 10Sa, and becomes circular polarized light having the opposite rotation direction from the circular polarized light transmitted through the second polarizing plate, even in a case that circular polarized light once again passes through the liquid crystal layer, the light is close to circular polarized light having the opposite rotation direction from the circular polarized light transmitted through the second polarizing plate, and therefore cannot be transmitted through the second polarizing plate. In this manner, in a case where the numerical value of the S3 of the polarized light passing through the liquid crystal layer is close to 1.00, not only can reflections in the second substrate 10Sb be suppressed, but reflections in the first substrate 10Sa can be suppressed as well. PTL 1 makes no mention of suppressing reflection in the first substrate 10Sa.

The results of finding the transmittances of liquid crystal display panels according to Examples 1-1 to 1-10, in which the liquid crystal layer has different Δnd and twist angles θ, are shown in Table 1. Here, the transmittance is the transmittance corresponding to a white display state, and is a transmittance arising when 5 V is applied between the electrode pair that produces the transverse electric field (the common electrode 14 and the pixel electrodes 16). The same applies hereinafter unless otherwise specified.

Table 1 also shows results from Comparative Examples 1-1 and 1-2 in which the twist angle is 0° and the λ conditions are satisfied. Comparative Example 1-1 is an example in which nematic liquid crystal with positive dielectric anisotropy, which have a positive anisotropy of dielectric constant, are used, whereas Comparative Example 1-2 is an example in which nematic liquid crystal with negative dielectric anisotropy, which have a negative anisotropy of dielectric constant, are used. As such, Comparative Example 1-1 and Comparative Example 1-2 differ in terms of the liquid crystal molecule alignment direction (the directions of the long axes of the liquid crystal molecules) and the azimuthal direction of the transverse electric field. Note that liquid crystal display panels corresponding to Comparative Example 1-1 or 1-2 are not publicly known.

Hereinafter, in the present specification, directions (azimuthal directions) such as the alignment directions of liquid crystal molecules and the directions of polarized light will be expressed as azimuth angles taking the azimuthal direction of the transverse electric field as a reference. Letting the azimuthal direction of the transverse electric field (the direction of three o'clock on the face of a clock) be 0°, the counter-clockwise direction as seen from the observer side is taken as positive. Twisted alignment is defined by the alignment azimuthal direction of the long axes of the liquid crystal molecules near the bottom substrate (the first substrate 10Sa) and the alignment azimuthal direction of the long axes of the liquid crystal molecules near the top substrate (the second substrate 10Sb).

TABLE 1

| | | | | Bottom | Top | | | |
|---|---|---|---|---|---|---|---|---|
| | Liquid | | | substrate | substrate | | | |
| | crystal | Cell | Liquid | alignment | alignment | | Polarizing | |
| | layer | thickness | crystal | azimuthal | azimuthal | Twist | plate | Transmittance |
| | Δnd | d (μm) | Δη | direction (°) | direction (°) | angle (°) | retardation | (%) |
| Example 1-1 | 540 nm | 4.50 | 0.12 | −11.5 | 21.5 | 33 | 137.5 nm | 22.7 |
| Example 1-2 | 520 nm | 4.33 | 0.12 | −23.5 | 33.5 | 57 | 137.5 nm | 23.2 |
| Example 1-3 | 500 nm | 4.17 | 0.12 | −31.5 | 41.5 | 73 | 137.5 nm | 23.0 |
| Example 1-4 | 480 nm | 4.00 | 0.12 | −38.0 | 48.0 | 86 | 137.5 nm | 22.4 |
| Example 1-5 | 460 nm | 3.83 | 0.12 | −43.5 | 53.5 | 97 | 137.5 nm | 21.5 |
| Example 1-6 | 440 nm | 3.67 | 0.12 | −48.0 | 58.0 | 106 | 137.5 nm | 20.4 |
| Example 1-7 | 420 nm | 3.50 | 0.12 | −52.0 | 62.0 | 114 | 137.5 nm | 19.2 |
| Example 1-8 | 400 nm | 3.33 | 0.12 | −55.5 | 65.5 | 121 | 137.5 nm | 17.9 |
| Example 1-9 | 380 nm | 3.17 | 0.12 | −58.5 | 68.5 | 127 | 137.5 nm | 16.4 |
| Example 1-10 | 360 nm | 3.00 | 0.12 | −61.5 | 71.5 | 133 | 137.5 nm | 14.8 |
| Comparative | 550 nm | 4.58 | 0.12 | 85.0 | 85.0 | 0 | 137.5 nm | 6.57 |
| Example 1-1 | | | | | | | | |
| Comparative | 550 nm | 4.58 | 0.12 | 5.0 | 5.0 | 0 | 137.5 nm | 19.3 |
| Example 1-2 | | | | | | | | |

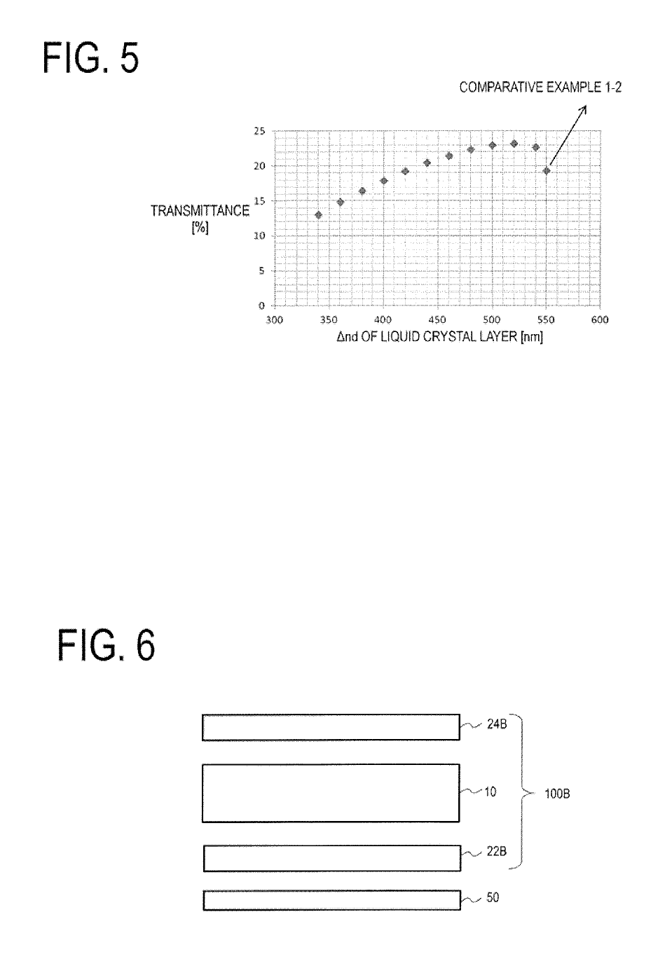

FIG. 5 is a graph illustrating a relationship between the transmittance of the liquid crystal display panel and Δnd of the liquid crystal layer according to Examples 1-1 to 1-10, shown in Table 1.

As is clear from FIG. 5, in a case where Δnd is greater than or equal to 420 nm, a higher transmittance (white display luminance) than the liquid crystal display panel according to Comparative Example 1-2 can be achieved. In a case where Δnd is from 340 nm to less than 420 nm, the transmittance does not reach that of Comparative Example 1-2, but as can be seen from FIG. 2, this range for Δnd has a broad region satisfying the semi-λ conditions. In other words, there are advantages in that the margin with respect to variations in the thickness of the liquid crystal layer can be increased and variations in the display quality, such as the contrast ratio, can be reduced.

On the other hand, it is preferable that the twist angle of the liquid crystal layer be from 50° to less than 90°. In this twist angle range, the optimal Δnd is approximately from 480 nm to 520 nm, which is a region of high transmittance. Additionally, the twist angle is less than 90°, and thus two or more domains in which twisted alignment azimuthal directions are different from each other can be formed within a single pixel, making it possible to improve the viewing angle characteristics.

### Second Embodiment

FIG. 6 is a schematic exploded cross-sectional view of a liquid crystal display panel 100B according to the second embodiment of the present invention. The liquid crystal display panel 100B includes the liquid crystal cell 10, a first polarizing plate 22B, and a second polarizing plate 24B. This panel differs from the liquid crystal display panel 100A according to the first embodiment in that the first polarizing plate 22A and the second polarizing plate 24B are both elliptical polarizing plates (excluding circular polarizing plates). Other points are the same as in the liquid crystal display panel according to the first embodiment, and thus descriptions thereof will be omitted.

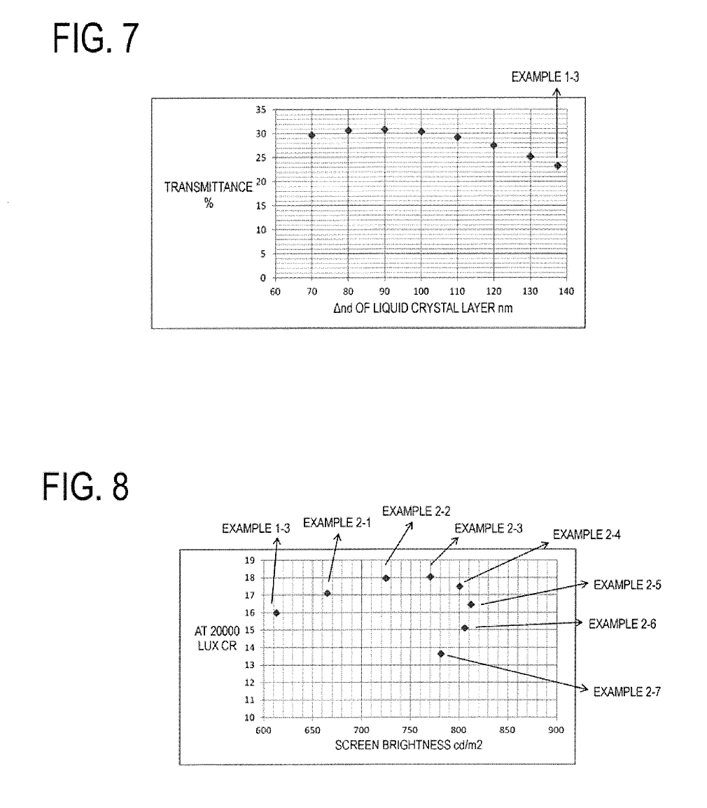

The results of finding the transmittance when the retardations (also called “phase difference”) of the elliptical polarizing plates are varied from 70 nm to 130 nm, in the case where Δnd of the liquid crystal layer is 500 nm and the twist angle is 73°, are shown in Table 2 and FIG. 7. Table 2 and FIG. 7 also show the results of Example 1-3 (a circular polarizing plate).

TABLE 2

| | | | | Bottom | Top | | | |
|---|---|---|---|---|---|---|---|---|
| | Liquid | | | substrate | substrate | | | |
| | crystal | Cell | Liquid | alignment | alignment | | Polarizing | |
| | layer | thickness | crystal | azimuthal | azimuthal | Twist | plate | Transmittance |
| | Δnd | d (μm) | Δη | direction (°) | direction (°) | angle (°) | retardation | (%) |
| Example 1-3 | 500 nm | 4.17 | 0.12 | −31.5 | 41.5 | 73 | 137.5 nm | 23.0 |
| Example 2-1 | 500 nm | 4.17 | 0.12 | −31.5 | 41.5 | 73 | 130 nm | 25.3 |
| Example 2-2 | 500 nm | 4.17 | 0.12 | −31.5 | 41.5 | 73 | 120 nm | 27.5 |
| Example 2-3 | 500 nm | 4.17 | 0.12 | −31.5 | 41.5 | 73 | 110 nm | 29.3 |
| Example 2-4 | 500 nm | 4.17 | 0.12 | −31.5 | 41.5 | 73 | 100 nm | 30.4 |
| Example 2-5 | 500 nm | 4.17 | 0.12 | −31.5 | 41.5 | 73 | 90 nm | 30.9 |
| Example 2-6 | 500 nm | 4.17 | 0.12 | −31.5 | 41.5 | 73 | 80 nm | 30.6 |
| Example 2-7 | 500 nm | 4.17 | 0.12 | −31.5 | 41.5 | 73 | 70 nm | 29.7 |

As is clear from Table 2 and FIG. 7, it can be seen that the transmittance can be improved by using elliptical polarizing plates instead of circular polarizing plates. In particular, in Examples 2-4 to 2-6, where the retardations of the elliptical polarizing plates are from 80 nm to 100 nm, the transmittance of the liquid crystal display panel is a high value of greater than 30%.

As is clear from the above-described results, the transmittance can be improved by using elliptical polarizing plates instead of circular polarizing plates. However, when elliptical polarizing plates are used, the effect of suppressing reflection of outside light drops. Accordingly, attempts were made to optimize the retardations of the elliptical polarizing plates, taking into consideration the transmittance improvement effect and the outside light reflection suppression effect.

FIG. 8 illustrates a relationship between screen brightness and contrast ratio (CR) for a liquid crystal display panel in which Δnd=500 nm and the twist angle is 73° in the liquid crystal layer. The contrast ratio assumes the bright outdoors, and thus a contrast ratio at 20000 lux was found.

Based on FIG. 8, up until retardations of the elliptical polarizing plates are from 90 nm to 130 nm (Examples 2-1 to 2-5), both the brightness and the contrast ratio are better than in Example 1-3 (circular polarizing plates with a retardation of 137.5 nm). It can be seen that in Example 2-6 and Example 2-7, where the retardations of the elliptical polarizing plates are from 70 nm to 80 nm, the contrast ratio is lower than in Example 1-3, but the screen brightness is high.

Note that in the case where elliptical polarizing plates are used, the transmittance changes greatly depending on the azimuthal directions of the long axis of the elliptical polarized light incident on the liquid crystal layer. The optimal azimuthal direction is set in the above-described Example 2-3.

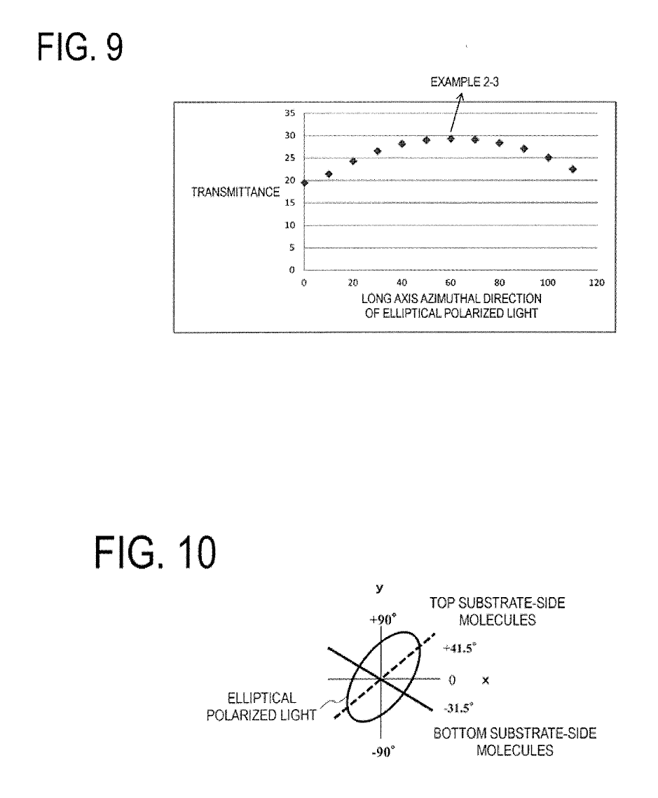

FIG. 9 indicates results of finding a relationship between the long axis azimuthal direction of incident elliptical polarized light and the transmittance, in the case where elliptical polarizing plates having a retardation of 110 nm in the same manner as in Example 2-3 are used.

As is clear from FIG. 9, the transmittance varies depending on the azimuthal direction of the long axis of the elliptical polarized light. Example 2-3 has the ideal conditions where the transmittance is maximum. However, in a case such as where the axes of the elliptical polarizing plates are subject to production restrictions or the like, the conditions need not be the ideal conditions, and a high transmittance effect can be achieved as long as there is a transmittance of greater than or equal to the 23% of the Example 1-3 using elliptical polarizing plates. With respect to these conditions, based on FIG. 9, it is preferable that the azimuthal direction of the long axis of the elliptical polarized light be from 20° to 100°. In particular, in the case where the azimuthal direction is within a range of 60°±10°, an effect in which the transmittance increases greatly and the contrast ratio (CR) at 20000 lux also increases can be achieved, and thus such a case is further preferable.

In the liquid crystal display panel 100B in the examples according to the second embodiment, a compensation layer is provided between the liquid crystal cell 10 and the second polarizing plate 24B. The name “compensation layer” is used here to distinguish the layer from the phase difference layer in the circular polarizing plate or the elliptical polarizing plate, but the layer may be called a phase difference layer as well.

Here, a compensation layer having the same And as the liquid crystal layer, and having a twisted state twisted in the opposite direction from the twisted state of the liquid crystal layer, is used as the compensation layer. This compensation layer compensates for differences in retardation caused by wavelength dispersion in the refractive index of the liquid crystal layer and the wavelength. Note that a compensation layer having another optical anisotropy can be used as the compensation layer. In such a case, the long axis azimuthal direction of the elliptical polarized light at which a high transmittance can be obtained is of course different from the above-described examples. However, there is a long axis azimuthal direction of the elliptical polarized light at which a maximum transmittance is achieved every 180°, even in the case where a compensation layer having another optical anisotropy is used. Accordingly, the azimuthal direction of the long axis of the elliptical polarized light is preferably within ±40° from the azimuthal direction of the long axis of the elliptical polarized light at which the maximum transmittance is obtained, and further preferably within a range of ±10°. Additionally, the compensation layer may be provided between the liquid crystal cell 10 and the first polarizing plate 22B, and although the long axis azimuthal direction of the elliptical polarized light of course differs from the above-described examples in this case too, the preferred range for the long axis of the ellipse has the same relationship as described above.

Next, Table 3 shows results of finding the optimal azimuthal direction of the long axis of the elliptical polarized light for liquid crystal display panels according to Examples 2-10 to 2-19, in which Δnd of the liquid crystal layer is different from that in Example 2-3. Additionally, FIG. 10 illustrates a relationship between the azimuthal direction of the long axis of the elliptical polarized light based on the azimuthal direction of the transverse electric field and the alignment azimuthal direction of the liquid crystal molecules.

In all of the Examples illustrated here, the long axes of the liquid crystal molecules are in a twisted alignment in the counter-clockwise direction (left rotation), from the bottom substrate toward the top substrate. Of course, the long axes of the liquid crystal molecules may be twisted in the clockwise direction (right rotation), from the bottom substrate toward the top substrate. In this case too, the transmittance is maximum when the azimuthal direction of the long axis of the elliptical polarized light is close to being orthogonal to the alignment azimuthal direction of the long axes of the liquid crystal molecules near the bottom substrate, for example.

As can be seen from the results in FIG. 10 and Table 3, it is preferable that an angle formed by the alignment azimuthal direction of the liquid crystal molecules in the liquid crystal layer near the bottom substrate and the azimuthal direction of the long axis of the elliptical polarized light passing through the first polarizing plate be from 85° to 90°.

TABLE 3

| | | | | | | | | Bottom-side |
|---|---|---|---|---|---|---|---|---|
| | | | | | | | | elliptical |
| | | | | Bottom | Top | | | polarized |
| | Liquid | | | substrate | substrate | | | light long |
| | crystal | Cell | Liquid | alignment | alignment | Twist | Polarizing | axis |
| | layer | thickness | crystal | azimuthal | azimuthal | angle | plate | azimuthal |
| | Δnd | d (μm) | Δη | direction (°) | direction (°) | (°) | retardation | direction (°) |
| Example 2-10 | 540 nm | 4.50 | 0.12 | −11.5 | 21.5 | 33 | 110 nm | 81 |
| Example 2-11 | 520 nm | 4.33 | 0.12 | −23.5 | 33.5 | 57 | 110 nm | 68 |
| Example 2-12 | 500 nm | 4.17 | 0.12 | −31.5 | 41.5 | 73 | 110 nm | 60 |
| Example 2-13 | 480 nm | 4.00 | 0.12 | −38.0 | 48.0 | 86 | 110 nm | 55 |
| Example 2-14 | 460 nm | 3.83 | 0.12 | −43.5 | 53.5 | 97 | 110 nm | 50 |
| Example 2-15 | 440 nm | 3.67 | 0.12 | −48.0 | 58.0 | 106 | 110 nm | 46 |
| Example 2-16 | 420 nm | 3.50 | 0.12 | −52.0 | 62.0 | 114 | 110 nm | 42 |
| Example 2-17 | 400 nm | 3.33 | 0.12 | −55.5 | 65.5 | 121 | 110 nm | 39 |
| Example 2-18 | 380 nm | 3.17 | 0.12 | −58.5 | 68.5 | 127 | 110 nm | 34 |
| Example 2-19 | 360 nm | 3.00 | 0.12 | −61.5 | 71.5 | 133 | 110 nm | 31 |

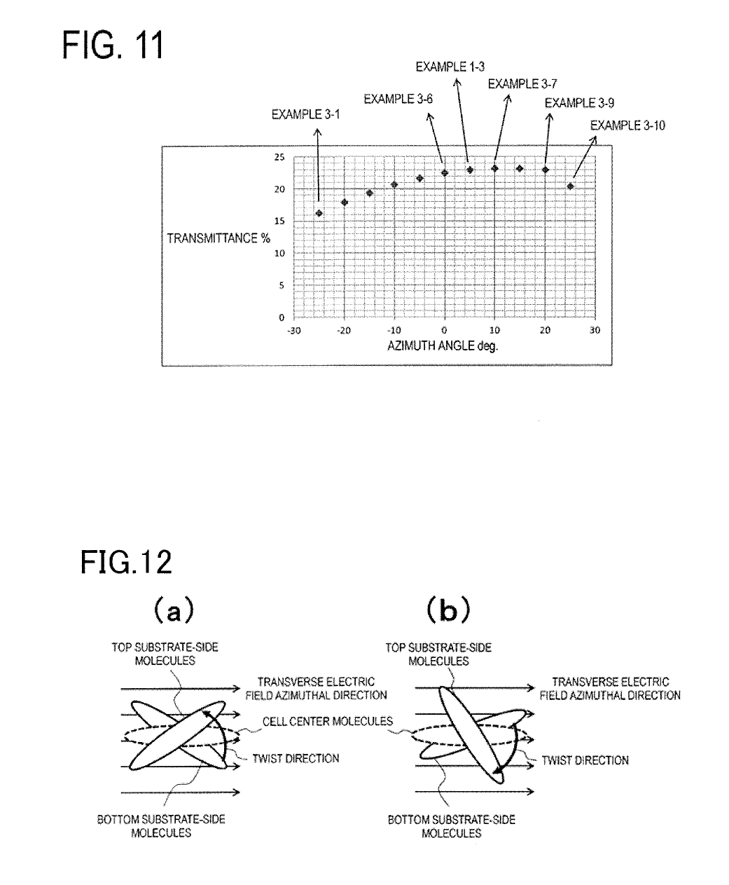

Next, results of investigating the relationship between the twist alignment of the liquid crystal layer and the azimuthal direction of the transverse electric field will be described. Table 4 and FIG. 11 show the results of examining how the transmittance changes depending on the azimuthal direction of the twist alignment relative to the azimuthal direction of the transverse electric field, with the same twist alignment as the twist alignment of the liquid crystal layer in the liquid crystal display panel of Example 1-3 (a twist angle of 73°).

Table 4 indicates the configurations and transmittances of liquid crystal display panels having different twist alignment azimuthal directions (Example 1-3 and Examples 3-1 to 3-10). FIG. 11 is a diagram illustrating a relationship between the alignment azimuthal direction of liquid crystal molecules in the center of the thickness direction of the liquid crystal layer in each liquid crystal display panel when no voltage is applied, and the transmittance. Note that the alignment azimuthal direction of the liquid crystal molecules in the center of the thickness direction of the liquid crystal layer is an azimuthal direction obtained by bisecting the alignment azimuthal direction of the liquid crystal molecules near the bottom substrate and the alignment azimuthal direction of the liquid crystal molecules near the top substrate.

TABLE 4

| | | | | Bottom | Top | | | | |
|---|---|---|---|---|---|---|---|---|---|
| | Liquid | | | substrate | substrate | Center | | | |
| | crystal | Cell | Liquid | alignment | alignment | alignment | Twist | Polarizing | |
| | layer | thickness | crystal | azimuthal | azimuthal | azimuthal | angle | plate | Transmittance |
| | Δnd | d (μm) | Δη | direction (°) | direction (°) | direction (°) | (°) | retardation | (%) |
| Example 3-1 | 500 nm | 4.17 | 0.12 | −61.5 | 11.5 | −25 | 73 | 137.5 nm | 16.3 |
| Example 3-2 | 500 nm | 4.17 | 0.12 | −56.5 | 16.5 | −20 | 73 | 137.5 nm | 17.9 |
| Example 3-3 | 500 nm | 4.17 | 0.12 | −51.5 | 21.5 | −15 | 73 | 137.5 nm | 19.4 |
| Example 3-4 | 500 nm | 4.17 | 0.12 | −46.5 | 26.5 | −10 | 73 | 137.5 nm | 20.7 |
| Example 3-5 | 500 nm | 4.17 | 0.12 | −41.5 | 31.5 | −5 | 73 | 137.5 nm | 22.5 |
| Example 3-6 | 500 nm | 4.17 | 0.12 | −36.5 | 36.5 | 0 | 73 | 137.5 nm | 23.2 |
| Example 1-3 | 500 nm | 4.17 | 0.12 | −31.5 | 41.5 | 5 | 73 | 137.5 nm | 23.0 |
| Example 3-7 | 500 nm | 4.17 | 0.12 | −26.5 | 46.5 | 10 | 73 | 137.5 nm | 23.2 |
| Example 3-8 | 500 nm | 4.17 | 0.12 | −21.5 | 51.5 | 15 | 73 | 137.5 nm | 23.0 |
| Example 3-9 | 500 nm | 4.17 | 0.12 | −16.5 | 56.5 | 20 | 73 | 137.5 nm | 23.0 |
| Example 3-10 | 500 nm | 4.17 | 0.12 | −11.5 | 61.5 | 25 | 73 | 137.5 nm | 20.4 |

As can be seen from Table 4 and FIG. 11, the transmittance changes depending on the azimuthal direction of the twist alignment relative to the azimuthal direction of the transverse electric field, even when the twist angle of the twist alignment is the same.

The behavior of the liquid crystal molecules when the transverse electric field is produced in the liquid crystal layer will be described with reference to FIG. 12 (a). FIG. 12 (a) is a diagram schematically illustrating changes in the alignment azimuthal direction of a liquid crystal molecule within a transverse electric field, and schematically illustrates the twist alignment of the liquid crystal layer in the liquid crystal display panel of Example 3-6.

When a transverse electric field arises as indicated by the arrows in FIG. 12A, a rotating force in the clockwise direction acts on the liquid crystal molecules present on the bottom substrate side from the center in the thickness direction of the liquid crystal layer (having a negative anisotropy of dielectric constant). On the other hand, a rotating force in the counter-clockwise direction acts on the liquid crystal molecules present on the top substrate side from the center in the thickness direction of the liquid crystal layer. However, a nematic liquid crystal material behaves like a continuous elastic body, and thus the liquid crystal molecules on the top substrate side also rotate in the clockwise direction so as to match the rotation of the liquid crystal molecules on the bottom substrate side, which are more strongly affected by the force of the transverse electric field.

Thus, as can be seen from Table 4 and FIG. 11, the transmittance is high in liquid crystal display panels in which the liquid crystal molecules near the bottom substrate are aligned in azimuthal directions greatly twisted by the transverse electric field. In other words, the transmittance is high in the case where the absolute value of the alignment azimuthal direction of the liquid crystal molecules near the bottom substrate (a negative value) is lower than the absolute value of the alignment azimuthal direction of the liquid crystal molecules near the top substrate (a positive value). As such, it is preferable that an angle formed by the alignment azimuthal direction of the liquid crystal molecules in the center of the thickness direction of the liquid crystal layer and the azimuthal direction of the transverse electric field be greater than 0°.

Furthermore, Example 3-10 is a case where the azimuthal direction of the long axes of the liquid crystal molecules near the bottom substrate is closer to the azimuthal direction of the transverse electric field, and because many liquid crystal molecules that rotate counter-clockwise due to the transverse electric field are present near the bottom substrate, the transmittance drops, albeit slightly, due to the counter-clockwise rotation. In particular, it is preferable that the alignment azimuthal direction of the liquid crystal molecules in the center of the thickness direction of the liquid crystal layer be greater than 0° and less than 20°.

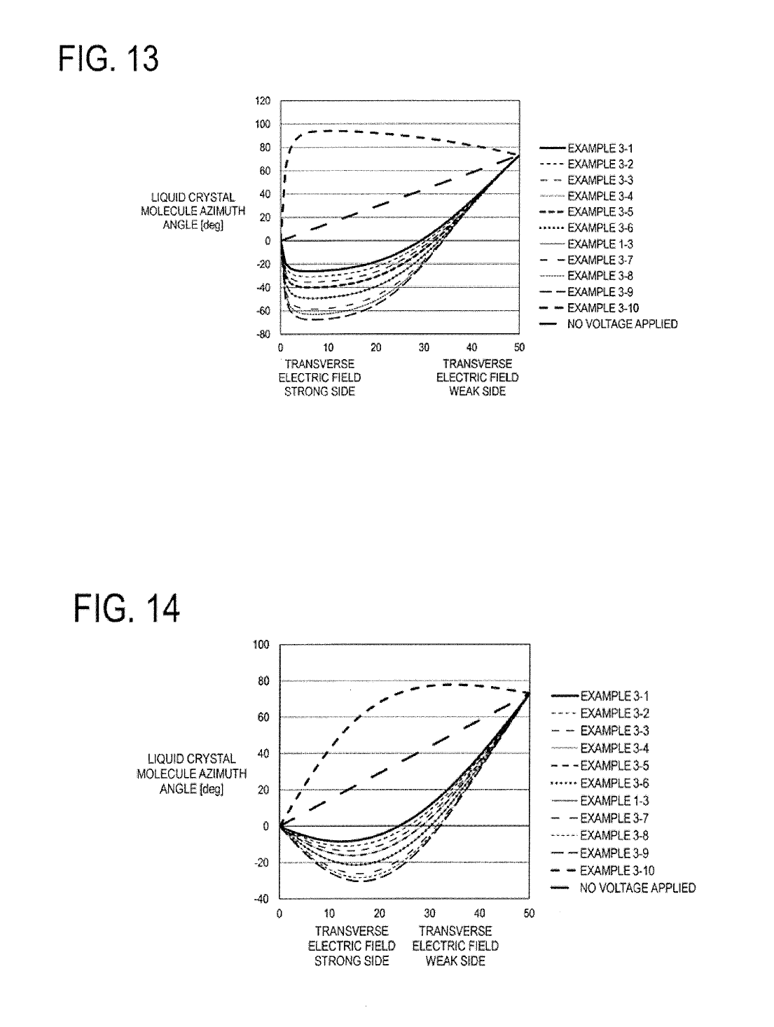

In a transverse electric field mode liquid crystal display panel, the intensity of the transverse electric field varies within the plane of the liquid crystal layer, and thus the alignment state varies as well. FIG. 13 is a graph illustrating a distribution of azimuthal directions of liquid crystal molecules with respect to the azimuthal direction of a transverse electric field in a region, of a liquid crystal layer in a voltage applied state, where the strength of the transverse electric field is highest. FIG. 14 is a graph illustrating a distribution of azimuthal directions of liquid crystal molecules with respect to the azimuthal direction of a transverse electric field in a region, of a liquid crystal layer in a voltage applied state, where the strength of the transverse electric field is lowest. Here, as indicated in Table 4, the Examples 3-1 to 3-10 have different liquid crystal molecule azimuthal directions in the case where the transverse electric field direction is taken as 0°; however, the graphs have the azimuthal direction of the liquid crystal molecules on the bottom substrate as 0° and the azimuthal direction of the liquid crystal molecules on the top substrate as 73° to make it easier to compare FIGS. 13 and 14.

In any case, the twist angle is 73° when no voltage is applied, but the alignment azimuthal directions on the substrates differ from example to example, and the twist angles when a voltage is applied have different magnitudes as a result. Here, as indicated by Example 3-10, as the alignment is made such that the azimuthal directions of the long axes of the liquid crystal molecules near the bottom substrate approach being parallel to the azimuthal direction of the transverse electric field, liquid crystal molecules having azimuthal directions that attempt to rotate counter-clockwise due to the transverse electric field are present as far as the vicinity of the bottom substrate. In the case of Example 3-10, a force acts so as to rotate the liquid crystal molecules near the bottom substrate clockwise, but because of the increase in the liquid crystal molecules having azimuthal directions that attempt to rotate counter-clockwise due to the transverse electric field, the force of the transverse electric field acting on these liquid crystal molecules causes the liquid crystal molecules to rotate counter-clockwise as a whole, which reduces the twist angle and reduces the transmittance. Thus, as can be seen from Table 4, the alignment azimuthal direction of the liquid crystal molecules near the bottom substrate is preferable within a range of from −41.5° to −16.5° relative to the azimuthal direction of the transverse electric field.

In the liquid crystal display panel according to this example, the twisted alignment state of the liquid crystal layer is counter-clockwise (see FIG. 12 (a)), but the same effects as this example can be achieved in the case where the twisted alignment state of the liquid crystal layer is clockwise (see FIG. 12 (b)) in a case where the alignment azimuthal direction of the long axes of the liquid crystal molecules are set so that the alignment azimuthal direction of the liquid crystal molecules of this example are linearly symmetrical to the transverse electric field direction.

The relationship between the twist alignment of the liquid crystal layer and the azimuthal direction of the transverse electric field has been described here for the liquid crystal display panel according to the first embodiment, i.e., for a case where the first polarizing plate 22A and the second polarizing plate 24A are circular polarizing plates, but the same relationship holds true for the liquid crystal display panel according to the second embodiment, which uses elliptical polarizing plates. One of the first polarizing plate and the second polarizing plate may be a circular polarizing plate, and the other may be an elliptical polarizing plate. In this case, it is preferable that the second polarizing plate be the circular polarizing plate, from the standpoint of effectively suppressing the reflection of outside light.

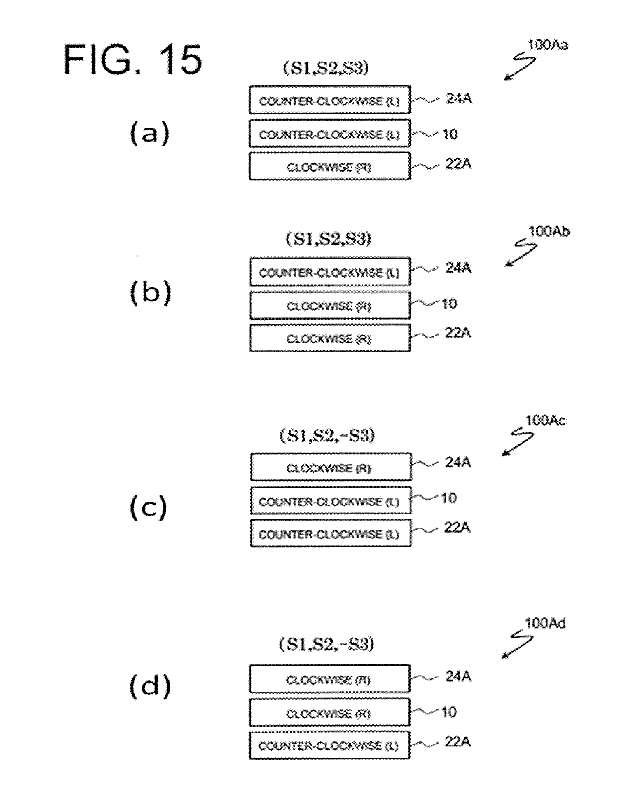

Next, a combination of the rotation direction of circular polarized light and the twist direction of the liquid crystal layer will be described with reference to FIGS. 15A to 15D.

Like a liquid crystal display panel 100Aa illustrated in FIG. 15 (a), the liquid crystal display panel 100A according to the above-described first embodiment is a combination of the first polarizing plate 22A rotated rightward (clockwise), the twist direction of the liquid crystal layer 10 being leftward (counter-clockwise), and the second polarizing plate 24A rotated leftward (counter-clockwise). The liquid crystal display panel 100B according to the second embodiment uses elliptical polarizing plates instead of circular polarizing plates for the first and second polarizing plates of the liquid crystal display panel 100A according to the first embodiment, but the combinations of rotation directions of elliptical polarized light and twist directions of the liquid crystal layer are the same. In addition to these, there are three types of combinations of the rotation direction of circular polarized light and the twist direction of the liquid crystal layer, as illustrated in FIGS. 15 (b)˜15(d). FIG. 15(b)˜15(d) illustrate combinations of the rotation direction of circular polarized light and the twist direction of the liquid crystal layer in liquid crystal display panels 100Ab, 100Ac, and 100Ad, as well as the states of polarized light emitted from the liquid crystal display panels 100Ab, 100Ac, and 100Ad when the Stokes parameters of the polarized light emitted from the liquid crystal display panel 100Aa are taken as (S1, S2, S3).

The liquid crystal display panel 100Ab illustrated in FIG. 15(b) is obtained by changing the twist direction of the liquid crystal layer 10 in the liquid crystal display panel 100Aa to rightward (clockwise). The Stokes parameters of the polarized light emitted from the liquid crystal display panel 100Ab are (S1, S2, S3), which are the same as the polarized light emitted from the liquid crystal display panel 100Aa.

The liquid crystal display panel 100Ac illustrated in FIG. 15(c) is obtained by leaving the twist direction of the liquid crystal layer 10 in the liquid crystal display panel 100Aa as-is (leftward (counter-clockwise), but changing the first polarizing plate 22A to leftward (counter-clockwise) and the second polarizing plate 24A to rightward (clockwise). The Stokes parameters of the polarized light emitted from the liquid crystal display panel 100Ac are (S1, S2, −S3), thus establishing a relationship of point symmetry to the origin on a Poincare sphere with respect to the polarized light emitted from the liquid crystal display panel 100Aa.

The liquid crystal display panel 100Ad illustrated in FIG. 15(d) is obtained by changing the twist direction of the liquid crystal layer 10 in the liquid crystal display panel 100Aa to rightward (clockwise), changing the first polarizing plate 22A to leftward (counter-clockwise), and changing the second polarizing plate 24A to rightward (clockwise). The Stokes parameters of the polarized light emitted from the liquid crystal display panel 100Ad are (S1, S2, −S3), thus establishing a relationship of point symmetry to the origin on a Poincare sphere with respect to the polarized light emitted from the liquid crystal display panel 100Aa.

As can be understood from the foregoing, when the first polarizing plate 22A and the second polarizing plate 24A are circular polarizing plates, the transmittances of the liquid crystal display panels 100Ab, 100Ac, and 100Ad are all the same as the transmittance of the liquid crystal display panel 100Aa. In other words, the foregoing descriptions of the embodiments and examples using circular polarizing plates are also valid for the liquid crystal display panels 100Ab, 100Ac, and 100Ad. In the case where elliptical polarizing plates are used instead of the first polarizing plate 22A and the second polarizing plate 24A, the respective parameters may be optimized as described in the second embodiment.

### Third Embodiment

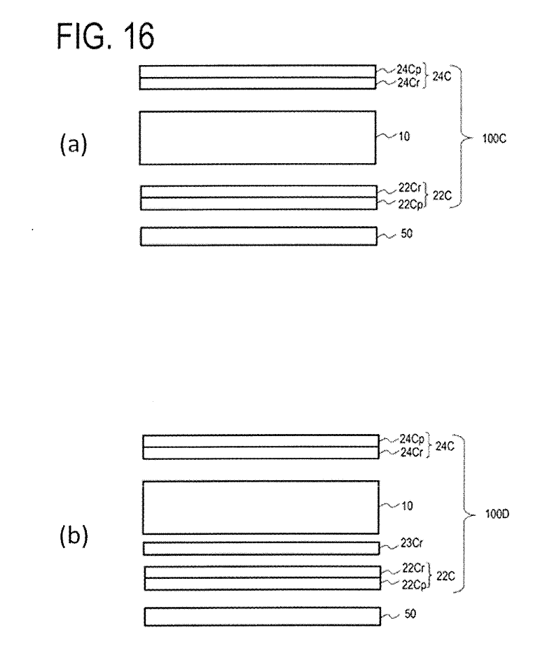

The liquid crystal display panel 100C according to the third embodiment of the present invention includes the liquid crystal cell 10, a first polarizing plate 22C, and a second polarizing plate 24C, as illustrated schematically in FIG. 16(a). The liquid crystal cell 10 is a transverse electric field mode liquid crystal cell, and has the same structure as the fringe field switching mode liquid crystal cell 10 illustrated in FIG. 1(b), for example. The liquid crystal layer in the liquid crystal cell 10 satisfies the above-described semi-λ conditions.

The first polarizing plate 22C and the second polarizing plate 24C are circular polarizing plates or elliptical polarizing plates. Here, to clarify the configurations of the first polarizing plate 22C and the second polarizing plate 24C, those plates are illustrated as being separated into linear polarizing layers and phase difference layers. The first polarizing plate 22C includes a first linear polarizing layer 22Cp and a first phase difference layer 22Cr, and the second polarizing plate 24C includes a second linear polarizing layer 24Cp and a second phase difference layer 24Cr. The first phase difference layer 22Cr and the second phase difference layer 24Cr are both phase difference layers for providing in-plane retardation (an in-plane phase difference). The first polarizing plate 22C and the second polarizing plate 24C substantially do not have phase difference layers aside from the first phase difference layer 22Dr and the second phase difference layer 24Cr, respectively. Here, the first polarizing plate 22C and the second polarizing plate 24C substantially not having phase difference layers aside from the first phase difference layer 22Dr and the second phase difference layer 24Cr, respectively, means that the compensation layer provided in the liquid crystal display panel according to the second embodiment is not provided either. In other words, substantially only the first phase difference layer 22Cr is present between the first linear polarizing layer 22Cp and the liquid crystal cell 10, and substantially only the second phase difference layer 24Cr is present between the second linear polarizing layer 24Cp and the liquid crystal cell 10.

A typical polarizing plate is formed by affixing a linear polarizing layer, a phase difference layer, and a support layer (a protection layer) together using adhesion layers (adhesive layers). Some polarizing plate may have a plurality of phase difference layers. The first polarizing plate 22C and the second polarizing plate 24C of the liquid crystal display panel 100C according to the third embodiment include the linear polarizing layers (22Cp or 24Cp) and only the phase difference layers (22Cr or 24Cr), and do not include any other phase difference layers. The compensation layer provided in the liquid crystal display panel according to the second embodiment is also not provided. The in-plane retardation of the support layers (the protection layers) and the adhesion layers (the adhesive layers) is less than or equal to 5 nm, and thus this in-plane retardation and substantially be ignored. The first polarizing plate 22C and the second polarizing plate 24C configured in this manner may be referred to as being “substantially constituted by only a linear polarizing layer and a phase difference layer”.

The first phase difference layer 22Cr and the second phase difference layer 24Cr do not have circular birefringence. Although detailed descriptions can be found in specialized books, a phase difference layer not having circular birefringence means that the eigen polarized light mode of the phase difference layer is linear polarized light. A phase difference layer having a spatially uniform refractive index distribution (e.g., a single-layer crystal plate that is not layered, a polymer film subjected to a stretching process in a routine procedure, or a liquid crystal cell in which the liquid crystal molecules are aligned in parallel without being twisted) does not have circular birefringence, and when observed using a polarization microscope in which a linear polarizing plate and a linear analyzer are arranged in a crossed-Nicol state while rotating the phase difference layer, an extinction point is present. At this time, the azimuthal direction of the slow axis of the phase difference layer and the polarization axis azimuthal direction of the analyzer are in a parallel or orthogonal relationship.

On the other hand, a phase difference layer having circular birefringence means that the eigen polarized light mode of the phase difference layer is elliptical polarized light or circular polarized light. A phase difference layer having a refractive index distribution that is not spatially uniform (e.g., a layered phase difference layer in which two or more phase difference layers not individually having circular birefringence are layered in a relationship in which the azimuthal directions of the slow axes are neither parallel nor orthogonal to each other or a compensation layer in which the alignment of twisted-alignment liquid crystal molecules is fixed) has circular birefringence, and when observed using a polarization microscope in which a linear polarizing plate and a linear analyzer are arranged in a crossed-Nicol state while rotating the phase difference layer, no extinction point is present. This is easy to understand when considering a laminated phase difference layer obtained by layering a phase difference layer A and a phase difference layer B in which the azimuthal directions of the slow axes differ by 45°. An analyzer is disposed on the outer side of the layered phase difference layer facing the phase difference layer A and a polarizing plate is disposed on the outer side facing the phase difference layer B. Assuming the azimuthal directions of the polarization axes of the analyzer and the polarizing plate are fixed in an orthogonal state (fixed in a so-called crossed-Nicol state) and the layered phase difference layer is then rotated, when the azimuthal direction of the slow axis of the retardation layer A becomes parallel or orthogonal to the azimuthal direction of the polarization axis of the analyzer (when the so-called extinction point is reached), the azimuthal direction of the slow axis of the phase difference layer B forms an angle of 45° with the azimuthal directions of the polarization axes of the analyzer and the polarizing plate, and the field of view does not quench. On the other hand, when the azimuthal direction of the slow axis of the phase difference layer B is parallel or orthogonal to the azimuthal direction of the polarization axis of the polarizing plate (upon reaching the so-called extinction point), this time, the azimuthal direction of the slow axis of the phase difference layer A and the azimuthal direction of the polarization axis of the polarizing plate form an angle of 45°, and the field of view is not quenched in this case either. In other words, the layered phase difference layer does not have an extinction point with the linear polarizing plate arranged in a crossed-Nicol state. The compensation layer (that compensates for the optical anisotropy of a liquid crystal layer in a twisted alignment state) included in the liquid crystal display panel 100B of the second embodiment has circular birefringence. Circular birefringence can be measured, for example, using a dual retarder rotation-type polarimeter (manufactured by Axometrics; trade name: Axo-scan, or the like). In the present specification, not having circular birefringence means that the absolute value of the circular birefringence is less than or equal to 10 nm.

For example, a phase difference layer having a linear birefringence (in-plane retardation is sometimes called linear birefringence in contrast with the term “circular birefringence”), a layered phase difference layer in which two phase difference layers having a linear birefringence of 100 nm are layered such that the slow axes thereof are parallel, and a layered phase difference layer in which two phase difference layers having a linear birefringence of 100 nm are layered such that the slow axes thereof are orthogonal all have a circular birefringence of 0 nm. On the other hand, for example, a layered phase difference in which two phase difference layers having a linear birefringence of 100 nm are layered such that the slow axes thereof form an angle of 5° has a circular birefringence of 11.1 nm, and a layered phase difference in which two phase difference layers having a linear birefringence of 100 nm are layered such that the slow axes thereof form an angle of 45° has a circular birefringence of 56.8 nm. A compensation layer that compensates for a liquid crystal cell having Δnd=505 nm and a twist angle of 73° has a circular birefringence of 45.2 nm, a compensation layer that compensates for a liquid crystal cell having Δnd=480.8 nm and a twist angle of 90° has a circular birefringence of 41.7 nm, and a compensation layer that compensates for a liquid crystal cell having Δnd=414 nm and a twist angle of 120° has a circular birefringence of 26.8 nm. As is clear from these examples, a single phase difference layer or a layered phase difference layer layered such that the azimuthal directions of the slow axes are parallel or orthogonal do not have circular birefringence, whereas a layered phase difference layer layered such that the slow axes are at angles that are neither parallel nor orthogonal, a compensation layer having a twisted alignment, and the like have circular birefringence. In the present specification, a phase difference layer that does not have circular birefringence refers to a single phase difference layer or a layered phase difference layer layered so that the azimuthal directions of the slow axes are parallel or orthogonal.

The liquid crystal display panel 100C according to the third embodiment can achieve a good black display with little light leakage while reducing reflection of outside light more than in the past and/or improving the contrast ratio of bright parts, without using a layered structure with a compensation layer or a phase difference layer having circular birefringence. This is an effect that cannot be anticipated from past general technical knowledge of optical compensation, and the inventors too first confirmed this effect by carrying out many detailed simulations.

To describe the properties of Examples 4-1 to 4-22 of the liquid crystal display panel 100C according to the third embodiment, simulations were carried out for Comparative Examples 3-1 to 3-6, which are liquid crystal display panels having a homogeneously-aligned liquid crystal layer.

Furthermore, simulations were carried out for Reference Examples 3-1 to 3-7, which are liquid crystal display panels including a compensation layer that compensates for optical anisotropy of the liquid crystal layer in a twisted alignment state. FIG. 16(b) illustrates the schematic structure of the liquid crystal display panel 100D according to Reference Examples 3-1 to 3-7. As can be seen from FIG. 16(b), the liquid crystal display panel 100D includes a compensation layer 23Cr between the liquid crystal cell 10 and the first polarizing plate 22C in the liquid crystal display panel 100C illustrated in FIG. 16(a). Here, a compensation layer having a twisted state twisted in the opposite direction from the twisted state of the liquid crystal layer is used as the compensation layer 23Cr. The liquid crystal display panel according to the reference examples can be the liquid crystal display panel according to the second embodiment.

Simulation results for the examples, comparative examples, and reference examples will be described hereinafter. A preferred configuration of the first polarizing plate 22C and the second polarizing plate 24C included in the liquid crystal display panel 100C of the third embodiment (the retardations, arrangement relationship between the absorption axes of the linear polarizing layers and the slow axes of the phase difference layers, and the like), and the preferred configuration of the liquid crystal layer in the liquid crystal cell 10 (the twist angle and alignment azimuthal directions in the top and bottom substrates), are different from the preferred configurations of those items in the liquid crystal display panels 100A and 100B of the first and second embodiments. In the case where the liquid crystal display panel 100C of the third embodiment includes circular polarizing plates as the first polarizing plate 22C and the second polarizing plate 24C, that liquid crystal display panel 100C also corresponds to the liquid crystal display panel of the first embodiment.

For example, the retardations of the first phase difference layer 22Cr and the second phase difference layer 24Cr are preferably from 105.0 nm to 170.0 nm, more preferably from 138.0 nm to 170.0 nm, and most preferably approximately 155.0 nm.

Additionally, the absorption axis of the first linear polarizing layer 22Cp and the absorption axis of the second linear polarizing layer 24Cp do not absolutely have to be orthogonal. When the first polarizing plate 22C and the second polarizing plate 24C are elliptical polarizing plates, it is preferable that an angle formed by the absorption axis and the slow axis be greater than 60° and less than 90°.

Additionally, an angle formed by the absorption axis of the first linear polarizing layer 22Cp and the slow axis of the first phase difference layer 22Cr, and an angle formed by the absorption axis of the second linear polarizing layer 24Cp and the slow axis of the second phase difference layer 24Cr, are preferably both less than 45° or greater than 45°, and further preferably, one is less than 45° and the other is greater than 45°. For example, as in Example 4-4, which will be described later, it is preferable that the bottom side (the angle formed by the absorption axis of the first linear polarizing layer 22Cp and the slow axis of the first phase difference layer 22Cr) be greater than 45° and the top side (the angle formed by the absorption axis of the second linear polarizing layer 24Cp and the slow axis of the second phase difference layer 24Cr) be less than 45°.

Furthermore, in the following simulations, the wavelength dispersion of the retardation of the liquid crystal layer, the first phase difference layer 22Cr, and the second phase difference layer 24Cr were also investigated. This is because the inventors noticed that the transmittance could not be sufficiently reduced in a black display state for all of the primary color pixels due to the influence of wavelength dispersion of the retardation. From the simulations, it was discovered that the retardation of the first phase difference layer 22Cr and the second phase difference layer 24Cr is preferably a normal dispersion (a lower absolute value for the retardation at longer wavelengths). This result is opposite from the past general technical knowledge, which says it is preferable that the wavelength dispersion of the retardation of a phase difference layer constituting a circular polarizing plate and an elliptical polarizing plate be an inversion dispersion (a higher absolute value for the retardation at longer wavelengths) or flat (constant regardless of the wavelength).

Additionally, the ellipticity of the first polarizing plate 22C and the second polarizing plate 24C is preferably greater than or equal to 0.575, more preferably greater than or equal to 0.617, and even more preferably greater than or equal to 0.720. In a case where the ellipticity of the first polarizing plate 22C and the second polarizing plate 24C is greater than or equal to the above values, the internal reflection remainder rate can be reduced to less than or equal to 0.25, less than or equal to 0.20, and less than or equal to 0.10. The internal reflection remainder rate will be described later.

The liquid crystal display panel 100C according to the third embodiment can use either a negative-working or positive-working liquid crystal material. As described above, using nematic liquid crystal with negative dielectric anisotropy having negative dielectric anisotropy is effective, and thus the following will describe an example in which nematic liquid crystal with negative dielectric anisotropy are used. As in the first and second embodiments, the following descriptions assume that the azimuth angle takes the orientation of the transverse electric field (orthogonal to the azimuthal direction in which the slits extend) as a reference (0°), with the counter-clockwise direction being positive. In the case where a positive-working liquid crystal material is used, the alignment azimuthal direction of the liquid crystal molecules may take the azimuthal direction in which the slits extend as a reference.

First, the results of simulations for the liquid crystal display panels according to Comparative Examples 3-1 to 3-6 will be described. The liquid crystal display panels according to Comparative Examples 3-1 to 3-3 have configurations similar to that of the liquid crystal display panel 100C illustrated in FIG. 16(a), differing from the liquid crystal display panel 100C in that the liquid crystal layer in the liquid crystal cell 10 is in a homogeneously-aligned state (i.e., the twist angle is zero degrees), Δnd of the liquid crystal layer is 550 nm, and the twist angle of the compensation layer is zero degrees. The liquid crystal display panels according to Comparative Examples 3-4 to 3-6 have configurations similar to that of the liquid crystal display panel 100D illustrated in FIG. 16(b), differing from the liquid crystal display panel 100D in that the liquid crystal layer in the liquid crystal cell 10 is in a homogeneously-aligned state (i.e., the twist angle is zero degrees) and Δnd of the liquid crystal layer is 550 nm. In other words, the liquid crystal layers in the liquid crystal display panels according to Comparative Examples 3-1 to 3-6 have homogeneous alignments in which Δnd=550 nm when no voltage is applied, and thus satisfy the λ conditions. When circular polarized light is incident on the liquid crystal layer, circular polarized light is emitted. The first polarizing plate 22C and the second polarizing plate 24C in the liquid crystal display panels according to Comparative Examples 3-1 to 3-6 are circular polarizing plates. The constituent elements of the liquid crystal display panels according to the comparative examples may be assigned the same reference signs as the constituent elements of the liquid crystal display panels 100C and 100D illustrated in FIGS. 16(a) and 16(b).

Table 5 shows design values of the liquid crystal display panels according to Comparative Examples 3-1 to 3-6 (values used in the simulations) and transmittances subjected to visibility correction. Unless specified otherwise, the transmittance in the present specification is a transmittance (Y value) subjected to visibility correction

TABLE 5

| | | Comparative | Comparative | Comp arative | Comparative | Comparative | Comparative |
|---|---|---|---|---|---|---|---|
| | | Example 3-1 | Example 3-2 | Example 3-3 | Example 3-4 | Example 3-5 | Example 3-6 |
| Second linear | Absorption axis (deg) | −5.0 | −5.0 | −5.0 | −5.0 | −5.0 | −5.0 |
| polarizing layer | | | | | | | |
| Second phase | Slow axis (deg) | 40.0 | 40.0 | 40.0 | 40.0 | 40.0 | 40.0 |
| difference layer | R550 (nm) | 137.5 | 137.5 | 137.5 | 137.5 | 137.5 | 137.5 |
| | R450/R550 | 1.00 | 1.05 | 0.91 | 1.00 | 1.05 | 0.91 |
| | R650/R550 | 1.00 | 0.97 | 1.03 | 1.00 | 0.97 | 1.03 |
| Liquid crystal | R550 (nm) | 550.0 | 550.0 | 550.0 | 550.0 | 550.0 | 550.0 |
| layer | Twist angle (deg) | 0.0 | 0.0 | 0.0 | 0.0 | 0.0 | 0.0 |
| | Top substrate | −5.0 | −5.0 | −5.0 | −5.0 | −5.0 | −5.0 |
| | alignment (deg) | | | | | | |
| | Bottom substrate | −5.0 | −5.0 | −5.0 | −5.0 | −5.0 | −5.0 |
| | alignment (deg) | | | | | | |
| | R450/R550 | 1.05 | 1.05 | 1.05 | 1.05 | 1.05 | 1.05 |
| | R650/R550 | 0.97 | 0.97 | 0.97 | 0.97 | 0.97 | 0.97 |
| Compensation | R550 (nm) | | | | 550.0 | 550.0 | 550.0 |
| layer | Twist angle (deg) | | | | 0.0 | 0.0 | 0.0 |
| | Top substrate | | | | 85.0 | 85.0 | 85.0 |
| | alignment (deg) | | | | | | |
| | Bottom substrate | | | | 85.0 | 85.0 | 85.0 |
| | alignment (deg) | | | | | | |
| | R450/R550 | | | | 1.05 | 1.05 | 1.05 |
| | R650/R550 | | | | 0.97 | 0.97 | 0.97 |
| First phase | Slow axis (deg) | 130.0 | 130.0 | 130.0 | 130.0 | 130.0 | 130.0 |
| difference layer | R550 (nm) | 137.5 | 137.5 | 137.5 | 137.5 | 137.5 | 137.5 |
| | R450/R550 | 1.00 | 1.05 | 0.91 | 1.00 | 1.05 | 0.91 |
| | R650/R550 | 1.00 | 0.97 | 1.03 | 1.00 | 0.97 | 1.03 |
| First linear | Absorption axis (deg) | 85.0 | 85.0 | 85.0 | 85.0 | 85.0 | 85.0 |
| polarizing layer | | | | | | | |
| Transmittance | Black state @ 0 V | 2.714 | 2.657 | 2.775 | 0.002 | 0.002 | 0.002 |
| (%) | White state @ 5 V | 19.3 | 19.4 | 19.3 | 21.1 | 21.1 | 21.1 |

The azimuth angles of the absorption axes are indicated for the polarizing layers 22Cp and 24Cp. A direction orthogonal to the direction in which the slits of the pixel electrodes extend, i.e., the direction of the transverse electric field, is taken as an x axis, and using the x axis as a reference, the counter-clockwise direction is positive.

The azimuth angles of the slow axes, the magnitude of the retardations (in-plane), and the magnitude of wavelength dispersion are indicated for the phase difference layers 22Cr and 24Cr. Unless otherwise specified, the retardation refers to a retardation at a wavelength of 550 nm. The retardation at a wavelength of 550 nm may be written as “R550” hereinafter. Retardations at other wavelengths may be written in the same manner.

The wavelength dispersions of the retardations of the phase difference layers 22Cr and 24Cr are expressed as a ratio of the retardation at a wavelength of 450 nm to the retardation at a wavelength of 550 nm (R450/R550), and a ratio of the retardation at a wavelength of 650 nm to the retardation at a wavelength of 550 nm (R650/R550). The wavelength dispersion is also expressed as R450/R550 and R650/R550 for Δnd of the liquid crystal layer and the retardation of the compensation layer 23Cr as well. Generally, the wavelength dispersion of Δnd of a liquid crystal layer is a normal dispersion, and (R450/R550)>(R650/R550). The wavelength dispersion of the retardations of the phase difference layers 22Cr and 24Cr and the compensation layer 23Cr can be either normal or inverse. The phase difference layers 22Cr and 24Cr and the compensation layer 23Cr are typically constituted of polymer films, but the compensation layer 23Cr, in particular, may be constituted of a liquid crystal layer.

R550 corresponding to Δnd at 550 nm (Δn: the birefringence of nematic liquid crystals; d: the thickness of the liquid crystal layer), the azimuth angle of the alignment azimuthal direction of the liquid crystal molecules near the bottom substrate (sometimes denoted as “bottom substrate alignment”) and the azimuth angle of the alignment azimuthal direction of the liquid crystal molecules near the top substrate (sometimes denoted as “top substrate alignment”), the twist angle (0°, in Comparative Examples 3-1 to 3-6), and the wavelength dispersion of Δnd are indicated for the liquid crystal layer. The physical properties of the liquid crystal layer used in the simulations were Δε=−4.1, Δn=0.112 (a wavelength of 550 nm), K1=14.5 PN, K3=16.1 PN, and wavelength dispersions R450/R550=1.05 and R650/R550=0.97.

The compensation layer 23Cr that compensates for the optical anisotropy of the liquid crystal layer exhibits qualities similar to those of the liquid crystal layer.

Table 5 shows, in addition to liquid crystal display panel design values, a black display transmittance (when no voltage is applied) of the liquid crystal display panel and a white display transmittance (when a voltage of 5 V is applied) calculated using a liquid crystal simulator (LCD master, manufactured by Shintech). The orthogonal transmittance of the polarizing layer used in the simulation was 0.00163%, and the parallel transmittance was 38.7%. For the liquid crystal display panels, the transmittances (black display transmittance and white display transmittance) found through the simulation are both calculated values (Y values) obtained by correcting the visibility under illumination by a D65 light source.

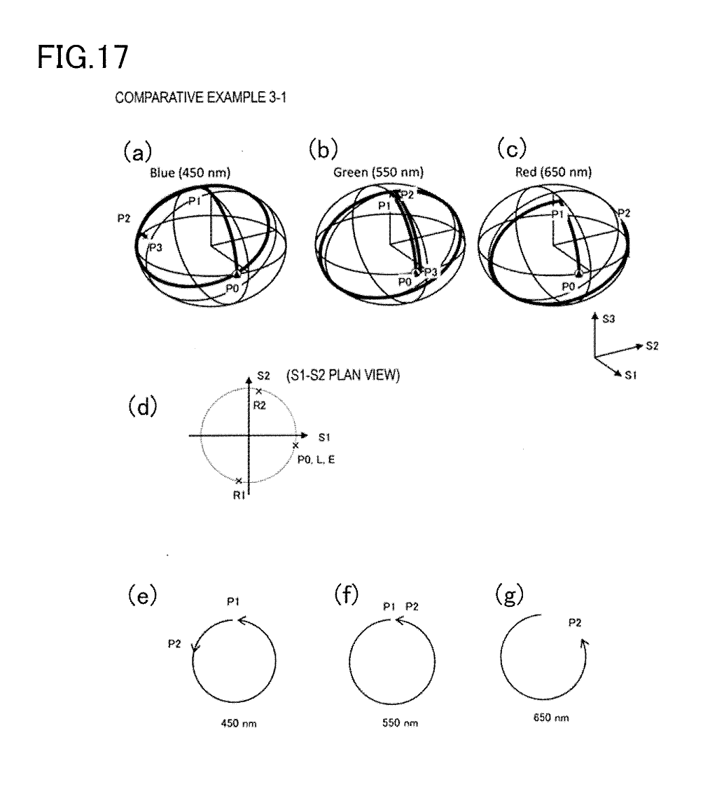

FIGS. 17(a) to 17(c) illustrate, on Poincare spheres, the trajectories of transitions in the polarization state in the black display state of the liquid crystal display panel according to Comparative Example 3-1. Using a Poincare sphere makes it possible to express the Stokes parameters S1, S2, and S3 using an orthogonal coordinate system. FIG. 17(a) illustrates the trajectory of the transition in the polarization state for blue light (a wavelength of 450 nm), FIG. 17(b), for green light (a wavelength of 550 nm), and FIG. 17(c), for red light (650 nm).

In FIGS. 17(a)˜17(c), a circle is a point representing the polarization state of polarized light immediately after being transmitted through the first linear polarizing layer 22Cp, an asterisk is a point representing the polarization state of polarized light immediately after being transmitted through the second phase difference layer 24Cr, and a triangle is a point representing the polarization state of polarized light that can be absorbed by the second linear polarizing layer 24Cp. A good black display is achieved when an asterisk and a triangle overlap (coincide) on the Poincare sphere.

A case where light having a wavelength of 550 nm is incident on the liquid crystal display panel according to Comparative Example 3-1 will be described as an example with reference to FIG. 17(b). The polarization state of the polarized light immediately after being transmitted through the first linear polarizing layer 22Cp is a linearly polarized light in which the azimuthal direction of the polarization plane is −5° (the azimuthal direction of the absorption axis is considered to be 85°, and the transmission axis to be)−5°, and thus the circle is located at a point P0 at or near S1=1 on the equator of the Poincare sphere. When the azimuth angle is measured using S1 as a reference and with the counter-clockwise direction being positive, the azimuth angle of P0 on the Poincare sphere is twice −5°, i.e., −10°. FIG. 17(d) is an S1-S2 plan view. In FIG. 17(d), priority is given to making the drawing easier to see, and thus illustrates an angle slightly different from the actual azimuth angle. The same applies to the necessary points in the following descriptions.

Next, a point indicating the polarization state of the polarized light transmitted through the first phase difference layer 22Cr, in which the slow axis has an azimuth angle of 130° and a retardation of 137.5 nm (λ/4) with respect to light having a wavelength of 550 nm, is at a point P1 on the Poincare sphere obtained by rotating 360°×(137.5 nm/550 nm)=90° counter-clockwise about a slow axis R1 of the first phase difference layer 22Cr (“×” indicates multiplication in the present specification). The point P1 is located at the north pole of the Poincare sphere, i.e., the polarization state at this time is right handed circularly-polarized light. Note that the azimuth angle of R1 on the Poincare sphere is twice 130°, i.e., 260°. Here, the rotation is described simply as “counter-clockwise rotation about the slow axis R1”, but to be more precise, the rotation is described as “counter-clockwise rotation, taking a line connecting a point R1 on the Poincare sphere indicating the slow axis with an origin O of the Poincare sphere as the center of rotation, seen from the point R1 toward O”. Similar expressions may be used in the following for simplicity.

Next, a point indicating the polarization state of the polarized light transmitted through the liquid crystal layer, in which the slow axis (director azimuthal direction) is −5° and the retardation is 550 nm (λ) with respect to light having a wavelength of 550 nm, is at a point P2 on the Poincare sphere obtained by rotating 360°×(550 nm/550 nm)=360° counter-clockwise about a slow axis L of the liquid crystal layer. In the case where the wavelength of 550 nm, the rotation is exactly 360° and thus substantially returns to the original point P1; however, as will be described later, the rotation is at an angle different from 360° for other wavelengths, and thus generally, P1 and P2 do not match. Note that the azimuth angle of L on the Poincare sphere is twice −5°, i.e., −10°.

Then, a point indicating the polarization state of the polarized light transmitted through the second phase difference layer 24Cr, in which the slow axis has an azimuth angle of 40° and a retardation of 137.5 nm (λ/4) with respect to light having a wavelength of 550 nm, is at a point P3 on the Poincare sphere obtained by rotating 360°×(137.5 nm/550 nm)=90° counter-clockwise about a slow axis R2 of the second phase difference layer 24Cr. The point P3 is located on the equator of the Poincare sphere, i.e., the polarization state at this time is linear polarized light. The point P3 and a point E representing a polarization state that the second linear polarizing layer 24Cp can absorb match. The point P3 and the point E are indicated by an asterisk and a triangle in FIG. 17(b). In this manner, a good black display with little light leakage can be achieved for incident light having a wavelength of 550 nm.

As described above, a good black display can be achieved for incident light having a wavelength of 550 nm, but such is not the case for incident light having a wavelength of 450 nm, 650 nm, and the like. This is because the rotation angle in the transition of the polarization state on the Poincare sphere differs from the case of incident light having a wavelength of 550 nm due to the influence of wavelength dispersion of the retardation of the phase difference layer, the liquid crystal layer, and the like. Here, as described above, the wavelength dispersion of Δnd of the liquid crystal layer is R450/R550=1.05 and R650/R550=0.97.

The transition (rotation angle) of the polarization state depending on Δnd of the liquid crystal layer will be described with reference to FIGS. 17(e)˜17(g). FIGS. 17(e)˜17(g) schematically illustrate rotation by the liquid crystal layer for incident light having wavelengths of 450 nm, 550 nm, and 650 nm, respectively. As illustrated in FIG. 17(f), with respect to incident light having a wavelength of 550 nm, polarized light in a polarization state indicated by the point P1 on the Poincare sphere has the polarization plane rotated 360° upon passing through the liquid crystal layer, and is transformed into polarized light in the polarization state indicated by the point P2 (matching the point P1), as described above.

As opposed to this, with respect to incident light having a wavelength of 450 nm, the rotation angle by the liquid crystal layer is 360°×(550 nm×1.05)/450 nm=462°, and thus the point P2 passes the point P1 as indicated in FIG. 17(e).

With respect to incident light having a wavelength of 650 nm, the rotation angle by the liquid crystal layer is 360°×(550 nm×0.97)/650 nm=295.5°, and thus the point P2 does not reach the point P1 as indicated in FIG. 17(g).

The rotation angles by the first phase difference layer 22Cr and the second phase difference layer 24Cr can be calculated in the same manner as the examples given for the liquid crystal layer.

As is clear from the foregoing, incident lights having wavelengths of 450 nm and 650 nm follow trajectories on the Poincare sphere different from incident light having a wavelength of 550 nm, and the final points reached thereby do not match the asterisk or triangle, resulting in the black display appearing to have coloration. This is the reason a black display subjected to visibility correction has a high transmittance.

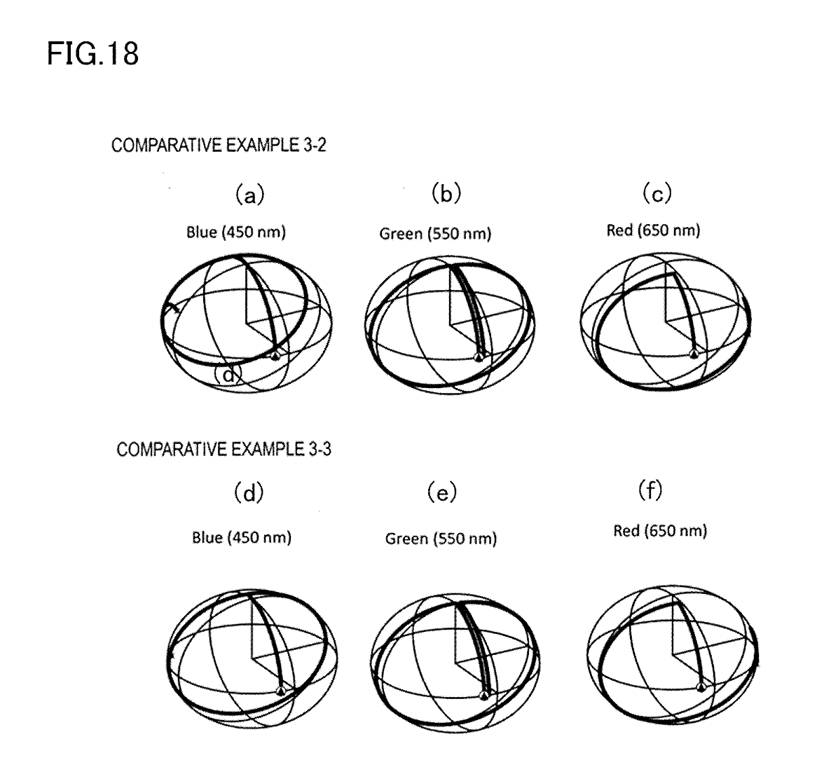

Next, FIGS. 18(a)˜18(f) illustrate, on Poincare spheres, the trajectories of transitions in polarization states in black display states of the liquid crystal display panels according to Comparative Example 3-2 and Comparative Example 3-3. The liquid crystal display panels according to Comparative Example 3-2 and Comparative Example 3-3 are the same as the liquid crystal display panel according to Comparative Example 3-1, aside from the wavelength dispersions of the retardations of the first phase difference layer 22Cr and the second phase difference layer 24Cr having been changed.

The first phase difference layer 22Cr and the second phase difference layer 24Cr in the liquid crystal display panel according to Comparative Example 3-1 both have flat wavelength dispersions, with substantially constant retardations regardless of wavelength. Such a phase difference layer can be formed from a cycloolefin polymer resin film, for example.

The first phase difference layer 22Cr and the second phase difference layer 24Cr in the liquid crystal display panel according to Comparative Example 3-2 have normal dispersions, with lower retardations at longer wavelengths. Such a phase difference layer can be formed from a polycarbonate or polystyrene resin film, or a liquid crystal layer, for example.

The first phase difference layer 22Cr and the second phase difference layer 24Cr in the liquid crystal display panel according to Comparative Example 3-3 have inverse dispersions, with higher retardations at longer wavelengths. Such a phase difference layer can be formed from a modified polycarbonate resin film, for example.

As is clear from FIGS. 18(a)˜18(f), a good black display state cannot be achieved at all wavelengths (e.g., the 450 nm, 550 nm, and 650 nm illustrated), regardless of whether the wavelength dispersions of the retardations of the first phase difference layer 22Cr and the second phase difference layer 24Cr are normal or inverse.

In other words, with the liquid crystal display panels according to Comparative Examples 3-1 to 3-3, in which a homogeneously-aligned liquid crystal cell and circular polarizing plates are used, a good black display cannot be achieved at all wavelengths simply by changing the wavelength dispersions of the retardations of the phase difference layers. As shown in Table 5, the transmittance in the black display state subjected to visibility correction exceeds 2.5%.

To achieve a good black display with a configuration using a homogeneously-aligned liquid crystal cell and circular polarizing plates, the compensation layer 23Cr that compensates for (cancels) optical anisotropy of the liquid crystal layer is necessary, as in the liquid crystal display panels according to Comparative Examples 3-4 to 3-6. As shown in Table 5, the liquid crystal display panels according to Comparative Examples 3-4 to 3-6, which include the compensation layer 23Cr, can achieve a good black display state at all wavelengths regardless of whether the wavelength dispersions of the retardations of the first phase difference layer 22Cr and the second phase difference layer 24Cr are flat, normal dispersions, or inverse dispersions.

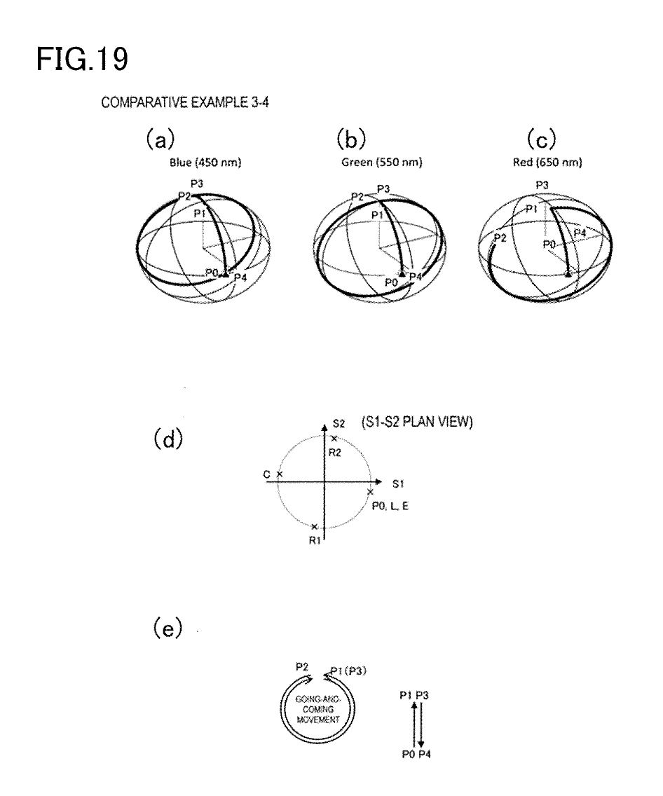

In the same manner as described above, FIGS. 19(a)˜19(c) illustrate, on Poincare spheres, the trajectories of transitions in the polarization state in the black display state of the liquid crystal display panel according to Comparative Example 3-4. FIG. 19(d) is an S1-S2 plan view. The polarization state of the polarized light transmitted through the first phase difference layer 22Cr corresponds to the point P1; up to this point is the same as in Comparative Example 3-1, and thus descriptions will be omitted.

Next, a point indicating the polarization state of the polarized light transmitted through the compensation layer 23Cr, in which the azimuth angle of the slow axis is 85° and the retardation is 550 nm (?) with respect to light having a wavelength of 550 nm, is at the point P2 on the Poincare sphere obtained by rotating 360° counter-clockwise about a slow axis C of the compensation layer 23Cr. Next, a point indicating the polarization state of the polarized light transmitted through the liquid crystal layer, in which the azimuth angle of the slow axis is −5° and the retardation is 550 nm (λ) with respect to light having a wavelength of 550 nm, is at a point P3 on the Poincare sphere obtained by rotating 360° counter-clockwise about the slow axis L of the liquid crystal layer. The trajectory retraces its path, such that the point P3 and the point P1 perfectly match. In other words, by making the absolute values of the rotation angles (retardations) formed by the compensation layer 23Cr and the liquid crystal layer match and setting the slow axes (which become the rotation axes on the Poincare sphere) of the compensation layer 23Cr and the liquid crystal layer to be orthogonal to each other, the point P3 and the point P1 can be made to match even in the case where the rotation angle by the compensation layer 23Cr and the liquid crystal layer is not 360°. The compensation layer 23Cr is provided to that end, and thus this is a natural result.

Finally, the point is transformed to a point P4 by passing through the second phase difference layer 24Cr. Here too, by making the absolute values of the rotation angles (retardations) of the first phase difference layer 22Cr and the second phase difference layer 24Cr match, and setting the slow axes (which become the rotation axes on the Poincare sphere) of the first phase difference layer 22Cr and the second phase difference layer 24Cr to be orthogonal to each other, the point P4 and the point P0 can be made to match. The point P4 is located on the equator of the Poincare sphere, i.e., the polarization state at this time is linear polarized light. The point P4 and the point E representing a polarization state of polarized light that the second linear polarizing layer 24Cp can absorb match. In this manner, a good black display with little light leakage can be achieved for incident light having a wavelength of 550 nm. The point P4 and the point E are indicated by an asterisk and a triangle in FIGS. 19(a)˜19(c).

Even for light having wavelengths of 450 nm and 650 nm, the point P4 and the point E match having followed almost the same trajectory as the light having a wavelength of 550 nm, simply by the rotation angle and the length of the trajectory on the Poincare sphere changing. The point P1 and the point P3 match due to the effect of the compensation layer 23Cr, and the absolute values of the retardations of the first phase difference layer 22Cr and the second phase difference layer 24Cr, including the wavelength dispersion, are equal to each other. This is because the rotation of the point P0→the point P1 and the rotation of the point P3→the point P4 cancel each other out perfectly. In a configuration where the compensation layer 23Cr is provided to perfectly compensate for the optical anisotropy of the liquid crystal layer, the point P4, which represents the final polarization state for all wavelengths, matches the point P0 regardless of the wavelength dispersions of the retardations of the first phase difference layer 22Cr and the second phase difference layer 24Cr. In this manner, the liquid crystal display panel according to Comparative Example 3-4 can achieve a good black display with little light leakage for incident light having a wavelength of 450 nm and a wavelength of 650 nm, in the same manner as for incident light having a wavelength of 550 nm.

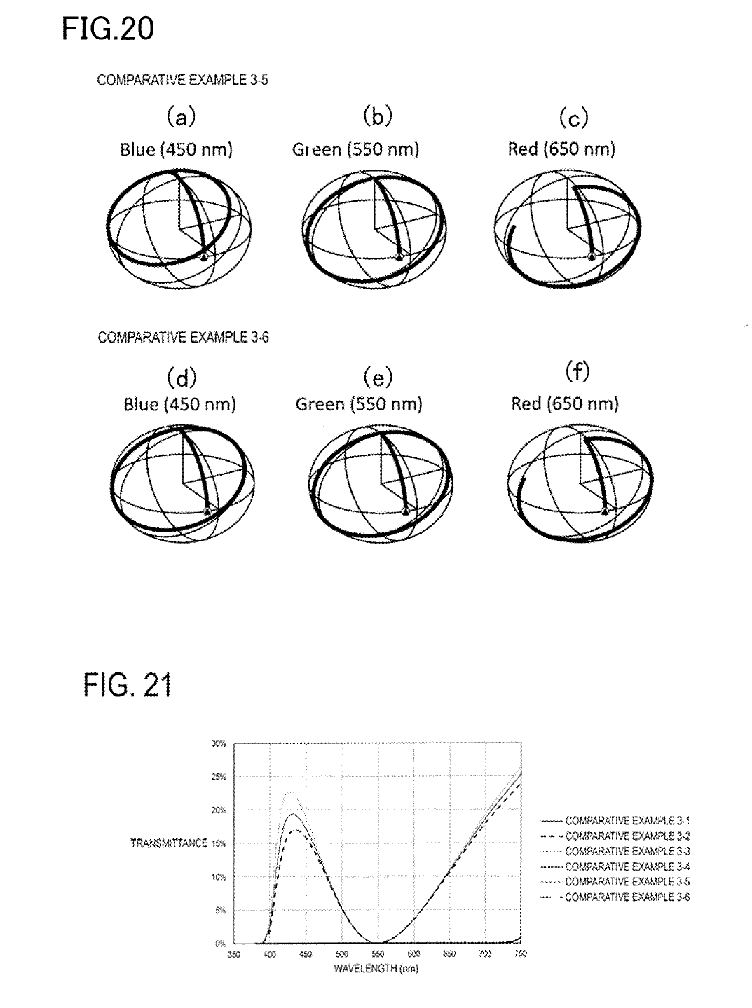

Next, FIGS. 20(a)˜20(f) illustrate, on Poincare spheres, the trajectories of transitions in polarization states in black display states of the liquid crystal display panels according to Comparative Example 3-5 and Comparative Example 3-6. The liquid crystal display panels according to Comparative Example 3-5 and Comparative Example 3-6 are the same as the liquid crystal display panel according to Comparative Example 3-4, aside from the wavelength dispersions of the retardations of the first phase difference layer 22Cr and the second phase difference layer 24Cr having been changed. While both the first phase difference layer 22Cr and the second phase difference layer 24Cr in the liquid crystal display panel according to Comparative Example 3-4 have flat wavelength dispersions, Comparative Example 3-5 has a normal dispersion (a lower absolute value for the retardation at longer wavelengths) and Comparative Example 3-6 has an inverse dispersion (a higher absolute value for the retardation at longer wavelengths).

As is clear from FIGS. 20(a)˜20(f), the point P4, which represents the final polarization state for all wavelengths, matches the point P0. In other words, with the liquid crystal display panels according to Comparative Examples 3-4 to 3-6, which include the compensation layer 23Cr, the black display does not appear to have coloration, and the transmittance subjected to visibility correction is also low. However, a compensation layer 23Cr that completely compensates for optical anisotropy of a liquid crystal layer is difficult to manufacture, and leads to an increase in cost. Additionally, because the retardation of the compensation layer 23Cr is comparatively high, there is a further problem in that the liquid crystal display panel becomes thicker. Mobile terminals such as smartphones are being made thinner, and thus the thickness of the compensation layer 23Cr cannot be ignored.

Next, FIG. 21 is a diagram illustrating spectra of the black display states of the liquid crystal display panels according to Comparative Examples 3-1 to 3-6. In all of the comparative examples, light leakage is suppressed at a designed center wavelength (the highly-visible 550 nm (green) is selected); however, it can be seen that, as described earlier, the transmittance is high, and light leakage occurs, at other wavelengths (at or near 450 nm (blue) and at or near 650 nm (red)) in Comparative Examples 3-1 to 3-3. In other words, the black display state has coloration in the liquid crystal display panels according to Comparative Examples 3-1 to 3-3, and thus the transmittance subjected to visibility correction (a so-called Y value) is also high, which results in poor black display quality in the liquid crystal display panel.

On the other hand, although the liquid crystal display panels according to Comparative Examples 3-4, 3-5, and 3-6 can achieve good black display states at all wavelengths, the panels require the compensation layer 23Cr to compensate for optical anisotropy of the liquid crystal layer, and thus costs and thickness are a problem.

The liquid crystal display panel according to the third embodiment of the present invention uses a liquid crystal layer in a twisted alignment state in the same manner as the liquid crystal display panels according to the first and second embodiments, but does not have the compensation layer 23Cr that completely compensates for optical anisotropy of the liquid crystal layer in the twisted alignment state. It is difficult and expensive to manufacture the compensation layer 23Cr for compensating for optical anisotropy of the liquid crystal layer in a twisted alignment state, and thus being able to omit such a layer is highly advantageous. The liquid crystal display panel according to the third embodiment can achieve a good black display with little light leakage while reducing reflection of outside light more than in the past and/or improving the contrast ratio of bright parts, without having the compensation layer 23Cr. A better black display can be achieved than the liquid crystal display panels according to the above-described Comparative Examples 3-1 to 3-3. In other words, the liquid crystal display panel according to the third embodiment can reduce black transmittance subjected to visibility correction to less than or equal to 0.8%, and further to less than or equal to 0.1%, and still further to less than or equal to 0.01%.

Liquid crystal display panels according to Examples 4-1 to 4-3 and Reference Examples 3-1 to 3-3 will be described next. The liquid crystal layer of the liquid crystal display panel according to Example 4-1 has Δnd=505 nm and a twist alignment having a twist angle of 73° in a state where no voltage is applied; the panel satisfies the semi-λ conditions, and emits circular polarized light when circular polarized light is incident. The liquid crystal display panels according to Reference Examples 3-1 to 3-3 adds the compensation layer 23Cr, which completely compensates for optical anisotropy of the liquid crystal layer having a twisted alignment, to the liquid crystal display panels according to Examples 4-1 to 4-3. Like Table 5, Table 6 shows design values of the liquid crystal display panels according to Examples 4-1 to 4-3 and Reference Examples 3-1 to 3-3 (values used in the simulations) and transmittances subjected to visibility correction.

TABLE 6

| | | Example | Example | Example | Reference | Reference | Reference |
|---|---|---|---|---|---|---|---|
| | | 4-1 | 4-2 | 4-3 | Example 3-1 | Example 3-2 | Example 3-3 |
| Second linear | Absorption axis (deg) | 114.0 | 114.0 | 114.0 | 114.0 | 114.0 | 114.0 |
| polarizing layer | | | | | | | |
| Second phase | Slow axis (deg) | 159.0 | 159.0 | 159.0 | 159.0 | 159.0 | 159.0 |
| difference layer | R550 (nm) | 137.5 | 137.5 | 137.5 | 137.5 | 137.5 | 137.5 |
| | R450/R550 | 1.00 | 1.05 | 0.91 | 1.00 | 1.05 | 0.91 |
| | R650/R550 | 1.00 | 0.97 | 1.03 | 1.00 | 0.97 | 1.03 |
| Liquid crystal | R550 (nm) | 505.0 | 505.0 | 505.0 | 505.0 | 505.0 | 505.0 |
| layer | Twist angle (deg) | 73.0 | 73.0 | 73.0 | 73.0 | 73.0 | 73.0 |
| | Top substrate | 60.5 | 60.5 | 60.5 | 60.5 | 60.5 | 60.5 |
| | alignment (deg) | | | | | | |
| | Bottom substrate | −12.5 | −12.5 | −12.5 | −12.5 | −12.5 | −12.5 |
| | alignment (deg) | | | | | | |
| | R450/R550 | 1.05 | 1.05 | 1.05 | 1.05 | 1.05 | 1.05 |
| | R650/R550 | 0.97 | 0.97 | 0.97 | 0.97 | 0.97 | 0.97 |
| Compensation | R550 (nm) | | | | 505.0 | 505.0 | 505.0 |
| layer | Twist angle (deg) | | | | −73.0 | −73.0 | −73.0 |
| | Top substrate | | | | 77.5 | 77.5 | 77.5 |
| | alignment (deg) | | | | | | |
| | Bottom substrate | | | | 150.5 | 150.5 | 150.5 |
| | alignment (deg) | | | | | | |
| | R450/R550 | | | | 1.05 | 1.05 | 1.05 |
| | R650/R550 | | | | 0.97 | 0.97 | 0.97 |
| First phase | Slow axis (deg) | 69.0 | 69.0 | 69.0 | 69.0 | 69.0 | 69.0 |
| difference layer | R550 (nm) | 137.5 | 137.5 | 137.5 | 137.5 | 137.5 | 137.5 |
| | R450/R550 | 1.00 | 1.05 | 0.91 | 1.00 | 1.05 | 0.91 |
| | R650/R550 | 1.00 | 0.97 | 1.03 | 1.00 | 0.97 | 1.03 |
| First linear | Absorption axis (deg) | 24.0 | 24.0 | 24.0 | 24.0 | 24.0 | 24.0 |
| polarizing layer | | | | | | | |
| Transmittance | Black state @ 0 V | 0.403 | 0.273 | 0.723 | 0.002 | 0.002 | 0.002 |
| (%) | White state @ 5 V | 18.7 | 18.6 | 18.6 | 18.9 | 18.7 | 19.1 |

Unlike a liquid crystal layer having a homogeneous alignment, the trajectory, on a Poincare sphere, of the transition of the polarization state of polarized light passing through a liquid crystal layer does not exhibit a simple rotation about a specific axis, and rather is typically very complex. However, by assuming that the liquid crystal layer having a twisted alignment is divided into a plurality of liquid crystal layers in the thickness direction with each division being a liquid crystal layer having a homogeneous alignment, the trajectory of the transition of the polarization state by each of the liquid crystal layers obtained by the division can be regarded as a simple rotation about the slow axis (the alignment direction of the liquid crystal director) in each liquid crystal layer, and thus the trajectory of the transition of the polarization state can be found through a routine procedure using simulations. Here, the liquid crystal layer having a twisted alignment state was divided into 50 equal layers in the thickness direction, and the trajectory of the transition of the polarization state was found through simulations.

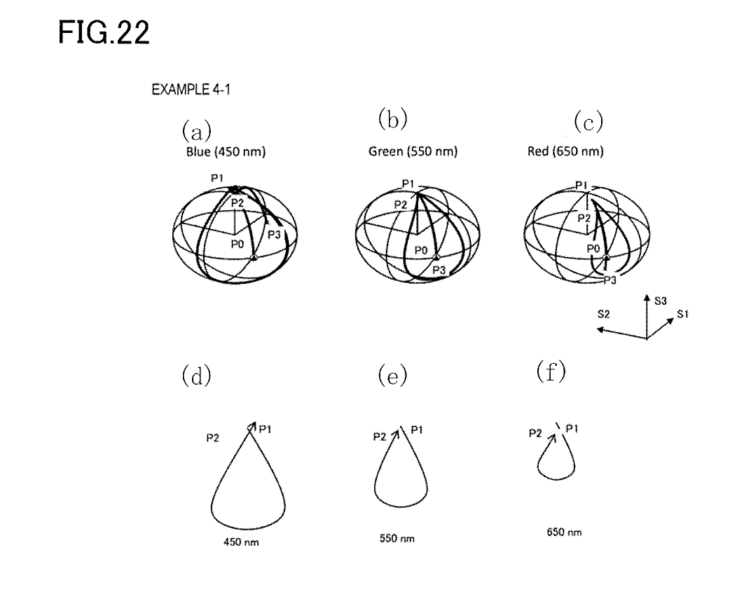

FIGS. 22(a) to 22(c) illustrate, on Poincare spheres, the trajectories of transitions in the polarization state in the black display state of the liquid crystal display panel according to Example 4-1. FIG. 22(a) illustrates the trajectory of the transition in the polarization state for blue light (a wavelength of 450 nm), FIG. 22(b), for green light (a wavelength of 550 nm), and FIG. 22(c), for red light (650 nm). FIGS. 22(d) to 22(f) schematically illustrate the trajectory of the transition in the polarization state depending on Δnd of the liquid crystal layer having a twisted alignment state.

In the case of a design such as the liquid crystal display panel according to Example 4-1, the trajectory in the transition of the polarization state by the liquid crystal layer (the point P1→the point P2) has a generally teardrop-shaped outer profile. As will be described later with reference to Example 4-4, this shape of the trajectory of the transition is determined not by the design values of the liquid crystal layer alone, but also depends on the design values of the first and second polarizing plates.

The trajectory of the transition in the polarization state by the first phase difference layer 22Cr and the second phase difference layer 24Cr can be regarded as the same as the comparative examples described earlier, and thus detailed descriptions thereof will be omitted.

In the case of a homogeneously-aligned liquid crystal layer, as in Comparative Example 3-1 described earlier, the trajectories of the transitions in the polarization state of the liquid crystal layer are simple rotations about a fixed specific axis regardless of the wavelength of the incident light, and all are perfect circles. When rotated by different angles in accordance with the different retardations for respective wavelengths, the point P2, representing the polarization state after transmission through the liquid crystal layer, varied depending on the wavelength. However, in the case where a liquid crystal layer having a twisted alignment and a circular polarizing plate are combined, as in the liquid crystal display panel according to Example 4-1, teardrop-shaped trajectories having different shapes (different manners of collapsing) arise depending on the wavelength and retardation, and thus there is comparatively low dispersion of the position of the point P2, which represents the polarization state after transmission through the liquid crystal layer. As a result, the position of the point P3, which represents the polarization state after transmission through the second phase difference layer 24Cr, has a low dispersion as well, and thus compared with Comparative Example 3-1, coloration in the black display state can be suppressed. As a result, the transmittance in the black display state for the liquid crystal display panel according to Example 4-1 is 0.403%, which is lower than the transmittance of 2.714% in the black display state of the liquid crystal display panel according to Comparative Example 3-1.

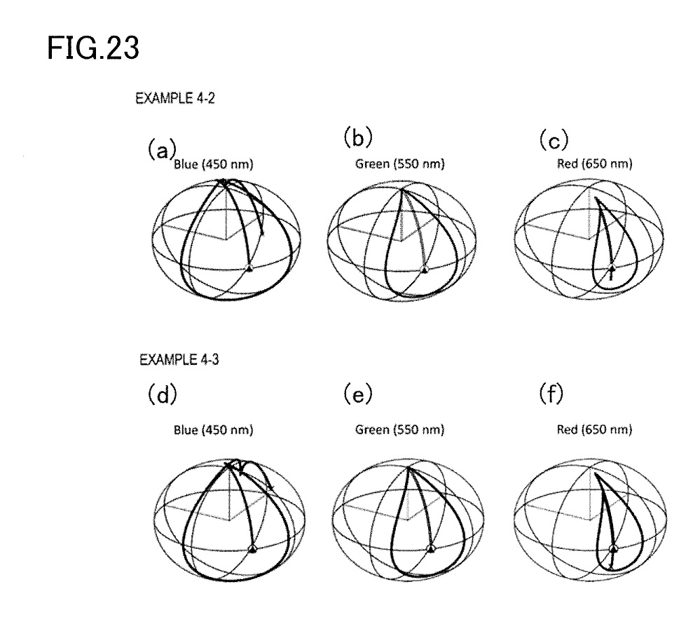

The liquid crystal display panels according to Example 4-2 and Example 4-3 are the same as the liquid crystal display panel according to Example 4-1, aside from the wavelength dispersions of the retardations of the first phase difference layer 22Cr and the second phase difference layer 24Cr having been changed. FIGS. 23(a)˜23(f) illustrate, on Poincare spheres, the trajectories of transitions in polarization states in black display states of liquid crystal display panels according to Example 4-2 and Example 4-3.

As can be seen by comparing FIGS. 23(a) and 23(c) with FIGS. 23(d) and 23(f), the liquid crystal display panel according to Example 4-2, which has a phase difference layer with a normal dispersion, has a smaller distance between the asterisks and the triangles on the Poincare sphere for blue light and red light than the liquid crystal display panel according to Example 4-3, which has a phase difference layer with an inverse dispersion. Additionally, based on Table 6, the liquid crystal display panel according to Example 4-2, which has the first phase difference layer 22Cr and the second phase difference layer 24Cr with normal dispersions, has a lower black display state transmittance than Example 4-1, which has a flat dispersion. The transmittance in the black display state in Example 4-3, which has an inverse dispersion, is higher than in Example 4-1, which has a flat dispersion.

In other words, the wavelength dispersions of the retardations of the first phase difference layer 22Cr and the second phase difference layer 24Cr are preferably the same normal dispersion as the wavelength dispersion of Δnd (retardation) of the liquid crystal layer. This result is opposite from the past general technical knowledge, which says it is preferable that the wavelength dispersion of the retardation of a phase difference layer constituting a circular polarizing plate and an elliptical polarizing plate be an inversion dispersion (a higher absolute value for the retardation at longer wavelengths) or flat (constant regardless of the wavelength).

The liquid crystal display panel according to Reference Example 3-1 is the same as the liquid crystal display panel according to Example 4-1, aside from the handedness (twist direction) being opposite from the liquid crystal layer in the liquid crystal cell, and that the compensation layer 23Cr having an equal retardation absolute value has been added. The compensation layer 23Cr may be, for example, a liquid crystal cell, or may be a substrate subjected to an alignment treatment (one or two substrates may be used, and these may be film-like substrates), which is then applied (sealed) with a liquid crystalline material to which a chiral agent has been added, and the alignment thereof is then fixed.

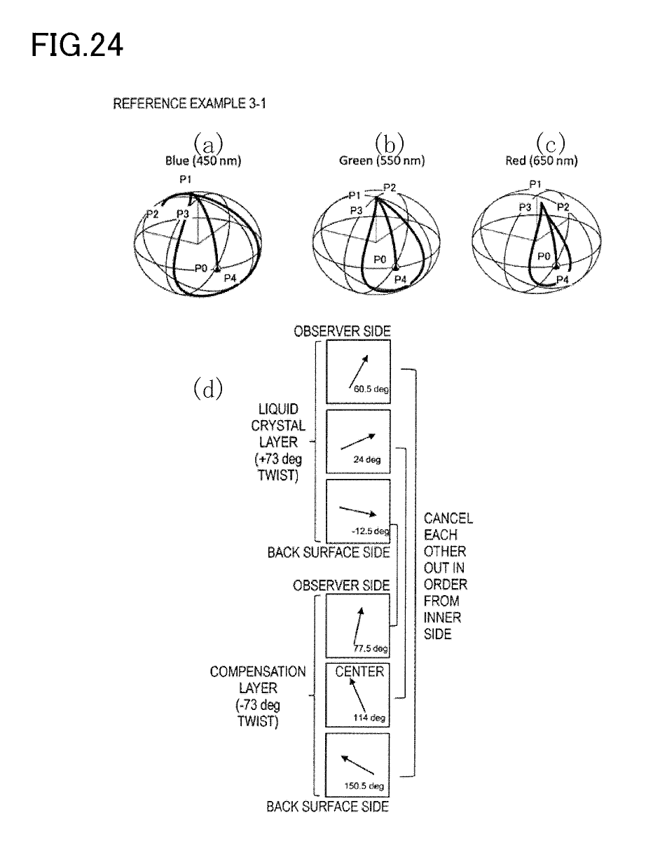

FIGS. 24(a)˜24(c) are diagrams illustrating, on Poincare spheres, the trajectories of transitions in polarization states in the black display state of the liquid crystal display panel according to Reference Example 3-1; and FIG. 24(d) is a diagram illustrating an optical compensation mechanism using the compensation layer 23Cr.

As can be seen from FIGS. 24(a)˜24(c), the point P0 and the point P4 match well, and the transmittance in the black display state is also an extremely low 0.002% (see Table 6).

A mechanism by which the compensation layer 23Cr compensates for the optical anisotropy of a liquid crystal layer having a twisted alignment will be described briefly with reference to FIG. 24(d).

As illustrated in FIG. 24(d), the alignments of the liquid crystal layer and the compensation layer 23Cr are designed such that the liquid crystal director azimuthal direction on the rearmost side of the liquid crystal cell is orthogonal to the liquid crystal director azimuthal direction on the side of the compensation layer 23Cr furthest on the observation surface side, the liquid crystal director azimuthal direction in a central area of the liquid crystal cell (measured in the thickness direction of the cell) is orthogonal to the liquid crystal director azimuthal direction in a central area of the compensation layer 23Cr (measured in the thickness direction of the cell), and the liquid crystal director azimuthal direction on the side of the liquid crystal cell furthest on the observation surface side is orthogonal to the liquid crystal director azimuthal direction on the rearmost side of the compensation layer 23Cr. Accordingly, the retardations cancel out in order from the inner sides of the interfaces therebetween, bringing the effective retardation of a layered body constituted of the liquid crystal layer and the compensation layer 23Cr to zero. The retardations are described as canceling out in order from the inner sides to facilitate intuitive understanding. However, a phenomenon in which, on the Poincare sphere, the trajectory for the compensation layer 23Cr is drawn from the point P1→the point P2, the trajectory for the liquid crystal layer is drawn from the point P2→the point P3 so as to return along that same trajectory, and the point P3 ultimately returns to the point P1, is occurring.

Aside from this, a good black display with little light leakage can be achieved for incident light of all wavelengths, under the same principles as those described for Comparative Example 3-4. No coloration appears in the black display, and the transmittance in the black display state is also low; however, the compensation layer 23Cr is required and thus the cost and thickness are a problem.

Note that although an example in which the compensation layer 23Cr is disposed on the back surface side of the liquid crystal cell 10 is described here, appropriately changing the design values in consideration of the above-described compensation mechanism also makes it possible to dispose the compensation layer 23Cr on the observation surface side of the liquid crystal cell 10. In fact, doing so makes it possible to describe an order where the compensation is realized by changing the polarization state so that the trajectory of the transition for the liquid crystal layer (the point P1→the point P2) returns for the compensation layer 23Cr (the point P2→the point P3), which makes the concept of “compensation” easy to understand. However, from the standpoint of maximizing the antireflection effect of the circular polarizing plate, it is preferable that the structure of the second polarizing plate 24C disposed on the observation surface side be as simple as possible, and including the compensation layer 23Cr as part of the first polarizing plate 22C disposed on the back surface side is considered practical; thus, this configuration is employed in Reference Example 3-1 as well. The material constituting the compensation layer is not particularly limited as long as the compensation effect can be achieved, but a liquid crystalline material is preferable from the standpoint of easily achieving a twisted alignment. Furthermore, from the standpoint of achieving the compensation effect not only in the normal direction but also in oblique viewing angles, it is more preferable that Δn of the liquid crystalline material constituting the compensation layer be negative. This corresponds to a liquid crystalline material having a disk-shaped (discotic) molecular shape. Δn of the liquid crystalline material encapsulated in the liquid crystal cell is positive (the molecular shape is a rod shape), and thus using a compensation layer formed from a liquid crystalline material having the opposite sign from Δn makes it possible to compensate for phase difference changes in all directions.

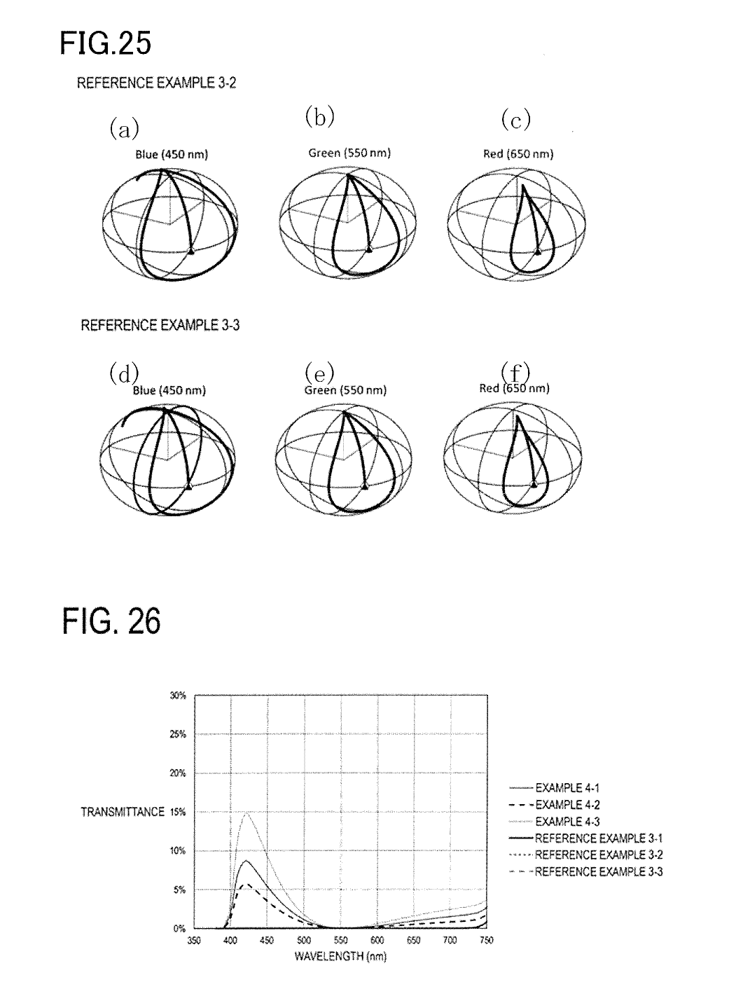

Next, FIGS. 25(a)˜25(f) illustrate, on Poincare spheres, the trajectories of transitions in polarization states in black display states of liquid crystal display panels according to Reference Example 3-2 and Reference Example 3-3. The liquid crystal display panels according to Reference Example 3-2 and Reference Example 3-3 are the same as the liquid crystal display panels as in Example 4-2 and Example 4-3, respectively, aside from the compensation layer 23Cr having been added. Put differently, the liquid crystal display panels are the same as the liquid crystal display panel according to Reference Example 3-1, aside from the wavelength dispersions of the retardations of the first phase difference layer 22Cr and the second phase difference layer 24Cr having been changed.

As can be seen from FIGS. 25(a)˜25(f), in a configuration where the optical anisotropy of the liquid crystal layer is perfectly compensated for by the compensation layer 23Cr, the point P4, which represents the final polarization state for all wavelengths, matches the point P0 regardless of the wavelength dispersions of the retardations of the first phase difference layer 22Cr and the second phase difference layer 24Cr. Thus, although the liquid crystal display panels according to Reference Examples 3-1 to 3-3 can achieve good black display states at all wavelengths, the compensation layer 23Cr is necessary, and thus issues with respect to cost and module thickness remain for these liquid crystal display panels.

FIG. 26 illustrates spectra of the black display states of the liquid crystal display panels according to Examples 4-1 to 4-3 and Reference Examples 3-1 to 3-3. In all of these liquid crystal display panels, light leakage is suppressed at the designed center wavelength (the highly-visible 550 nm (green) is selected). With the liquid crystal display panels according to Examples 4-1 to 4-3, the transmittances at other wavelengths (at or near 450 nm (blue) and 650 nm (red)) is high, and thus light leakage occurs. However, compared to the spectra of the liquid crystal display panels according to Comparative Examples 3-1 to 3-3 illustrated in FIG. 21, the transmittance for long wavelengths exceeding 550 nm is remarkably reduced, and the transmittance for wavelengths at or near 450 nm is reduced as well. Thus, it can be seen that despite not having the compensation layer 23Cr, the liquid crystal display panels according to Examples 4-1 to 4-3 have improved black display quality compared to the liquid crystal display panels according to Comparative Examples 3-1 to 3-3. On the other hand, although the liquid crystal display panels according to Reference Examples 3-1 to 3-3 can achieve good black display states at all wavelengths, the panels require the compensation layer 23Cr, and thus costs and thickness are a problem.

Liquid crystal display panels according to Examples 4-4 to 4-11 will be described next. Table 7 shows design values of the liquid crystal display panels according to Examples 4-4 to 4-11 (values used in the simulations) and transmittances subjected to visibility correction.

TABLE 7

| | | Example | Example | Example | Example | Example | Example | Example | Example |
|---|---|---|---|---|---|---|---|---|---|
| | | 4-4 | 4-5 | 4-6 | 4-7 | 4-8 | 4-9 | 4-10 | 4-11 |
| Second linear | Absorption axis (deg) | 98.1 | 98.1 | 98.1 | 98.1 | 106.8 | 106.8 | 106.8 | 106.8 |
| polarizing layer | | | | | | | | | |
| Second phase | Slow axis (deg) | 135.6 | 135.6 | 135.6 | 135.6 | 139.8 | 139.8 | 139.8 | 139.8 |
| difference layer | R550 (nm) | 155.0 | 155.0 | 155.0 | 155.0 | 155.0 | 155.0 | 155.0 | 155.0 |
| | R450/R550 | 1.05 | 1.15 | 1.05 | 1.15 | 1.05 | 1.09 | 1.05 | 1.09 |
| | R650/R550 | 0.97 | 0.89 | 0.97 | 0.89 | 0.97 | 0.94 | 0.97 | 0.94 |
| Liquid crystal | R550 (nm) | 505.0 | 505.0 | 505.0 | 505.0 | 505.0 | 505.0 | 505.0 | 505.0 |
| layer | Twist angle (deg) | 73.0 | 73.0 | 73.0 | 73.0 | 73.0 | 73.0 | 73.0 | 73.0 |
| | Top substrate | 60.5 | 60.5 | 60.5 | 60.5 | 60.5 | 60.5 | 60.5 | 60.5 |
| | alignment (deg) | | | | | | | | |
| | Bottom substrate | −12.5 | −12.5 | −12.5 | −12.5 | −12.5 | −12.5 | −12.5 | −12.5 |
| | alignment (deg) | | | | | | | | |
| | R450/R550 | 1.05 | 1.05 | 1.05 | 1.05 | 1.05 | 1.05 | 1.05 | 1.05 |
| | R650/R550 | 0.97 | 0.97 | 0.97 | 0.97 | 0.97 | 0.97 | 0.97 | 0.97 |
| Compensation | R550 (nm) | | | | | | | | |
| layer | Twist angle (deg) | | | | | | | | |
| | Top substrate | | | | | | | | |
| | alignment (deg) | | | | | | | | |
| | Bottom substrate | | | | | | | | |
| | alignment (deg) | | | | | | | | |
| | R450/R550 | | | | | | | | |
| | R650/R550 | | | | | | | | |
| First phase | Slow axis (deg) | 90.0 | 90.0 | 90.0 | 90.0 | 87.5 | 87.5 | 87.5 | 87.5 |
| difference layer | R550 (nm) | 146.3 | 146.3 | 146.3 | 146.3 | 152.0 | 152.0 | 152.0 | 152.0 |
| | R450/R550 | 1.05 | 1.05 | 1.15 | 1.15 | 1.05 | 1.05 | 1.09 | 1.09 |
| | R650/R550 | 0.97 | 0.97 | 0.89 | 0.89 | 0.97 | 0.97 | 0.94 | 0.94 |
| First linear | Absorption axis (deg) | 35.8 | 35.8 | 35.8 | 35.8 | 29.6 | 29.6 | 29.6 | 29.6 |
| polarizing layer | | | | | | | | | |
| Transmittance | Black state @ 0 V | 0.077 | 0.031 | 0.020 | 0.015 | 0.018 | 0.010 | 0.007 | 0.006 |
| (%) | White state @ 5 V | 26.6 | 26.2 | 26.5 | 26.1 | 29.4 | 29.3 | 29.4 | 29.3 |

Although the design values of the liquid crystal layers in the liquid crystal display panels according to Examples 4-4 to 4-11 are the same as those in the liquid crystal display panel according to Example 4-1, the design values of the first polarizing plate 22C and the second polarizing plate 24C are different. In the liquid crystal display panel according to Example 4-4, the retardation is proactively set to be greater (155.0 nm) than the retardation of the circular polarizing plate (137.5 nm). An angle formed by the absorption axis of the first linear polarizing layer 22Cp and the slow axis of the first phase difference layer 22Cr, and an angle formed by the absorption axis of the second linear polarizing layer 24Cp and the slow axis of the second phase difference layer 24Cr, are proactively set to be smaller than an angle formed by the absorption axis of the linear polarizing layer in the circular polarizing plate and a quarter wave layer)(45° (Examples 4-4 to 4-7: 54.2° and 37.5°; Examples 4-8 to 4-11: 57.9° and 33.0°). Furthermore, an angle formed by the absorption axis of the first linear polarizing layer 22Cp and the absorption axis of the second linear polarizing layer 24Cp is set to be less than 90° (Examples 4-4 to 4-7: 62.3°; Examples 4-8 to 4-11:77.2°).

Generally, an elliptical polarizing plate has a weaker antireflection effect than a circular polarizing plate, but as indicated by this example, a sufficient antireflection effect can be achieved by appropriately designing parameters such as the retardations of the phase difference layers, the angle formed by the absorption axis of the linear polarizing layer and the slow axis of the phase difference layer, and the like. Although details will be given later, in Examples 4-4 to 4-7, the first polarizing plate 22C and the second polarizing plate 24C were designed so that the internal reflection remainder rate was 0.1. The internal reflection remainder rate will be described later.

The director azimuthal direction of the liquid crystal layer, the azimuthal direction of the absorption axis of the first linear polarizing layer 22Cp, and the azimuthal direction of the slow axis of the first phase difference layer 22Cr are then optimized, so that the trajectory of the transition in the polarization state by the liquid crystal layer (the point P1→the point P2) takes on the overall shape of a proportional symbol (a). The trajectory of the transition in the polarization state by the first phase difference layer 22Cr and the second phase difference layer 24Cr can be regarded as the same as Example 4-1 and the like described earlier, and thus detailed descriptions thereof will be omitted.

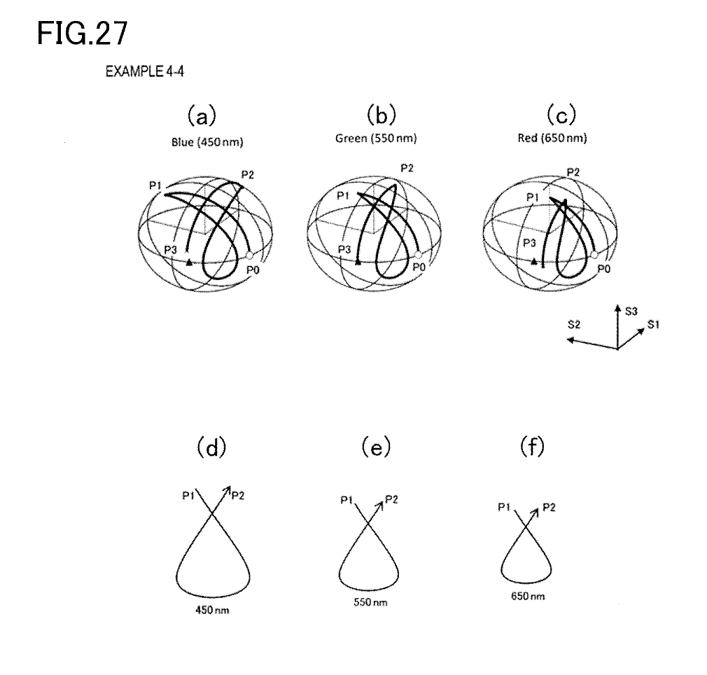

FIGS. 27(a)˜27(c) illustrate, on Poincare spheres, the trajectories of transitions in the polarization state in the black display state of the liquid crystal display panel according to Example 4-4. FIG. 27(a) illustrates the trajectory of the transition in the polarization state for blue light (a wavelength of 450 nm), FIG. 27(b), for green light (a wavelength of 550 nm), and FIG. 27(c), for red light (650 nm). FIGS. 27(d) to 27(f) schematically illustrate the trajectory of the transition in the polarization state depending on Δnd of the liquid crystal layer having a twisted alignment state.

In the case where a liquid crystal layer having a twisted alignment and an elliptical polarizing plate are combined, as in the liquid crystal display panel according to Example 4-4, proportional symbol-shaped trajectories having different shapes (different manners of collapsing) arise depending on the wavelength of incident light and the retardation of the phase difference layers, and thus there is comparatively low wavelength dispersion of the position of the point P2, which represents the polarization state after transmission through the liquid crystal layer. As a result, the position of the point P3, which represents the polarization state after transmission through the second phase difference layer 24Cr, has a low dispersion as well, and thus coloration in the black display state can be suppressed.

In the liquid crystal display panel according to Example 4-1, in which the trajectory of the transition in the polarization state has a teardrop shape, the polarization state varies changes so as to reciprocate vertically (this may be expressed as the North-South direction on the Poincare sphere). Thus, by moving a long distance Southward and then moving a long distance Northward, or moving a short distance Southward and then moving a short distance Northward, a self-compensating effect is achieved for the wavelength dispersion (see FIGS. 22(a)˜22(f)). As opposed to this, with the liquid crystal display panel according to Example 4-4, in which the trajectory of the transition in the polarization state has a proportional symbol shape, the trajectory swings greatly to the left and right to the extent that there is an intersection point partway along the trajectory (see FIGS. 27(a)˜27(f)), in addition to the effect achieved in the case of a teardrop shape. Accordingly, a self-compensating effect is achieved for the wavelength dispersion in the left and right directions as well, which is regarded as further reducing the wavelength dispersion.

However, the point P1 and the point P2 do not match each other, and thus a black display cannot be achieved if the absorption axis of the first linear polarizing layer 22Cp and the absorption axis of the second linear polarizing layer 24Cp are made orthogonal to each other. Accordingly, the angle formed by the absorption axis of the first linear polarizing layer 22Cp and the absorption axis of the second linear polarizing layer 24Cp is also optimized.

As can be seen by comparing FIGS. 27(a) to 27(c), the wavelength dispersion of the point P2 is small, but not small enough to be ignorable. However, the degree of dispersion of the point P2 is very similar to the degree of dispersion of the point P1. In other words, for incident light of any wavelength, the distance from the equator to the point P1 and the distance from the equator to the point P2 are generally equal, and the distance becomes shorter as the wavelength becomes longer. Focusing on this point, in Example 4-4, the wavelength dispersions of the retardations of the first phase difference layer 22Cr and the second phase difference layer 24Cr are normal dispersions. Note that the wavelength dispersions of the retardations of the first phase difference layer 22Cr and the second phase difference layer 24Cr are optimized in Example 4-11, which will be described later.

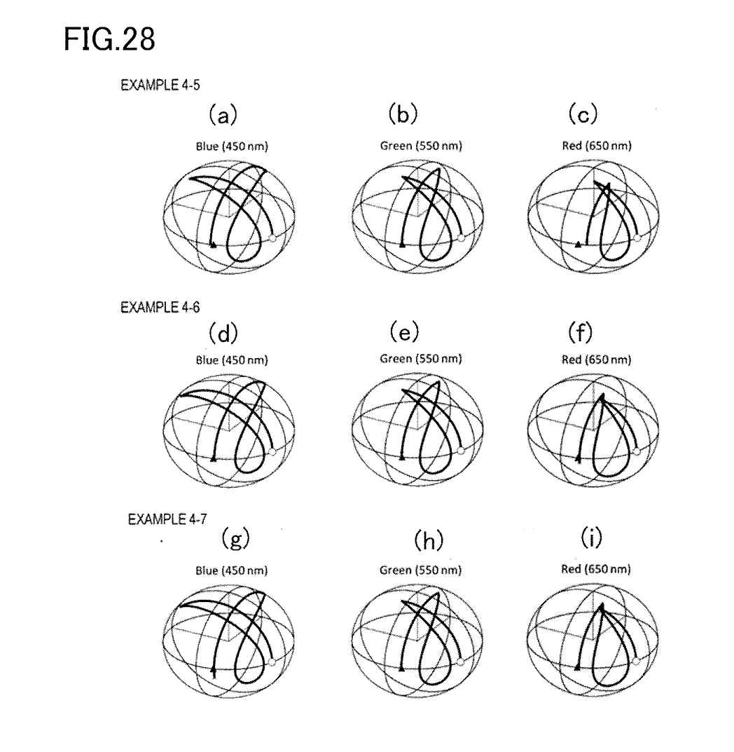

FIGS. 28(a) to 28(i) illustrate, on Poincare spheres, the trajectories of transitions in the polarization states in the black display states of the liquid crystal display panels according to Examples 4-5 to 4-7.

The liquid crystal display panels according to Examples 4-5 to 4-7 are the same as the liquid crystal display panel according to Example 4-4, aside from the wavelength dispersions of the retardations of the first phase difference layer 22Cr and the second phase difference layer 24Cr having been changed. Light leakage in the black display can be suppressed further by setting the wavelength dispersion the retardation of at least one of the first phase difference layer 22Cr and the second phase difference layer 24Cr to be high (by strengthening the normal dispersion) (Examples 4-5 and 4-6).

Generally, as the wavelength dispersion increases, the antireflection performance of a circular polarizing plate deteriorates (coloration arises more easily). The same applies to elliptical polarizing plates as well. Accordingly, in the case where the wavelength dispersion of the retardation of either the first phase difference layer 22Cr or the second phase difference layer 24Cr is increased, it is preferable that the wavelength dispersion of the retardation of the first phase difference layer 22Cr on the back surface side be changed first. As shown in Table 7, the transmittance in the black display state of the liquid crystal display panel according to Example 4-5, in which the wavelength dispersion of the retardation of the second phase difference layer 24Cr disposed on the observer side is increased, is 0.031%, whereas the transmittance in the black display state of the liquid crystal display panel according to Example 4-6, in which the wavelength dispersion of the retardation of the first phase difference layer 22Cr disposed on the back surface side is increased, is 0.020%. Of course, increasing the wavelength dispersions of the retardations of the first phase difference layer 22Cr and the second phase difference layer 24Cr, as with the liquid crystal display panel according to Example 4-7, makes it possible to further increase the antireflection effect and reduce the transmittance in the black display state to 0.015%.

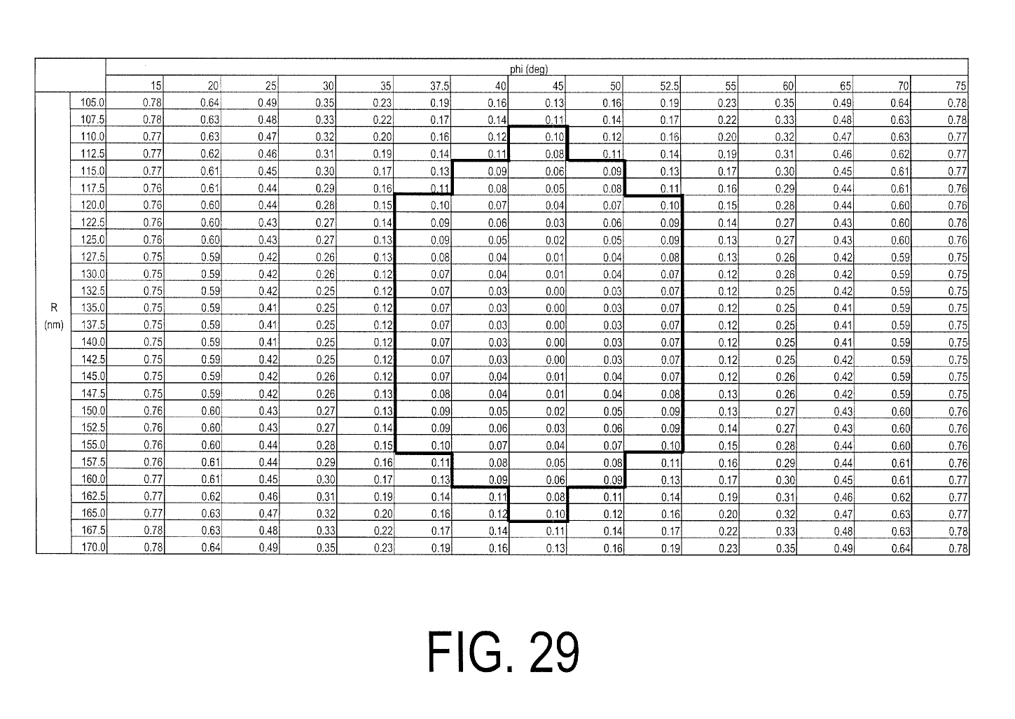

The internal reflection remainder rate of an elliptical polarizing plate will be described here with reference to FIG. 29. FIG. 29 shows results of calculating a ratio of light, orthogonally incident on an elliptical polarizing plate disposed above a mirror, that is reflected by the mirror and transmitted through and emitted from the elliptical polarizing plate. The reflectivity, obtained in this manner, of the mirror on which the elliptical polarizing plate is disposed is referred to as the internal reflection remainder rate. The internal reflection remainder rate becomes zero in the case where a circular polarizing plate is disposed on the mirror instead of an elliptical polarizing plate.

The numerical values in the left column of FIG. 29 are the retardation of a phase difference layer (corresponding to the first phase difference layer 22Cr and the second phase difference layer 24Cr) in the elliptical polarizing plate, and the numerical values in the top row indicate an angle phi (deg) formed by the absorption axis of the linear polarizing layer and the slow axis of the phase difference layer. Thus, when the retardation is 137.5 nm and phi is 45°, the circular polarizing plate is disposed and the internal reflection remainder rate is 0.00. Note that the internal reflection remainder rate arising when a linear polarizing plate is disposed instead of an elliptical polarizing plate is normalized to 1.00.

As described above, in Example 4-4, the first polarizing plate 22C and the second polarizing plate 24C were designed so that the internal reflection remainder rate is 0.10. As can be seen from FIG. 29, although there are a plurality of combinations of retardations and angles at which the internal reflection remainder rate is 0.10, examinations by the inventors indicated that comparatively good properties are achieved even with designs in which the retardation is at or near 155 nm. As such, Example 4-4 was designed so that the retardation of the second polarizing plate 24C on the observer side is 155 nm and the angle formed by the absorption axis of the second linear polarizing layer 24Cp and the slow axis of the second phase difference layer 24Cr is 37.5°.

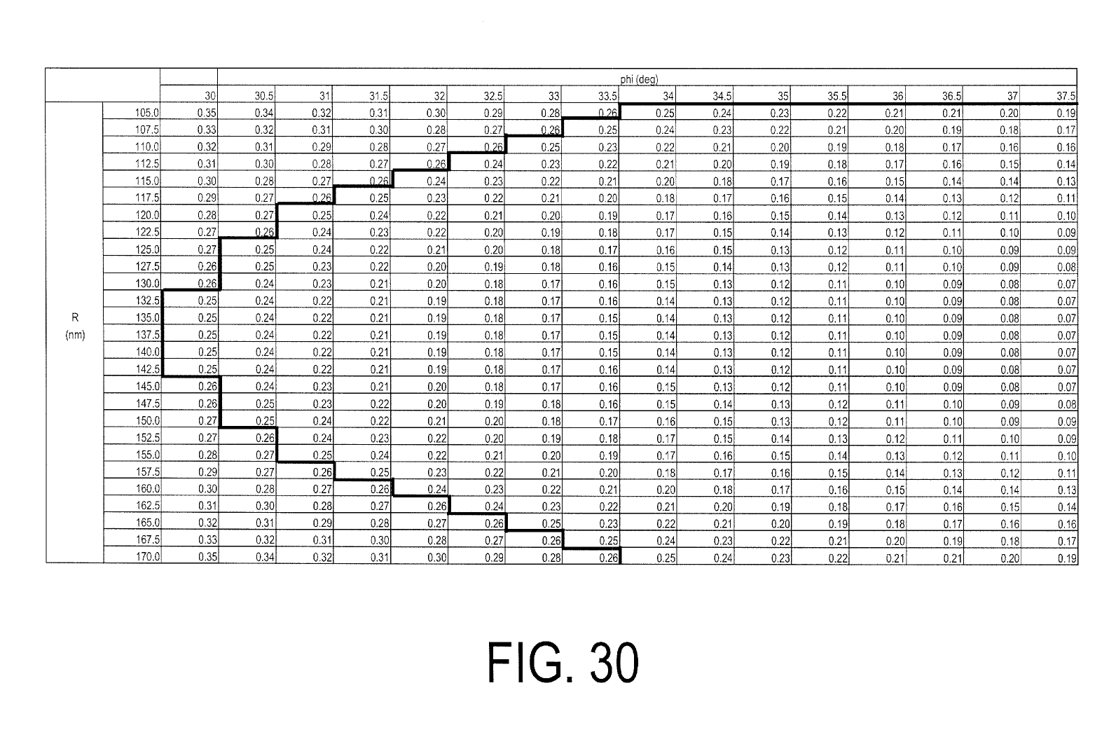

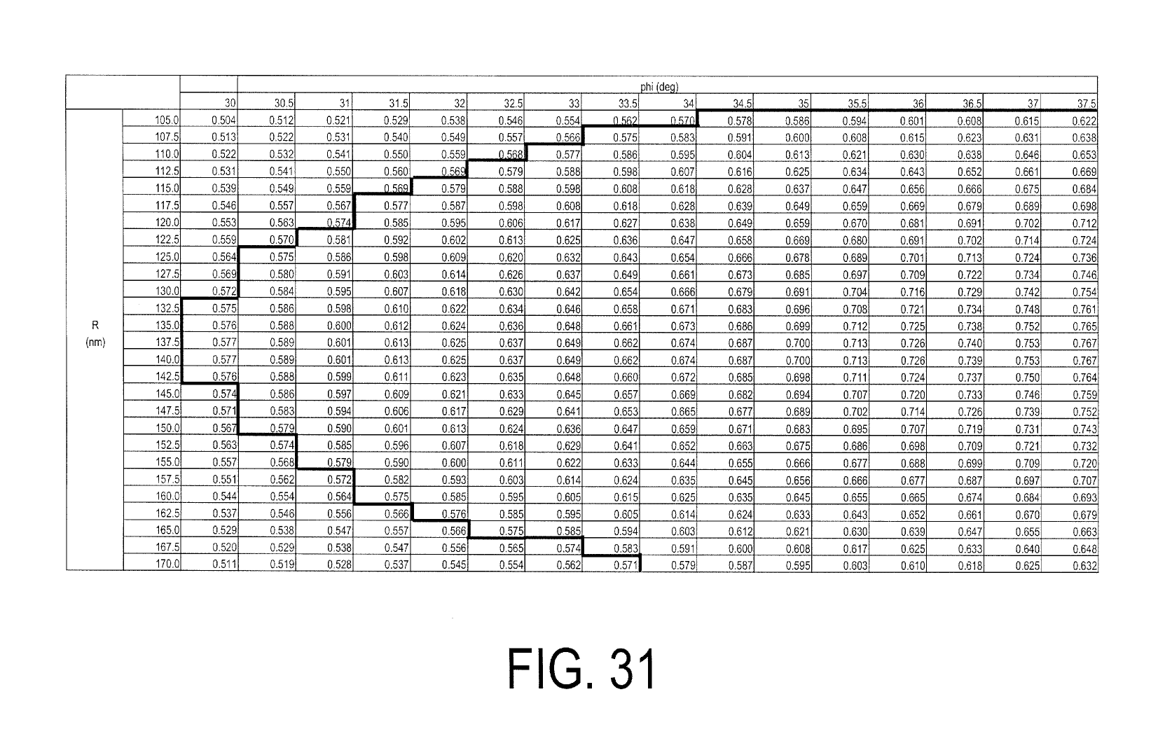

As will be described later, the internal reflection remainder rate is preferably less than or equal to 0.25. When the internal reflection remainder rate is less than or equal to 0.25, a contrast ratio of greater than or equal to 10 can be achieved even in bright parts at 20000 lux. FIG. 30 illustrates regions of retardations and Phi (the right side of the bold line) where the internal reflection remainder rate is less than or equal to 0.25. FIG. 31 illustrates values of the ellipticity of a polarizing plate instead of the internal reflection remainder rate. As can be seen by comparing FIG. 31 with FIG. 30, the region in which the ellipticity is greater than or equal to 0.575 indicated in FIG. 31 (the right side of the bold line) substantially matches the region in FIG. 30 where the internal reflection remainder rate is less than or equal to 0.25. In other words, a range in which the internal reflection remainder rate is less than or equal to 0.25 can be referred to instead as a range where the ellipticity is greater than or equal to 0.575. Note that “ellipticity” in the present specification refers to an absolute value independent from handedness.

For example, if 155 nm is selected as the retardation of the second phase difference layer 24Cr, the angle formed by the absorption axis of the second linear polarizing layer 24Cp and the slow axis of the second phase difference layer 24Cr may be set to a range of from 31° to 59° (see FIG. 29). Focusing on the ellipticity, (45−α)° and (45+α)° give the same result, and thus angles outside the above range may be used; however, the range of the angle formed by the absorption axis of the second linear polarizing layer 24Cp and the slow axis of the second phase difference layer 24Cr is set to from 31° to 59 (=45+(45-31))°.

A preferred range of numerical values for the internal reflection remainder rate will be described next.

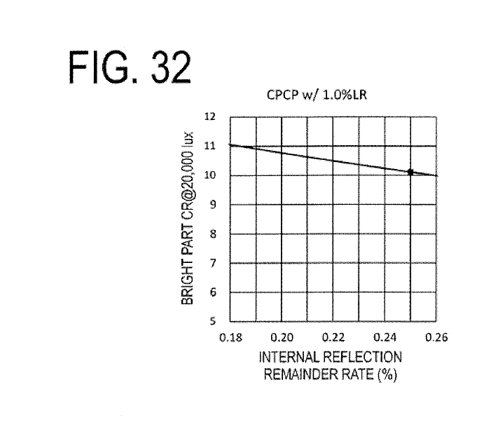

FIG. 32 illustrates a relationship between the internal reflection remainder rate and a bright part contrast ratio (CR) in a 20000 lux environment, found through a simulation. The internal reflectivity of the liquid crystal display panel was set to 5.4%, which is a typical value for an actual liquid crystal display panel. It was furthermore assumed that an antireflective film having a reflectivity of 1% was provided on the surface of the liquid crystal display panel. The reflectivity of the antireflective film is also a typical value.

According to subjective evaluation results, good visibility can be achieved in a case where the contrast ratio is greater than or equal to 10 in a 20000 lux environment. As can be seen from FIG. 32, a contrast ratio greater than or equal to 10 is achieved in a case where the internal reflection remainder rate is less than or equal to 0.25. A numerical value of 0.25 is one standard with respect to the internal reflection remainder rate.

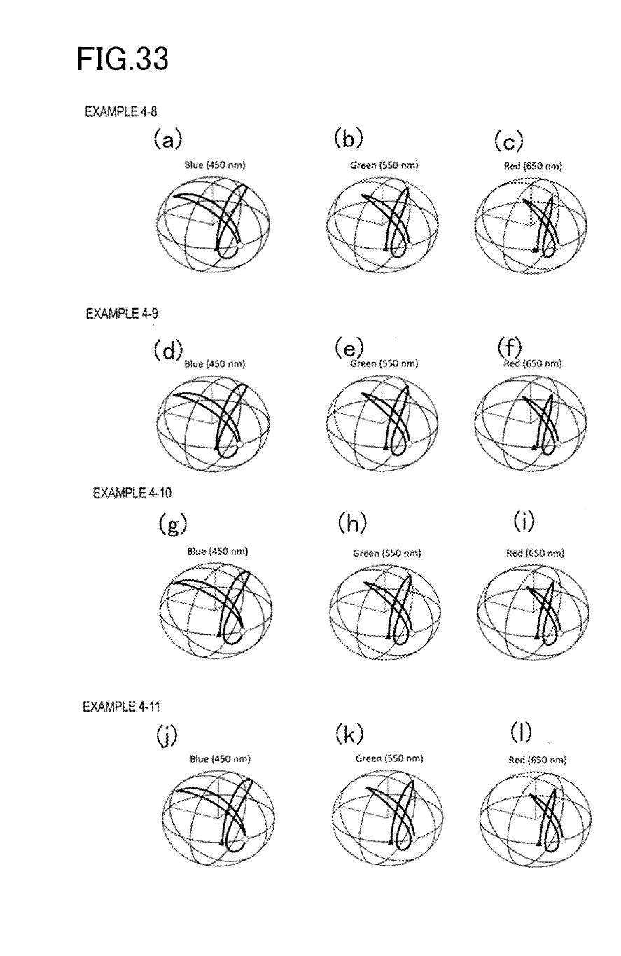

FIGS. 33(a)˜33(l) illustrate, on Poincare spheres, the trajectories of transitions in the polarization states in the black display states of the liquid crystal display panels according to Examples 4-8 to 4-11. In the liquid crystal display panels according to Examples 4-8 to 4-11, the polarizing plates were designed so that the internal reflection remainder rate was 0.20. As indicated by the design values in Table 7, the angle formed by the absorption axis of the first linear polarizing layer 22Cp and the slow axis of the first phase difference layer 22Cr is set to 57.9°, and the angle formed by the absorption axis of the second linear polarizing layer 24Cp and the slow axis of the second phase difference layer 24Cr is set to 33.0°. Additionally, the angle formed by the absorption axis of the first linear polarizing layer 22Cp and the absorption axis of the second linear polarizing layer 24Cp is set to 77.2°. Example 4-10, in which the wavelength dispersion of the retardation of the first phase difference layer 22Cr is optimized, and Example 4-11, in which the wavelength dispersions of the retardations of the first phase difference layer 22Cr and the second phase difference layer 24Cr are optimized, have a low value of less than or equal to 0.010 for the transmittance in the black display state.

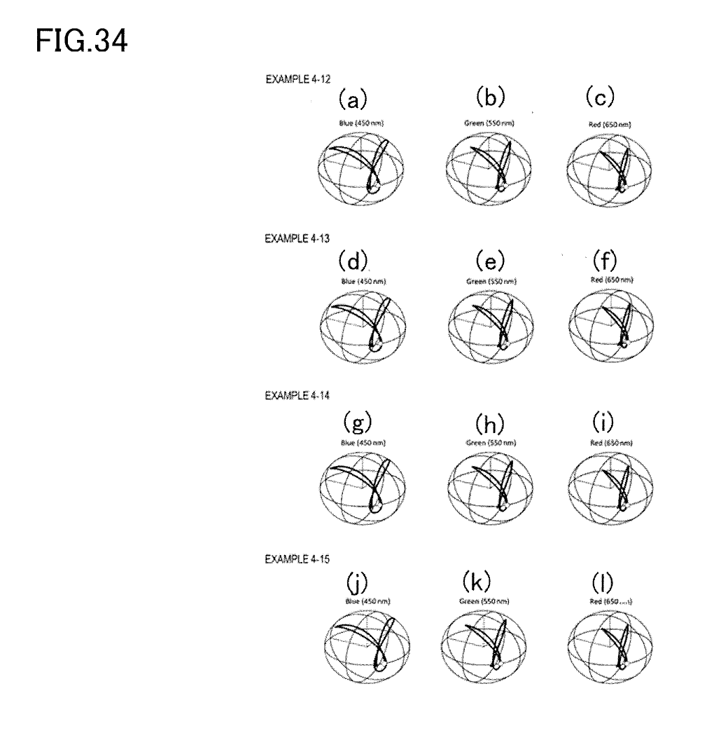

FIGS. 34 (a)˜34(l) illustrate, on Poincare spheres, the trajectories of transitions in the polarization states in the black display states of the liquid crystal display panels according to Examples 4-12 to 4-15. Table 8 shows the design values.

TABLE 8

| | | Example | Example | Example | Example | Example |
|---|---|---|---|---|---|---|
| | | 4-12 | 4-13 | 4-14 | 4-15 | 4-16 |
| Second linear | Absorption axis (deg) | 110.6 | 110.6 | 110.6 | 110.6 | 112.8 |
| polarizing layer | | | | | | |
| Second phase | Slow axis (deg) | 141.6 | 141.6 | 141.6 | 141.6 | 142.1 |
| difference layer | R550 (nm) | 155.0 | 155.0 | 155.0 | 155.0 | 155.0 |
| | R450/R550 | 1.05 | 1.06 | 1.05 | 1.06 | 1.05 |
| | R650/R550 | 0.97 | 0.95 | 0.97 | 0.95 | 0.97 |
| Liquid crystal | R550 (nm) | 505.0 | 505.0 | 505.0 | 505.0 | 505.0 |
| layer | Twist angle (deg) | 73.0 | 73.0 | 73.0 | 73.0 | 73.0 |
| | Top substrate | 60.5 | 60.5 | 60.5 | 60.5 | 60.5 |
| | alignment (deg) | | | | | |
| | Bottom substrate | −12.5 | −12.5 | −12.5 | −12.5 | −12.5 |
| | alignment (deg) | | | | | |
| | R450/R550 | 1.05 | 1.05 | 1.05 | 1.05 | 1.05 |
| | R650/R550 | 0.97 | 0.97 | 0.97 | 0.97 | 0.97 |
| Compensation | R550 (nm) | | | | | |
| layer | Twist angle (deg) | | | | | |
| | Top substrate | | | | | |
| | alignment (deg) | | | | | |
| | Bottom substrate | | | | | |
| | alignment (deg) | | | | | |
| | R450/R550 | | | | | |
| | R650/R550 | | | | | |
| First phase | Slow axis (deg) | 86.5 | 86.5 | 86.5 | 86.5 | 85.9 |
| difference layer | R550 (nm) | 154.4 | 154.4 | 154.4 | 154.4 | 155.0 |
| | R450/R550 | 1.05 | 1.05 | 1.06 | 1.06 | 1.05 |
| | R650/R550 | 0.97 | 0.97 | 0.95 | 0.95 | 0.97 |
| First linear | Absorption axis (deg) | 26.9 | 26.9 | 26.9 | 26.9 | 25.2 |
| polarizing layer | | | | | | |
| Transmittance | Black state @ 0 V | 0.011 | 0.009 | 0.008 | 0.007 | 0.003 |
| (%) | White state @ 5 V | 30.3 | 30.3 | 30.3 | 30.3 | 31.1 |

In the liquid crystal display panels according to Examples 4-12 to 4-15, the polarizing plates were designed so that the internal reflection remainder rate was 0.25. As indicated by the design values in Table 8, the angle formed by the absorption axis of the first linear polarizing layer 22Cp and the slow axis of the first phase difference layer 22Cr is set to 59.6°, and the angle formed by the absorption axis of the second linear polarizing layer 24Cp and the slow axis of the second phase difference layer 24Cr is set to 31.0°. Additionally, the angle formed by the absorption axis of the first linear polarizing layer 22Cp and the absorption axis of the second linear polarizing layer 24Cp is set to 83.7°. Example 4-13, in which the wavelength dispersion of the retardation of the second phase difference layer 24Cr is optimized, Example 4-14, in which the wavelength dispersion of the retardation of the first phase difference layer 22Cr is optimized, and Example 4-15, in which the wavelength dispersions of the retardations of the first phase difference layer 22Cr and the second phase difference layer 24Cr are optimized, have a low value of less than or equal to 0.010 for the transmittance in the black display state.

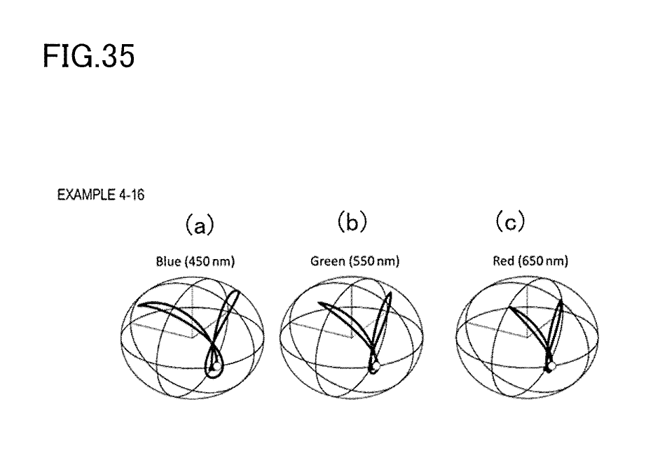

FIGS. 35(a)˜35(c) illustrates, on Poincare spheres, the trajectories of transitions in the polarization state in the black display state of the liquid crystal display panel according to Example 4-16. Table 8 shows the design values.

In the liquid crystal display panel according to Example 4-16, the polarizing plates were designed for the best black display state, without specifying the internal reflection remainder rate. The angle formed by the absorption axis of the first linear polarizing layer 22Cp and the slow axis of the first phase difference layer 22Cr is set to 60.7°, and the angle formed by the absorption axis of the second linear polarizing layer 24Cp and the slow axis of the second phase difference layer 24Cr is set to 29.3°. Additionally, the angle formed by the absorption axis of the first linear polarizing layer 22Cp and the absorption axis of the second linear polarizing layer 24Cp is set to 87.6°. The internal reflection remainder rate was 0.28. According to this configuration, a low value of less than or equal to 0.010 can be achieved for the transmittance in the black display state, even in a case where the wavelength dispersions of the first phase difference layer 22Cr and the second phase difference layer 24Cr are not optimized. Thus, a configuration in which a sufficient black display can be achieved is possible even if the internal reflection remainder rate exceeds 0.25.

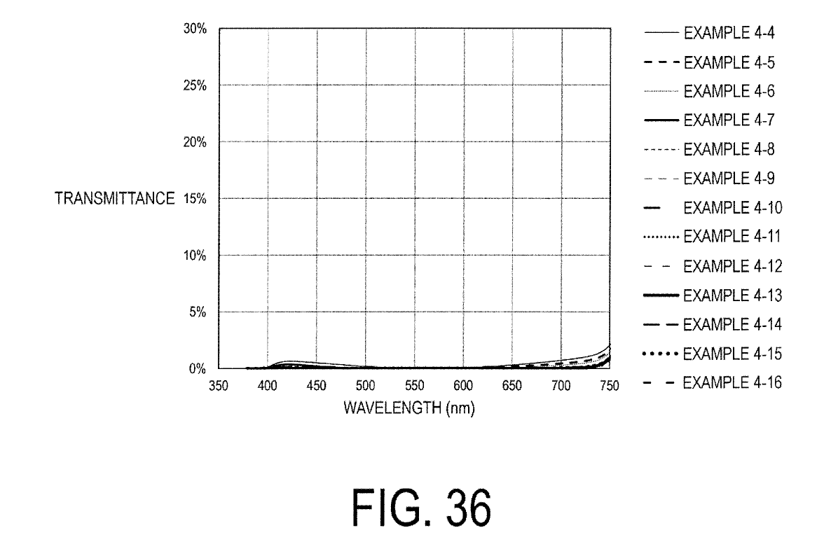

FIG. 36 illustrates spectra of black display states of liquid crystal display panels according to Examples 4-4 to 4-16. The liquid crystal display panels according to any of these examples can achieve a good black display state at all wavelengths, despite not including the compensation layer 23Cr for compensating for optical anisotropy of the liquid crystal layer.

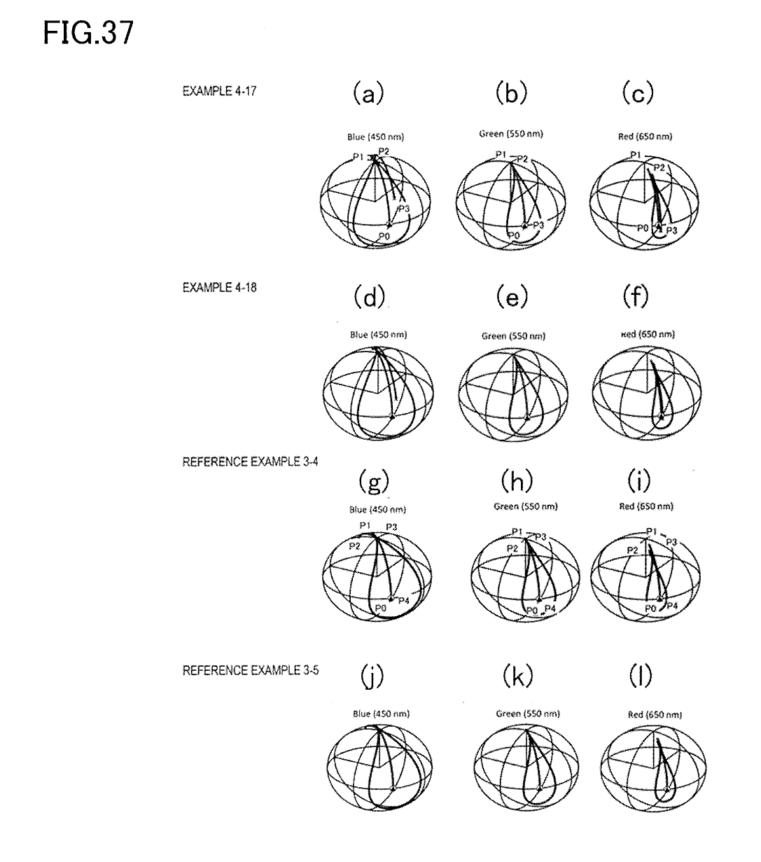

FIGS. 37(a)˜37(l) illustrates, on Poincare spheres, the trajectories of transitions in polarization states in black display states of liquid crystal display panels according to Examples 4-17 and 18 and Reference Examples 3-4 and 3-5. Table 9 shows the design values.

TABLE 9

| | | Example | Example | Reference | Reference | Example |
|---|---|---|---|---|---|---|
| | | 4-17 | 4-18 | Example 3-4 | Example 3-5 | 4-19 |
| Second linear | Absorption axis (deg) | 112.5 | 112.5 | 112.5 | 112.5 | 108.7 |
| polarizing layer | | | | | | |
| Second phase | Slow axis (deg) | 157.5 | 157.5 | 157.5 | 157.5 | 144.1 |
| difference layer | R550 (nm) | 137.5 | 137.5 | 137.5 | 137.5 | 155.0 |
| | R450/R550 | 1.00 | 1.05 | 1.00 | 1.05 | 1.05 |
| | R650/R550 | 1.00 | 0.97 | 1.00 | 0.97 | 0.97 |
| Liquid crystal | R550 (nm) | 480.8 | 480.8 | 480.8 | 480.8 | 480.8 |
| layer | Twist angle (deg) | 90.0 | 90.0 | 90.0 | 90.0 | 90.0 |
| | Top substrate | 67.5 | 67.5 | 67.5 | 67.5 | 67.5 |
| | alignment (deg) | | | | | |
| | Bottom substrate | −22.5 | −22.5 | −22.5 | −22.5 | −22.5 |
| | alignment (deg) | | | | | |
| | R450/R550 | 1.05 | 1.05 | 1.05 | 1.05 | 1.05 |
| | R650/R550 | 0.97 | 0.97 | 0.97 | 0.97 | 0.97 |
| Compensation | R550 (nm) | | | 480.8 | 480.8 | |
| layer | Twist angle (deg) | | | −90.0 | −90.0 | |
| | Top substrate | | | −22.5 | −22.5 | |
| | alignment (deg) | | | | | |
| | Bottom substrate | | | 67.5 | 67.5 | |
| | alignment (deg) | | | | | |
| | R450/R550 | | | 1.05 | 1.05 | |
| | R650/R550 | | | 0.97 | 0.97 | |
| First phase | Slow axis (deg) | 67.5 | 67.5 | 67.5 | 67.5 | 80.9 |
| difference layer | R550 (nm) | 137.5 | 137.5 | 137.5 | 137.5 | 155.0 |
| | R450/R550 | 1.00 | 1.05 | 1.00 | 1.05 | 1.05 |
| | R650/R550 | 1.00 | 0.97 | 1.00 | 0.97 | 0.97 |
| First linear | Absorption axis (deg) | 22.5 | 22.5 | 22.5 | 22.5 | 26.3 |
| polarizing layer | | | | | | |
| Transmittance | Black state @ 0 V | 0.213 | 0.103 | 0.002 | 0.002 | 0.004 |
| (%) | White state @ 5 V | 18.0 | 17.9 | 17.7 | 17.5 | 25.4 |

In the liquid crystal display panels according to Examples 4-1 to 4-16, Δnd of the liquid crystal layer is 505.0 nm and the twist angle is 73.0°, whereas in the liquid crystal display panels according to Examples 4-17 and 18 and Reference Examples 3-4 and 3-5, Δnd of the liquid crystal layer is 480.8 nm and the twist angle is 90.0°. Circular polarizing plates are used for the first polarizing plate 22C and the second polarizing plate 24C. The liquid crystal display panels according to Reference Examples 3-4 and 3-5 include the compensation layer 23Cr.

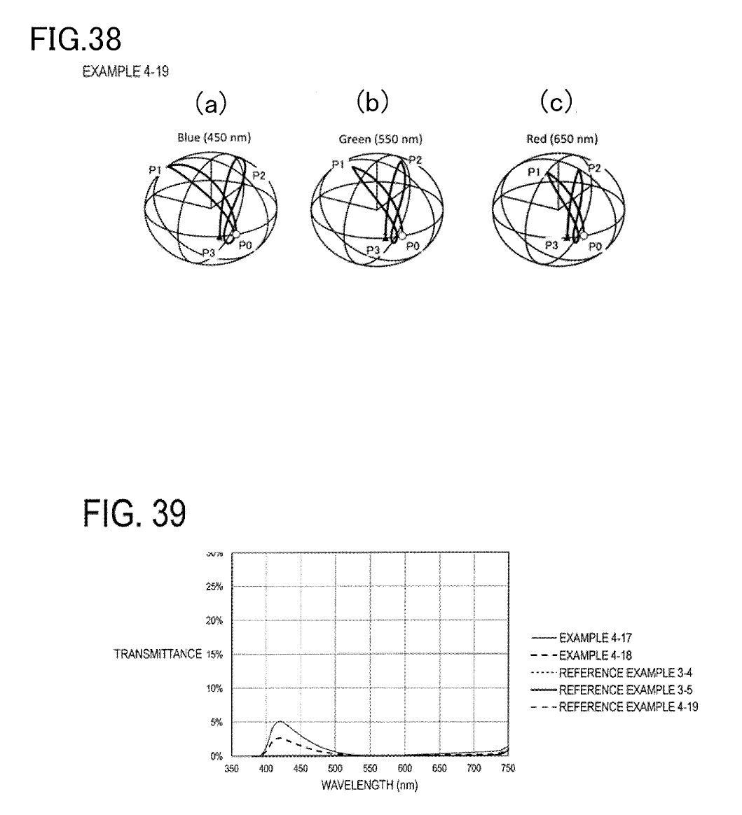

FIGS. 38(a)˜38(c) illustrate, on Poincare spheres, the trajectories of transitions in the polarization state in the black display state of the liquid crystal display panel according to Example 4-19. Table 9 shows the design values. The liquid crystal display panel according to Example 4-19 also has a liquid crystal layer having Δnd of 480.8 nm and a twist angle of 90.0°, but differs from the liquid crystal display panels according to Examples 4-17 and 18 in that elliptical polarizing plates are used for the first polarizing plate 22C and the second polarizing plate 24C.

FIG. 39 illustrates spectra of the black display states of the liquid crystal display panels according to Examples 4-17 to 4-19 and Reference Examples 3-4 to 3-5. Although not as low as the liquid crystal display panels according to Reference Examples 3-4 and 3-5, which have the compensation layer 23Cr, the transmittance is reduced across a broad wavelength range in the liquid crystal display panels according to Examples 4-17 to 4-19. In particular, the transmittance in the black display state in Example 4-19, which uses an elliptical polarizing plate, is a low value of less than or equal to 0.010 (see Table 9).

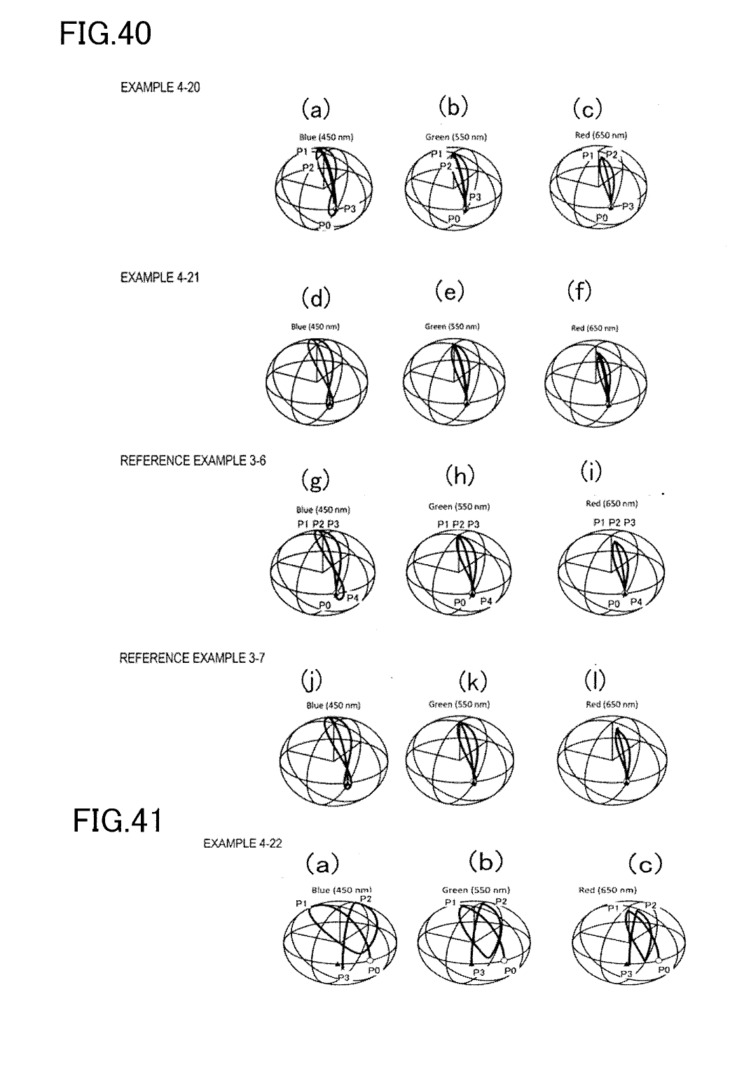

FIGS. 40(a)˜40(l) illustrate, on Poincare spheres, the trajectories of transitions in polarization states in black display states of liquid crystal display panels according to Examples 4-20 and 4-21 and Reference Examples 3-6 and 3-7. Table 10 shows the design values.

TABLE 10

| | | Example | Example | Reference | Reference | Example |
|---|---|---|---|---|---|---|
| | | 4-20 | 4-21 | Example 3-6 | Example 3-7 | 4-22 |
| Second linear | Absorption axis (deg) | 112.5 | 112.5 | 112.5 | 112.5 | 103.8 |
| polarizing layer | | | | | | |
| Second phase | Slow axis (deg) | 157.5 | 157.5 | 157.5 | 157.5 | 145.5 |
| difference layer | R550 (nm) | 137.5 | 137.5 | 137.5 | 137.5 | 155.0 |
| | R450/R550 | 1.00 | 1.05 | 1.00 | 1.05 | 1.05 |
| | R650/R550 | 1.00 | 0.97 | 1.00 | 0.97 | 0.97 |
| Liquid crystal | R550 (nm) | 414.1 | 414.1 | 414.1 | 414.1 | 414.1 |
| layer | Twist angle (deg) | 120.0 | 120.0 | 120.0 | 120.0 | 120.0 |
| | Top substrate | 82.5 | 82.5 | 82.5 | 82.5 | 82.5 |
| | alignment (deg) | | | | | |
| | Bottom substrate | −37.5 | −37.5 | −37.5 | −37.5 | −37.5 |
| | alignment (deg) | | | | | |
| | R450/R550 | 1.05 | 1.05 | 1.05 | 1.05 | 1.05 |
| | R650/R550 | 0.97 | 0.97 | 0.97 | 0.97 | 0.97 |
| Compensation | R550 (nm) | | | 414.1 | 414.1 | |
| layer | Twist angle (deg) | | | −120.0 | −120.0 | |
| | Top substrate | | | −37.5 | −37.5 | |
| | alignment (deg) | | | | | |
| | Bottom substrate | | | 82.5 | 82.5 | |
| | alignment (deg) | | | | | |
| | R450/R550 | | | 1.05 | 1.05 | |
| | R650/R550 | | | 0.97 | 0.97 | |
| First phase | Slow axis (deg) | 67.5 | 67.5 | 67.5 | 67.5 | 79.5 |
| difference layer | R550 (nm) | 137.5 | 137.5 | 137.5 | 137.5 | 155.0 |
| | R450/R550 | 1.00 | 1.05 | 1.00 | 1.05 | 1.05 |
| | R650/R550 | 1.00 | 0.97 | 1.00 | 0.97 | 0.97 |
| First linear | Absorption axis (deg) | 22.5 | 22.5 | 22.5 | 22.5 | 31.1 |
| polarizing layer | | | | | | |

The liquid crystal layers of the liquid crystal display panels according to Examples 4-20 and 4-21 and Reference Examples 3-6 and 3-7 have Δnd of 414.1 nm and a twist angle of 120.0°. Circular polarizing plates are used for the first polarizing plate 22C and the second polarizing plate 24C. The liquid crystal display panels according to Reference Examples 3-6 and 3-7 include the compensation layer 23Cr.

FIGS. 41(a)˜41(c) illustrate, on Poincare spheres, the trajectories of transitions in the polarization state in the black display state of the liquid crystal display panel according to Example 4-22. Table 10 shows the design values. The liquid crystal display panel according to Example 4-22 also has a liquid crystal layer having Δnd of 414.1 nm and a twist angle of 120.0°, but differs from the liquid crystal display panels according to Examples 4-20 and 4-21 in that elliptical polarizing plates are used for the first polarizing plate 22C and the second polarizing plate 24C.

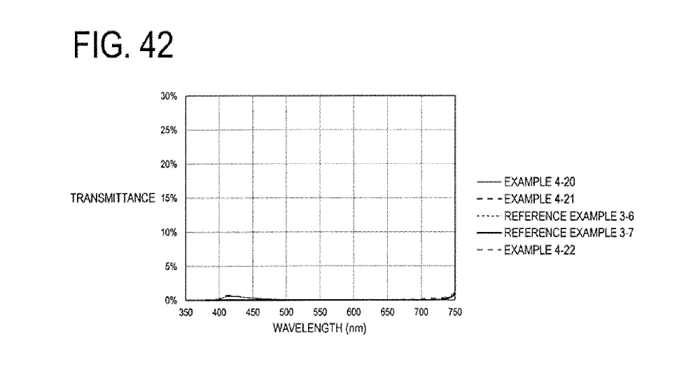

FIG. 42 illustrates spectra of the black display states of the liquid crystal display panels according to Examples 4-20 to 4-22 and Reference Examples 3-6 and 3-7. Although not as low as the liquid crystal display panels according to Reference Examples 3-6 and 3-7, which have the compensation layer 23Cr, the transmittance is reduced across a broad wavelength range in the liquid crystal display panels according to Examples 4-20 to 4-22.

In this manner, the transmittance in the black display state can be sufficiently reduced by optimizing the configuration of the polarizing plates, even if the twist angles of the liquid crystal layers are different.

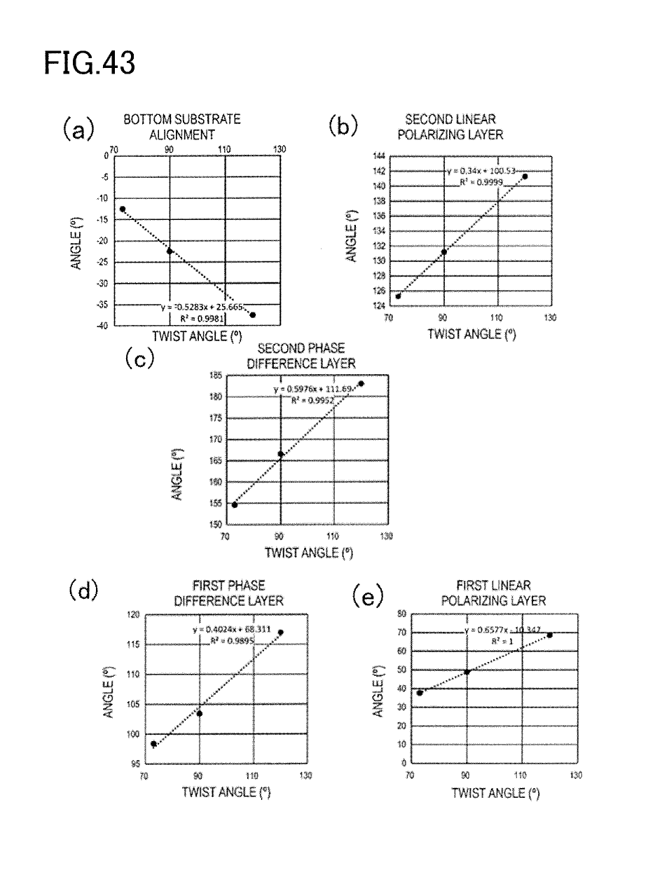

Preferred values for the design parameters of the polarizing plate (the linear polarizing layer and the phase difference layer) with respect to the twist angle of the liquid crystal layer will be described with reference to FIGS. 43(a) to 43(e). FIGS. 43(a) to 43(e) are graphs illustrating preferred relationships of various design parameters of the polarizing plate with respect to the twist angle of the liquid crystal layer. These are based on the results of the liquid crystal display panels of Examples 4-16, 4-19, and 4-22.

With respect to the three types of liquid crystal layers having different Δnd and twist angles in the liquid crystal display panels according to Examples 4-16, 4-19 and 4-22, no limitations were placed on the internal reflection remainder rate, or in other words, the results are those of designing the retardation with priority given to reducing the black display transmittance. There is a trade-off between lowering the internal reflection remainder rate and lowering the black display transmittance, and thus it is generally not possible to minimize the black display transmittance when the internal reflection remainder rate is limited.

FIG. 43(a) is a graph illustrating the relationship between the twist angle and the liquid crystal director alignment azimuthal direction on the bottom substrate side, and shows a result of selection intended to maximize the white display transmittance. This feature is not necessary for obtaining a good black display quality. In other words, even if the bottom substrate alignment azimuth direction does not satisfy the relationship indicated in FIG. 43(a), a good black display can be achieved as long as the relative angle formed by the absorption axis of the linear polarizing layer and the slow axis of the phase difference layer is appropriate.

Thus, based on this concept, the definitions of axial angles aside from the bottom substrate alignment are generalized. Here, an approximate expression was examined after redefining the azimuthal directions of the absorption axis of the linear polarizing layer and the slow axis of the phase difference layer at angles based on the alignment azimuthal direction of the liquid crystal director on the bottom substrate side. For example, the alignment azimuthal direction of the bottom substrate in Example 4-4 is −12.5° and the azimuthal direction of the second linear polarizing layer 24Cp is 98.1°, and thus the azimuthal direction of the second linear polarizing layer 24Cp can be thought of as 98.1°−(−12.5°)=110.6°. When the angles redefined in this way were plotted against the twist angle of the liquid crystal layer, it was found that the azimuthal directions of the absorption axis of the second linear polarizing layer 24Cp, the slow axis of the second phase difference layer 24Cr, the slow axis of the first phase difference layer 22Cr, and the absorption axis of the first linear polarizing layer 22Cp are all roughly aligned with the straight lines indicated in FIGS. 43(b) to 43(e).

Next, consider Examples 4-4, 4-8, 4-12, and 4-16. In these examples, the twist angle of the liquid crystal layer is a comparatively low angle of 73°, and thus there is a high wavelength dispersion during black display. In other words, it is comparatively difficult to achieve a good black display, and it is difficult to both reduce the internal reflection remainder rate and reduce the black display transmittance. As such, if the design places no limitations on the internal reflection remainder rate and prioritizes black display, the internal reflection remainder rate will become higher. In fact, in Example 4-16, the internal reflection remainder rate is 0.28 (0.557, in terms of the ellipticity).

Accordingly, Examples 4-4, 4-8, and 4-12 indicate results of making design changes within a range that achieves a preferable internal reflection remainder rate, or in other words, within a range in which the ellipticity is greater than or equal to 0.575, while somewhat sacrificing the black display quality. The retardation value of the second phase difference layer 24Cr was fixed at 155 nm, and changes were made only to the other design values.

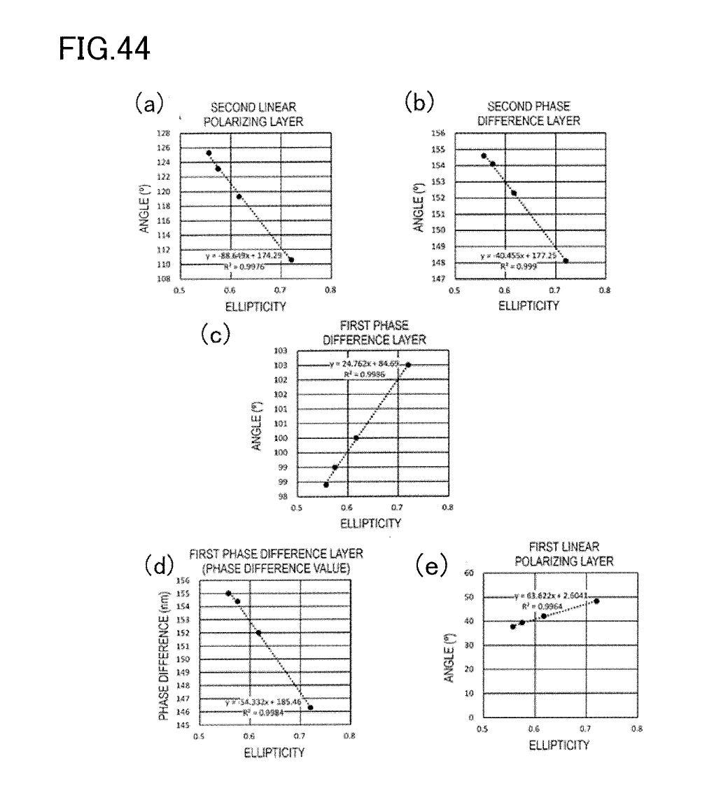

FIGS. 44(a) to 44(e) are graphs illustrating preferred relationships of various design parameters with respect to the ellipticity of the polarizing plate. These are based on the results of Examples 4-4, 4-8, 4-12, and 4-16. As can be seen from FIGS. 44(a) to 44(e), the azimuthal direction of the absorption axis of the second linear polarizing layer 24Cp, the azimuthal direction of the slow axis of the second phase difference layer 24Cr, the azimuthal direction of the slow axis of the first phase difference layer 22Cr, the retardation value of the first phase difference layer 22Cr, and the azimuthal direction of the absorption axis of the first linear polarizing layer 22Cp all are roughly linear. With respect to the liquid crystal layer illustrated here, which has a twist angle of 73° and Δnd of 505 nm, when the design values of Example 4-16, which is designed without placing limitations on the internal reflection remainder rate, is used as a reference, it can be seen that it is best to set the angle formed by the absorption axis of the second linear polarizing layer 24Cp and the absorption axis of the second phase difference layer 24Cr and the retardation of the first phase difference layer 22Cr to be lower, and to set the angle formed by the absorption axis of the first phase difference layer 22Cr and the first linear polarizing layer 22Cp to be higher.

Although an example in which the slits in the pixel electrodes extend parallel to the vertical direction of the drawing surface in the cross-sectional view is given here, the black display performance does not depend thereon, and the configuration is not limited thereto. Although there are cases where changing the azimuthal direction in which the slits in the pixel electrodes extend changes the white display transmittance, by changing all of the azimuthal directions, e.g., the azimuthal directions of the absorption axes of the linear polarization layers, the azimuthal directions of the slow axes of the phase difference layers, and the director azimuthal direction of the liquid crystal layer, to be aligned with the azimuthal direction in which the slits in the pixel electrodes extend, the same white display transmittance as before the change can be achieved.

The liquid crystal display panel according to embodiments of the present invention can be produced by twist-aligning liquid crystal molecules of the liquid crystal layer in a predetermined azimuthal direction in a known method for producing a liquid crystal cell having a transverse electric field mode. Processes for attaching the circular polarizing plate and/or the elliptical polarizing plate to the liquid crystal cell in a predetermined direction can of course be carried out using a known method.

The liquid crystal cell 10 (see FIG. 1(b)) of the liquid crystal display panels 100A, 100B, 100C and 100D can be produced as follows, for example.

The first substrate 10Sa is prepared through a known method. For example, circuit elements such as TFTs, gate bus lines, source bus lines, and common wiring are formed on the glass substrate 12a. The common electrode 14, the dielectric layer 15, and the pixel electrodes 16 are then formed. An alignment film is formed on the liquid crystal layer 18-side surface of the substrate 10Sa. The alignment film is then subjected to a rubbing treatment, for example, so that the liquid crystal molecules near the first substrate 10Sa are aligned in a predetermined direction.

The second substrate 10Sb produced through a known method is then prepared. The second substrate 10Sb has, for example, a black matrix and a color filter layer upon the glass substrate 12b, and has an alignment film on the liquid crystal layer 18 side. The alignment film is subjected to a rubbing treatment, for example, so that the liquid crystal molecules near the second substrate 10Sb are aligned in a predetermined direction.

Controlling the thickness of the liquid crystal layer 18 using spacers formed on the first substrate 10Sa or the second substrate 10Sb, the liquid crystal layer 18 is formed through one drop filling, for example, and the first substrate 10Sa and the second substrate 10Sb are then affixed to each other to prepare the liquid crystal cell 10.

Because the liquid crystal layer 18 of the liquid crystal cell 10 according to embodiments of the present invention is in a twisted alignment state, variations in the display quality caused by variations in the thickness of the liquid crystal layer 18 is suppressed, as described above; as such, a liquid crystal display panel having excellent display quality can be obtained even using a known production method.

Of course, the alignment treatment of the alignment film is not limited to a rubbing treatment, and an optical alignment treatment may be carried out using an optical alignment film. A rubbing treatment and an optical alignment treatment may be combined as well.

The TFT of the liquid crystal display panels 100A, 100B, 100C and 100D according to embodiments of the present invention may be a known TFT such as an amorphous silicon TFT (a-Si TFT), a polysilicon TFT (p-Si TFT), or a microcrystalline silicon TFT (μC-Si TFT), but it is preferable to use a TFT having an oxide semiconductor layer (an oxide TFT). Using an oxide TFT makes it possible to reduce the surface area of the TFT, and thus the pixel aperture ratio can be increased.

The oxide semiconductor layer may contain at least one metal element selected from In, Ga, and Zn, for example. The oxide semiconductor layer contains an In—Ga—Zn—O semiconductor, for example. Here, the In—Ga—Zn—O semiconductor is a ternary oxide of In (indium), Ga (gallium), and Zn (zinc); the ratio of In, Ga, and Zn (the composition ratio) is not particularly limited, and includes, for example, In:Ga:Zn=2:2:1, In:Ga:Zn=1:1:1, In:Ga:Zn=1:1:2, and the like. Such an oxide semiconductor layer can be formed from an oxide semiconductor film containing an In—Ga—Zn—O semiconductor. Note that a channel-etched TFT having an active layer containing an In—Ga—Zn—O semiconductor may be called a “CE-InGaZnO-TFT”.

The In—Ga—Zn—O semiconductor may be amorphous or crystalline. For a crystalline In—Ga—Zn—O semiconductor, a crystalline In—Ga—Zn—O semiconductor in which the c-axis is oriented generally perpendicular to the layer surface is preferable.

Note that JP 2014-007399 A, JP 2012-134475 A, and JP 2014-209727 A, for example, disclose crystal structures of crystalline In—Ga—Zn—O semiconductors. The entire contents of JP 2012-134475 A and JP 2014-209727 A are incorporated into the present specification by reference. A TFT having an In—Ga—Zn—O semiconductor layer has a high mobility (more than 20 times that of an a-Si TFT) and a low leak current (less than 1/100th that of an a-Si TFT), and can thus be used favorably as a driving TFT and a pixel TFT.

The oxide semiconductor layer may contain another oxide semiconductor instead of an In—Ga—Zn—O semiconductor. For example, the oxide semiconductor layer may contain an In—Sn—Zn—O semiconductor (In₂O₃—SnO₂—ZnO, for example). The In—Sn—Zn—O semiconductor is a ternary oxide of In (indium), Sn (tin), and Zn (zinc). Alternatively, the oxide semiconductor layer may contain an In—Al—Zn—O semiconductor, an In—Al—Sn—Zn—O semiconductor, a Zn—O semiconductor, an In—Zn—O semiconductor, a Zn—Ti—O semiconductor, a Cd—Ge—O semiconductor, a Cd—Pb—O semiconductor, CdO (cadmium oxide), a Mg—Zn—O semiconductor, an In—Ga—Sn—O semiconductor, an In—Ga—O semiconductor, a Zr—In—Zn—O semiconductor, an Hf—In—Zn—O semiconductor, or the like.

### INDUSTRIAL APPLICABILITY

The present invention can be applied broadly in liquid crystal display panels having transverse electric field modes. The present invention is particularly suited to use in transverse electric field mode liquid crystal display panels used outdoors.

### REFERENCE SIGNS LIST

10 Liquid crystal cell
10Sa First substrate
10Sb Second substrate
12a, 12b Transparent substrate (glass substrate)
14 Common electrode
15 Dielectric layer
16 Pixel electrode
16a Opening in pixel electrode (slit)
18 Liquid crystal layer
22A First polarizing plate (circular polarizing plate)
22B First polarizing plate (elliptical polarizing plate)
22C First polarizing plate (circular polarizing plate or elliptical polarizing plate)
22Cp First linear polarizing layer
22Cr First phase difference layer
24A Second polarizing plate (circular polarizing plate)
24B Second polarizing plate (elliptical polarizing plate)
24C Second polarizing plate (circular polarizing plate or elliptical polarizing plate)
24Cp Second linear polarizing layer
24Cr Second phase difference layer
50 Backlight
100A, 100B, 100C, 100D Liquid crystal display panel

1. A liquid crystal display panel comprising:
a liquid crystal cell, the liquid crystal cell including a first substrate, a second substrate, and a liquid crystal layer, the liquid crystal layer being provided between the first substrate and the second substrate;
a first polarizing plate disposed on a back surface side of the liquid crystal cell; and
a second polarizing plate disposed on an observer side of the liquid crystal cell,
wherein the first substrate includes an electrode pair, the electrode pair configured to produce a transverse electric field in the liquid crystal layer,
Δnd is less than 550 nm, where Δn represents birefringence of the nematic liquid crystals and d represents a thickness of the liquid crystal layer, the liquid crystal layer is in a twisted alignment state when no voltage is applied, and when polarized light for which an absolute value |S3| of a Stokes parameter S3 is 1.00 is incident, the |S3| of polarized light transmitted through the liquid crystal layer is greater than or equal to 0.85, and
the first polarizing plate and the second polarizing plate are circular polarizing plates or elliptical polarizing plates having an ellipticity of greater than or equal to 0.422, the first polarizing plate is substantially constituted only of a first linear polarizing layer and a first phase difference layer, and the second polarizing plate is substantially constituted only of a second linear polarizing layer and a second phase difference layer.

2. The liquid crystal display panel according to claim 1,
wherein the ellipticity of the first polarizing plate and the second polarizing plate is greater than or equal to 0.575.

3. The liquid crystal display panel according to claim 1 or 2,
wherein a retardation of the first phase difference layer and the second phase difference layer is from 105.0 nm to 170.0 nm.

4. The liquid crystal display panel according to any one of claims 1 to 3,
wherein an absorption axis of the first linear polarizing layer and an absorption axis of the second linear polarizing layer are not orthogonal.

5. The liquid crystal display panel according to any one of claims 1 to 4,
wherein an angle formed by the absorption axis of the first linear polarizing layer and a slow axis of the first phase difference layer, and an angle formed by the absorption axis of the second linear polarizing layer and a slow axis of the second phase difference layer, are both less than 45° or greater than 45°.

6. The liquid crystal display panel according to any one of claims 1 to 5,
wherein the retardation of at least one of the first phase difference layer and the second phase difference layer has a normal dispersion.
